(19) United States
(12) Patent Application Publication
(10) Pub. No.: US 2016/0370626 A1
(43) Pub. Date: Dec. 22, 2016

(54) LIQUID CRYSTAL DISPLAY DEVICE

(71) Applicant: DIC CORPORATION, Tokyo (JP)

(72) Inventors: Shinji OGAWA, Kita-adachi-gun (JP); Yoshinori IWASHITA, Kita-adachi-gun (JP); Mika YAMAMOTO, Kita-adachi-gun (JP); Yasuhiro KUWANA, Kita-adachi-gun (JP); Koichi ENDOU, Kita-adachi-gun (JP); Kazuaki HATSUSAKA, Kita-adachi-gun (JP)

(73) Assignee: DIC CORPORATION, Tokyo (JP)

(21) Appl. No.: 15/120,876

(22) PCT Filed: Feb. 24, 2015
(86) PCT No.: PCT/JP2015/055172

§ 371 Date: Aug. 23, 2016

(30) Foreign Application Priority Data
Feb. 27, 2014 (JP) 2014-036682

(51) Int. Cl. G02F 1/13363; C09K 19/44; C09K 19/38; C09K 19/46; C09K 19/30; C09K 19/32

(52) U.S. Cl. CPC G02F 1/13363; C09K 19/3003; C09K 19/3066; C09K 19/322; C09K 19/3814; C09K 19/46; C09K 19/44; C09K 2019/3004; C09K 2019/3009; C09K 2019/301; C09K 2019/3016; G02F 2001/133565

(57) ABSTRACT

The present invention provides a liquid crystal display device which can prevent a decrease in a voltage holding ratio (VHR) of a liquid crystal layer and an increase in ion density (ID) and solve a problem of a display defect such as white spots, alignment irregularities, burn-in, or the like. The present-invention provides a liquid crystal display device which uses a liquid crystal composition containing a liquid crystal compound having a specific structure as a liquid crystal layer, and an optically anisotropic body obtained by polymerizing a polymerizable liquid crystal composition containing a polymerizable liquid crystal compound having a specific structure at a specific ratio as an in-cell type retardation film. Since the liquid crystal display device of the present-invention can prevent a decrease in a voltage holding ratio (VHR) of a liquid crystal layer and an increase in ion density (ID) and suppress the occurrence of a display defect, such as burn-in or the like, the liquid crystal display device of the present invention is useful particularly for an active matrix driving VA mode or PSVA mode liquid crystal display device, and can be applied to liquid crystal display devices such as liquid crystal televisions, monitors, mobile phones, smart phones, or the like.

### TECHNICAL FIELD

The present invention relates to a liquid crystal display device.

### BACKGROUND ART

A liquid crystal display device is used for various electric home appliances, measuring equipment, a panel for an automobile, a word processor, an electronic notebook, a printer, a computer, a television, or the like, including a clock and an electronic calculator. As a liquid crystal display system, representative examples thereof include a Twisted Nematic (TN) mode, a Super Twisted Nematic (STN) mode, a Dynamic Light Scattering (DS) mode, a Guest-Host (GH) mode, an In-Plane Switching (IPS) mode, an Optically Compensated Birefringence (OCB) mode, an Electrically Controlled Birefringence (ECB) mode, a Vertical Alignment (VA) mode, a Color Super Homeotropic (CHS) mode, and a Ferroelectric Liquid Crystal (FLC). Also, as a driving system, multiplex driving has become common from static driving in the related art, and a passive matrix system and, in recent years, an active matrix (AM) system driven by a Thin Film Transistor (TFT) or a Thin Film Diode (TFD) have been mainstream.

In general, the liquid crystal display device has view angle dependency due to an influence of birefringence properties of a liquid crystal molecule. In order to improve this view angle dependency, an optical film (also referred to as an optical compensation film) having birefringence properties different from those of the liquid crystal molecule is used. In a liquid crystal display device using a bar-like liquid crystal molecule having negative dielectric anisotropy, in a case where a polarizing plate is only included in a liquid crystal cell, for example, if the liquid crystal cell is obliquely seen, there is a problem in the view angle properties that light leakage occurs.

In order to solve the problem of these view angle properties, for example, a method in which a piece of a biaxial retardation film is respectively disposed between the liquid crystal cell and an upper polarizing plate or a lower polarizing plate, a method in which a piece of the uniaxial retardation film and a piece of a completely biaxial retardation film are respectively disposed on the upper liquid crystal cell and the lower liquid crystal cell, or a method in which the uniaxial retardation film and the completely biaxial retardation film are disposed on one side of the liquid crystal cell, has been used.

In addition, a liquid crystal display device (out-cell type) in which the retardation film is disposed on the outside of the liquid crystal cell has been mainstream, but in recent years, a liquid crystal display device (in-cell type) in which the retardation film is disposed in the inside of the liquid crystal cell has been developed, from a viewpoint of reducing the thickness and weight of the liquid crystal display device and improving productivity caused by elimination of an attachment step. For example, usually, an example in which a negative C plate is disposed on the inside of the liquid crystal cell (PTLs 1 and 2), or an example in which retardation films of a positive A plate and a negative C plate are disposed, has been known (PTL 3).

In a liquid crystal material constituting a liquid crystal layer, impurities have been thoroughly controlled, since electric properties of a display device are greatly affected if the impurities remain in the material. In addition, with regard to the material forming an alignment film, it has been known that direct contact of the alignment film with the liquid crystal layer and movement of the impurities remaining in the alignment film to the liquid crystal layer affect the electric properties of the liquid crystal layer, and properties of the liquid crystal display device resulting from the impurities in the material of the alignment film have been reviewed.

In the in-cell type liquid crystal display device, the retardation film exists within the cell, but since a transparent electrode layer and the alignment film are interposed between the liquid crystal layer and the retardation film, it is considered that a direct influence to the liquid crystal layer is considerably less compared to the alignment film material. However, normally, the alignment film merely has a film thickness of 0.1 μm or less and the transparent-electrode layer also has a film thickness substantially the same as that of the alignment film. Accordingly, it cannot be said that the liquid crystal layer and the retardation film are disposed in a completely isolated environment, and it is conceived that even in the in-cell type retardation film, the impurities included therein affect the liquid crystal layer in the same manner as the alignment film material. The retardation film has possibility to cause a display defect such as a decrease in a voltage holding ratio (VHR) of the liquid crystal layer, white spots caused by an increase in ion density (ID), alignment irregularities, burn-in, or the like, because of the impurities included in the retardation film via the alignment film and the transparent electrode. However, the influence on the liquid crystal layer due to the impurities in the retardation film has not been reviewed.

### CITATION LIST

### Patent Literature

[PTL 1] JP-A-2012-78431

[PTL 2] JP-A-2000-221506

[PTL 3] WO 11/007669

### SUMMARY OF INVENTION

### Technical Problem

An object of the present invention is to provide, a liquid crystal display device which can prevent a decrease in a voltage holding ratio (VHR) of a liquid crystal layer and an increase in ion density (ID) and solve a problem of a display defect such as white spots, alignment irregularities, burn-in, or the like, by using an in-cell type retardation film which uses a liquid crystal composition containing a liquid crystal compound having a specific structure and a polymerizable liquid crystal composition containing a polymerizable liquid crystal compound having a specific structure at a specific ratio.

### Solution to Problem

As a result of thorough study on a combination of a structure of the liquid crystal material which configures the liquid crystal layer and a polymerizable liquid crystal for constituting the retardation film in order to solve the aforementioned problem, the present, inventors have found that a liquid crystal display device, which uses a liquid, crystal composition containing a liquid crystal compound having a specific structure as a liquid crystal layer and an optically anisotropic body obtained by polymerizing a polymerizable liquid crystal composition containing a polymerizable liquid crystal compound having a specific structure at a specific ratio as a retardation film, prevents a decrease in a voltage holding ratio (VHR) of the liquid crystal layer and an increase in ion density (ID) and solves a display defect such as white spots, alignment irregularities, burn-in, or the like, thereby completing the present invention.

In other words, the present invention provides a liquid crystal display device including a first substrate; a second substrate; a liquid crystal layer interposed between the first substrate and the second substrate; a retardation film between a pair of the substrates; and at least a pair of electrodes, in which the liquid crystal layer is composed of a liquid crystal composition which contains a compound represented by General Formula (I) in an amount of 10% to 50% by weight, and a compound represented by General Formula (II) in an amount, of 35% to 80% by weight:

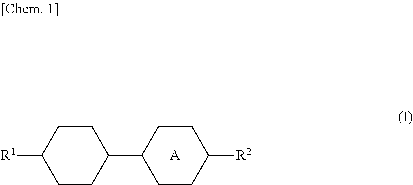

wherein R¹ and R² each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, and A represents a 1,4-phenylene group or a trans-1,4-cyclohexylene group) and

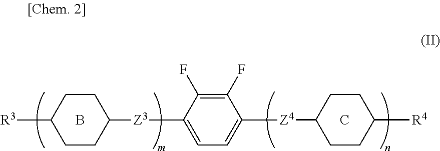

wherein R³ and R⁴ each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, Z³ and Z⁴ each independently represent a single bond, —CH═CH—, —C≡C—, —CH₂CH₂—, —(CH₂)₄—, —COO—, —OCO—, —OCH₂—, —CH₂O—, —OCF₂—, or —CF₂O—, B and C each independently represent a 1,4-phenylene group or a trans-1,4-cyclohexylene group, which may be fluorinated, m and n each independently represent an integer of 0 to 4, and m+n=1 to 4), and the retardation film is an optically anisotropic body obtained by polymerizing a polymerizable liquid crystal composition containing a liquid crystal compound having two or more polymerizable functional groups in an amount of 25% by weight or more.

### Advantageous Effects of Invention

The liquid crystal display device of the present invention can prevent a decrease in a voltage holding ratio (VHR) of a liquid crystal layer and an increase in ion density (ID) and prevent the occurrence of a display defect such as white spots, alignment irregularities, burn-in, or the like, by using the liquid crystal composition containing the liquid crystal compound having a specific structure as the liquid crystal layer, and the optically anisotropic body obtained by polymerizing the polymerizable liquid crystal composition containing the polymerizable liquid crystal compound having a specific structure at a specific ratio as the retardation film.

### BRIEF DESCRIPTION OF DRAWINGS

FIG. 1 is a diagram illustrating one example of a liquid crystal display device of the present invention.

FIG. 2 is a diagram illustrating one example of the liquid crystal display device of the present invention.

FIG. 3 is a diagram illustrating one example of the liquid crystal display device of the present invention.

FIG. 4 is a diagram illustrating one example of the liquid crystal display device of the present invention.

FIG. 5 is a diagram illustrating one example of the liquid crystal display device of the present invention.

FIG. 6 is a diagram illustrating one example of the liquid crystal display device of the present invention.

FIG. 7 is a diagram illustrating one example of the liquid crystal display device of the present invention.

FIG. 8 is a diagram illustrating one example of the liquid crystal display device of the present invention.

FIG. 9 is a diagram illustrating one example of the liquid crystal display device of the present invention.

FIG. 10 is a diagram illustrating one example of the liquid crystal display device of the present invention.

FIG. 11 is a diagram illustrating one example of the liquid crystal display device of the present invention.

### REFERENCE SIGNS LIST

(1) Polarising layer

(2) Adhesive layer

(3) Optically transparent substrate

(4) Color filter layer

(5) Planarizing layer

(6) Alignment film for a retardation film

(7) Retardation film 1 using specific polymerizable liquid crystal composition

(8) Retardation film 2 using specific polymerizable liquid crystal composition

(9) Transparent electrode layer

(10) Alignment film

(11) Specific liquid crystal composition

(12) Alignment film

(13) Pixel electrode layer

(14) Optically transparent substrate

(15) Adhesive layer

(16) Polarizing layer

(17) Backlight

### Description of Embodiments

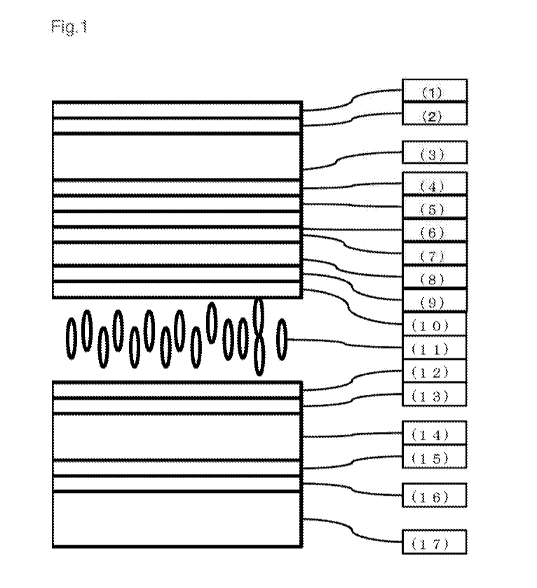

FIG. 1 illustrates one example of the liquid crystal display device of the present invention, which is configured as follows. A polarizing plate which includes a polarizing layer (1), an adhesive layer (2), and an optically transparent substrate (3) includes a color filter layer (4) and a planarizing layer (5). Further, a first retardation film (7) and a second retardation film (8) using a specific polymerizable composition are included between an alignment film for a retardation film (6) and a transparent electrode layer (9). A specific liquid crystal composition (11) is interposed between alignment film layers (10) and (12).

A transparent, electrode layer (9), which is a common electrode, and a color filter layer (4) are included between one alignment film (10) of two substrates having the alignment film (12) and a polarizing layer, and a substrate (3), and a pixel electrode layer (13) is included between the other alignment, film (10) and an optically transparent substrate (14). An adhesive layer (15) and a polarizing layer (16) are included with respect to a glass substrate (14) on a backlight (17) side.

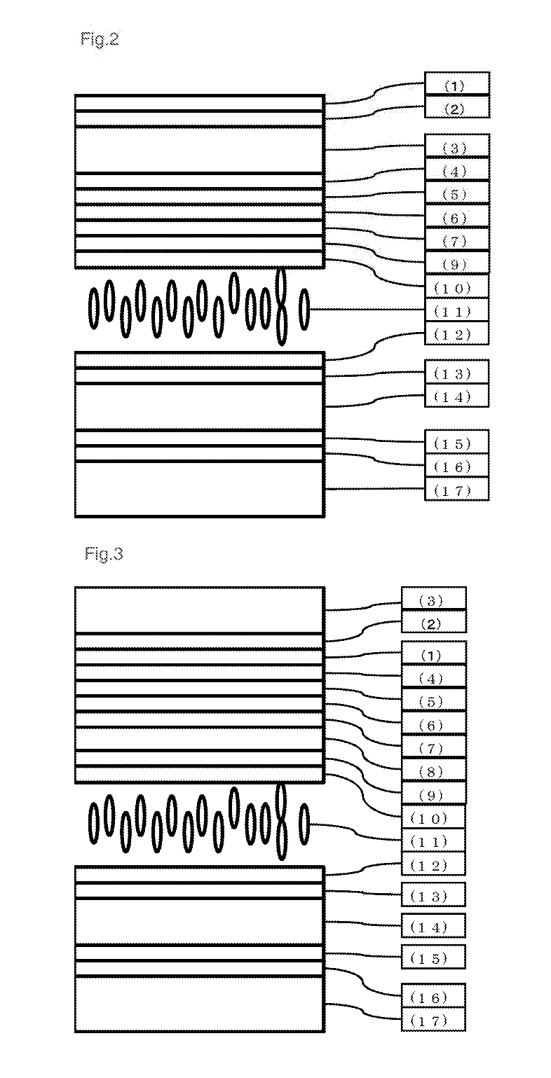

The two substrates in the display device are attached to each other by a sealing material or a sealant, disposed in the peripheral area, and in many cases, granular spacers or column spacers composed of a resin formed by a photolithography method are disposed therebetween in order to retain a distance between the substrates. In addition, FIG. 2 illustrates one example of a liquid crystal display device using only the retardation film (7) without using the retardation film (8).

(Liquid Crystal Layer)

The liquid crystal layer in the liquid crystal display device of the present invention is composed of a liquid crystal composition which contains a compound represented by General Formula (I) in an amount of 10% to 50% by weight, and a compound represented by General Formula (II) in an amount of 35% to 80% by weight.

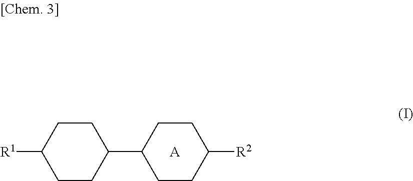

In the formula, R¹ and R² each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, and A represents a 1,4-phenylene group or a trans-1,4-cyclohexylene group.

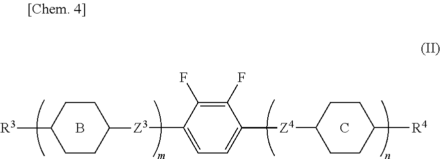

In the formula, R³ and R⁴ each independently represent an alkyl group having 1 to 3 carbon atoms, an alkenyl group having 2 to 8 carbon atoms, an alkoxy group having 1 to 8 carbon atoms, or an alkenyloxy group having 2 to 8 carbon atoms, Z³ and Z⁴ each independently represent a single bond, —CH═CH—, —C≡C—, —CH₂CH₂—, —(CH₂)₄—, —COO—, —OCO—, —OCH₂—, —CH₂O—, —OCF₂—, or —CF₂O—, B and C each independently represent a 1,4-phenylene group or a trans-1,4-cyclohexylene group, which may be fluorinated, m and n each independently represent an integer of 0 to 4, and m+n=1 to 4.

The liquid crystal layer in the liquid crystal display device of the present invention, contains 10% to 50% by weight of the compound represented by General Formula (I), and the liquid crystal layer in the liquid crystal display device of the present invention preferably contains 15% to 4 8% by weight and more preferably contains 20% to 46% by weight.

In General Formula (I), R¹ and R² each independently represent an alkyl group having 1 to S carbon atoms, an alkenyl group having 2 to 8 carbon atoms, an alkoxy group having 1 to 8 carbon atoms, or an alkenyloxy group having 2 to 8 carbon atoms, but in a case where A represents a trans-1,4-cyclohexylene group,

R¹ and R² preferably represent an alkyl group having 1 to 5 carbon atoms, an alkenyl group having 2 to 5 carbon atoms, an alkoxy group having 1 to 5 carbon atoms, or an alkenyloxy group having 2 to 5 carbon atoms, and

more preferably represent an alkyl group having 2 to 5carbon atoms, an alkenyl group having 2 to 4 carbon atoms, an alkoxy group having 1 to 4 carbon atoms, or an alkenyloxy group having 2 to 4 carbon atoms.

R¹ preferably represents an alkyl group, and in this case, an alkyl group having 2, 3, or 4 carbon atoms is particularly preferable. In a case where R¹ represents an alkyl group having 3 carbon atom, R² preferably represents an alkyl group having 2, 4, or 5 carbon atoms or an alkenyl group having 2 to 3 carbon atoms, and R² more preferably represents an alkyl group having 2 carbon atoms.

In a case where A represents a 1,4-phenylene group, R¹ and R² preferably represent an alkyl group having 1 to 5 carbon atoms, an alkenyl group having 4 to 5 carbon atoms, an alkoxy group having 1 to 5 carbon atoms, or an alkenyloxy group, having 3 to 5 carbon atoms, and

R¹ and R² more preferably represent an alkyl group having 2 to 5 carbon atoms, an alkenyl group having 4 to 5 carbon atoms, an alkoxy group having 1 to 4 carbon atoms, or an alkenyloxy group having 2 to 4 carbon atoms.

R¹ preferably represents an alkyl group, and in this case, an alkyl group having 1, 3, or 5 carbon atoms is particularly preferable. Further, R² preferably represents an alkoxy group having 1 to 2 carbon atoms.

The content of the compound represented by General Formula (I) in which at least one of a substituent of R¹ and R² is an alkyl group having 3 to 5 carbon atoms is preferably 50% by weight or more, more preferably 70% by weight or more, and still more preferably 80% by weight or more in the compound represented by General Formula (I). The content of the compound represented by General Formula (I) in which at least one of a substituent of R¹ and R² is an alkyl group having 3 carbon atoms is preferably 50% by weight or more, more preferably 70% by weight or more, still more preferably 30% by weight or more, and most preferably 100% by weight in the compound represented by General Formula (I).

One type or two or more types of the compound represented by General Formula (I) may be contained, and at least one type of the compound in which A represents a trans-1,4-cyclohexylene group, and the compound in which A represents a 1,4-phenylene group is preferably contained respectively.

The content of the compound represented by General Formula (I) in which A represents a trans-1,4-cyclohexylene group is preferably 50% by weight or more, more preferably 70% by weight or more, and still more preferably 80% by weight or more in the compound represented by General Formula (I).

Preferred examples of the compound represented by General Formula (I) include compounds represented by General Formula (Ia) to General Formula (Ik) shown below.

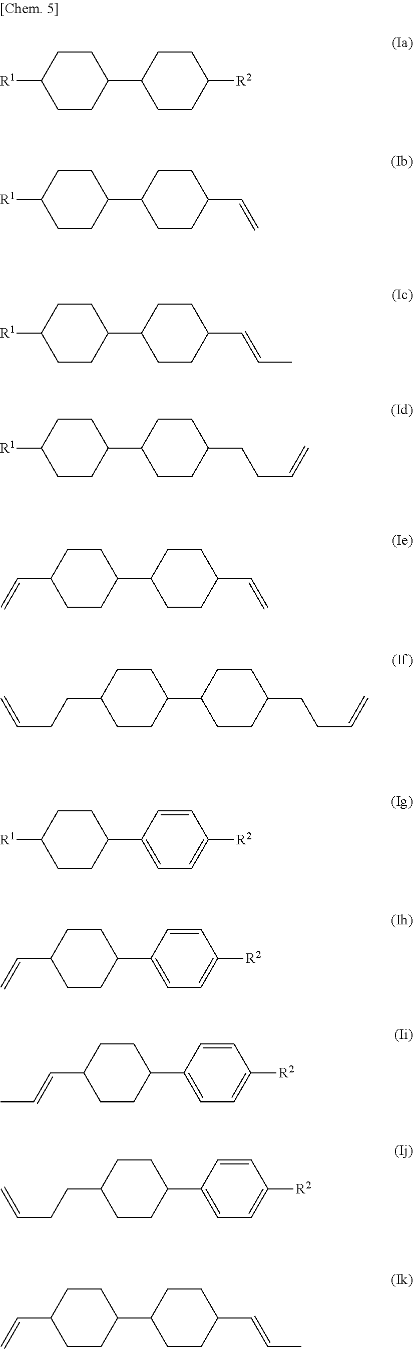

In the formulas, R¹ and R² each independently represent an alkyl group having 1 to 5 carbon atoms or an alkoxy group having 1 to 5 carbon atoms, and the same embodiment as that of R¹ and R2 in General Formula (I) is preferable.

In General Formula (Ia) to General Formula (Ik), General Formula (Ia), General Formula (Ib), General Formula (Ic), and General Formula (Ig) are preferable, General Formula (Ia), General Formula (Ib), and General Formula (Ic) are more preferable, and General Formula (Ia) and General Formula (Ib) are more preferable. In a case where a response speed is important, General Formula (Ib) and General Formula (Ic) are preferable, and a combination of General Formula (Ib) and General Formula (Ic) is more preferable. In a case where reliability is important, General Formula (Ia) is preferable.

From these viewpoints, the content of the represented by General Formula (Ia), General Formula (Ib), and General Formula (Ic) is preferably 80% by weight or more, more preferably 90% by weight or more, still more preferably 95% by weight or more, and most preferably 100% by weight in the compound represented by General Formula (I). The content of the compound represented by General Formula (Ia) is 65% by weight to 100% by weight in the compound represented by General Formula (I), the content of the compounds represented by General Formula (Ib) and General Formula (Ic) is 0% by weight to 35% by weight in the compound represented by General Formula (I), or the content of the compound represented by General Formula (Ia) is 0% by weight to 10% by weight in the compound represented by General Formula (I), and the content of the compounds represented by General Formula (Ib) and General Formula (Ic) is preferably 90% by weight to 100% by weight in the compound represented by General Formula (I).

The liquid crystal layer in the liquid, crystal display device of the present invention contains 35% to 80% by weight of the compound represented by General Formula (II), and the liquid crystal layer in the liquid crystal display device of the present invention preferably contains 40% to 75% by weight and more preferably contains 45% to 70% by weight.

In General Formula (II), R³ represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, and R³ preferably represents an alkyl group having 1 to 5 carbon atoms or an alkenyl group having 2 to 5 carbon atoms, more preferably represents an alkyl group having 2 to 5 carbon atoms or an alkenyl group having 2 to 4 carbon atoms, still more preferably represents an alkyl group having 3 to 5 carbon atoms or an alkenyl group having 2 or 3 carbon atoms, particularly preferably represents an alkyl group having 2 or 3 carbon atoms or an alkenyl group having 2 carbon atoms, and most preferably represents an alkyl group having 2 or 3 carbon atoms.

R⁴ represents an alkyl group having 1 to 8 carbon atoms, an alkenyl group having 4 to 8 carbon atoms, an alkoxy group having 1 to 8 carbon atoms, or an alkenyloxy group having 3 to 8 carbon atoms, and R⁴ preferably represents an alkyl group having 1 to 5 carbon atoms or an alkoxy group having 1 to 5 carbon atoms, more preferably represents an alkyl group having 1 to 3 carbon atoms or an alkoxy group having 1 to 4 carbon atoms, and still more preferably represents an alkoxy group having 2 to A carbon atoms. Z³ and Z⁴ each independently represent a single bond, —CH═CH—, —C≡C—, —CH₂CH₂—, —(CH₂)₄—, —COO—, —OCO—, —OCH₂—, —CH₂O—, —OCF₂—, or—CF₂O—, and Z³ and Z⁴ preferably represent a single bond, —CH₂CH₂—, —COO—, —OCH₂—, —CH₂O—, —OCF₂—, or —CF₂O— and more preferably represent a single bond or —CH₂O—.

m and n each independently represent an integer of 0 to 3 and preferably represent an integer of 0 to 2, and m+n preferably satisfies 1 to 3 and more preferably satisfies 1 to 2.

The liquid crystal layer in the liquid crystal display device of the present invention may contain 3 types to 10 types of the compound represented by General Formula (II), preferably contain 4 types to 9 types and more preferably 5 types to 8 types.

Preferred examples of the compound represented by General Formula (II) include a compound represented by the following General Formula (II-1) or (II-2).

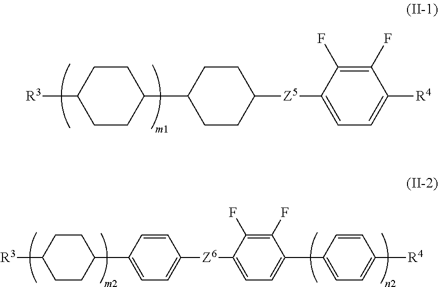

In the formulas, R³ and R⁴ each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, Z⁵ and Z⁶ each independently represent a single bond, —CH═CH—, —C≡C—, —CH₂CH₂—, —(CH₂)₄—, —COO—, —OCO—, —OCH₂—, —CH₂O—, —OCF₂—, or —CF₂O—, and m1, m2 and n2 each independently represent 0 or 1.

In General Formula (II-1), R³ preferably represents an alkyl group having 1 to 5 carbon atoms or an alkenyl group having

2 to 5 carbon atoms, more preferably represents an alkyl group having 2 to 5 carbon atoms or an alkenyl group having 2 to 4 carbon atoms, still more preferably represents an alkyl group having 3 to 5 carbon atoms or an alkenyl group having 2 carbon atoms, and particularly preferably represents an alkyl group having 3 carbon atoms, R⁴ preferably represents an alkyl group having 1 to 5 carbon atoms or an alkoxy group having 1 to 5 carbon atoms, more preferably represents an alkyl group having 1 to 3 carbon atoms or an alkoxy group having 1 to 3 carbon atoms, still more preferably represents an alkyl group having 3 carbon atoms or an alkoxy group having 2 carbon atoms, and particularly preferably represents an alkoxy group having 2 carbon atoms, and Z⁵ preferably represents a single bond, —CH₂CH₂—, —COO—, —OCH₂—, —CH₂O—, —OCF₂—, or —CF₂O—, and more preferably represents a single bond or —CH₂O—.

The liquid crystal layer in the liquid, crystal display device of the present invention preferably contains 15% by weight to 60% by weight of the compound represented by General Formula (II-1), more preferably contains 17% by weight to 50% by weight, more preferably contains 18% by weight to 40% by weight, and more preferably contains 19% by weight to 30% by weight.

The liquid crystal layer in the liquid crystal display device of the present invention may contain one type or two or more types of the compound represented by General Formula (II-1), and the liquid crystal layer in the liquid crystal display device of the present invention preferably contains

1 type to 6 types, preferably contains 2 types to 5 types, and preferably contains 3 types or 4 types.

In General Formula (II-2), R³ preferably represents an alkyl group having 1 to 5 carbon atoms or an alkenyl group having 2 to 5 carbon atoms, more preferably represents an alkyl group having 2 to 5 carbon atoms or an alkenyl group having 2 to 4 carbon atoms, still more preferably represents an alkyl group having 3 to 5 carbon atoms or an alkenyl group having 2 carbon atoms, and particularly preferably represents an alkyl group having 2 or 3 carbon atoms, R⁴ preferably represents an alkyl group having 1 to 5 carbon atoms or an alkoxy group having 1 to 5 carbon atoms,, more preferably represents an alkyl group having 1 to 3 carbon atoms or an alkoxy group having 1 to 3 carbon atoms, and still more preferably represents an alkyl group having 3 carbon atoms or an alkoxy group having 2 carbon atoms, and Z⁴ preferably represents a single bond, —CH₂CH₂—, —COO—, —OCO—, —OCH₂—, —CH₂O—, —OCF₂—, or —CF₂O— and more preferably represents a single bond or —CH₂O—.

The liquid crystal layer in the liquid crystal display device of the present invention preferably contains 10% by weight to 50% by weight of the compound represented by General Formula (II-2), preferably contains 15% by weight to 45% by weight, preferably contains 20% by weight to 4 0% by weight, and preferably contains 25% by weight to 35% by weight.

The liquid crystal layer in the liquid crystal display device of the present invention may contain 1 type or 2 or more types of the compound represented by General Formula (II-2), and the liquid crystal layer in the liquid crystal display device of the present invention preferably contains 1 type to 6 types, preferably contains 2 types to 5 types, and preferably contains 3 types or 4 types.

Specific preferred examples of the compound represented by General Formula (II-1) include compounds represented by General Formula (II-1a) to General Formula (II-1d) shown below.

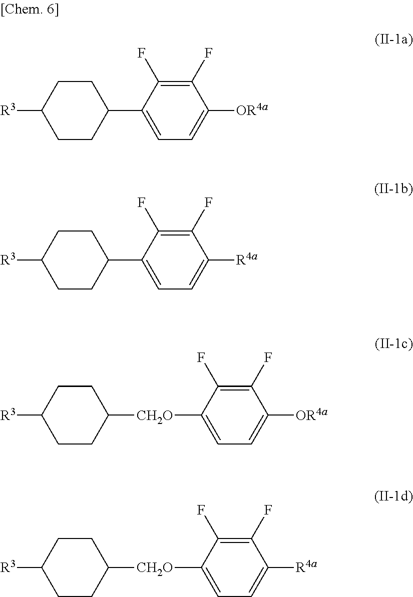

In the formulas, R³ represents an alkyl group having 1 to 5 carbon atoms or an alkenyl group having 2 to 5 carbon atoms, and R^{4a} represents an alkyl group having 1 to 5 carbon atoms.

In General Formula (II-1a) and General Formula (II-1c), R³ preferably represents the same embodiment as in General Formula (II-1). R^{4a} preferably represents an alkyl group having 1 to 3 carbon atoms, more preferably represents an alkyl group having 1 or 2 carbon atoms, and particularly preferably represents an alkyl group having 2 carbon atoms.

In General Formula (II-1b) and General Formula (II-1d), R³ preferably represents the same embodiment as in General Formula (II-1). R^{4a} preferably represents an alkyl group having 1 to 3 carbon atoms, more preferably represents an alkyl group having 1 or 3 carbon atoms, and particularly preferably represents an alkyl group having 3 carbon atoms.

Among General Formula (II-1a) to General Formula (II-1d), in order to increase an absolute value of dielectric anisotropy, General Formula (II-1a) and General Formula (II-1c) are preferable and General Formula (II-1a) is preferable.

The liquid crystal layer in the liquid crystal display device of the present invention preferably contains 1 type or 2 or more types of the compounds represented by General Formula (II-1a) to General Formula (II-1d) and preferably 1 type or 2 types, and the liquid crystal layer in the liquid crystal display device of the present invention preferably contains 1 type or 2 types of the compound represented by General Formula (II-1a).

In addition, specific preferred examples of the compound represented by General Formula (II-1) include compounds, represented by General Formula (II-1e) to General Formula (II-1h) shown below.

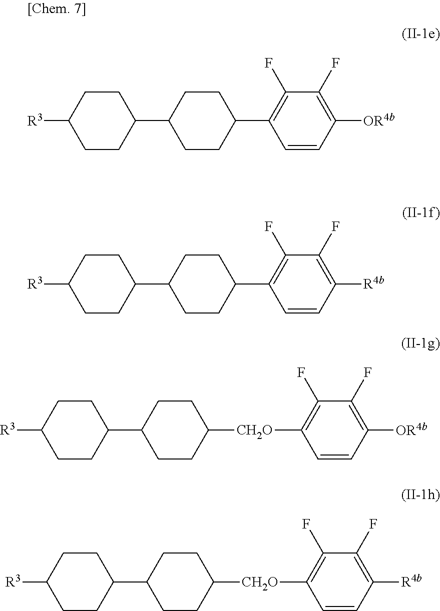

In the formulas, R³ represents an alkyl group having 1 to 5 carbon atoms or an alkenyl group having 2 to 5 carbon atoms and R^{4b} represents an alkyl group having 1 to 5 carbon atoms.

In General Formula (II-1e) and General Formula (II-1g), R³ preferably represents the same embodiment as in General Formula (II-1). R^{4b} preferably represents an alkyl group having 1 to 3 carbon atoms, more preferably represents an alkyl group having 1 or 2 carbon atoms, and particularly preferably represents an alkyl group having 2 carbon atoms.

In General Formula (II-1f) and General Formula (II-1h), R³ preferably represents the same embodiment as in General Formula (II-1). R^{4b} preferably represents an alkyl group having 1 to 3 carbon atoms, more preferably represents an alkyl group having 1 or 3 carbon atoms, and particularly preferably represents an alkyl group having 3 carbon atoms.

Among General Formula (II-1e) to General Formula (II-1h), in order to increase an absolute value of dielectric anisotropy, General Formula (II-1e) and General Formula (II-1g) are preferable.

Specific preferred examples of the compound represented by General Formula (II-2) include compounds represented by General Formula (II-2a) to General Formula (II-2d) shown below.

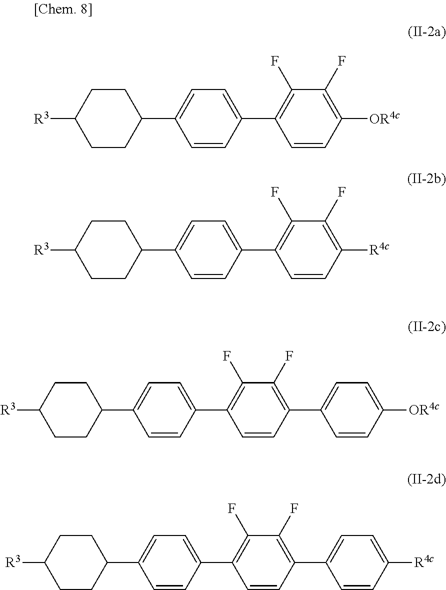

In the formulas, R³ represents an alkyl group having 1to 5 carbon atoms or an alkenyl group having 2 to 5 carbon atoms, R^{4c} represents an alkyl group having 1 to 5 carbon atoms, and R³ and R^{4c} preferably represent the same embodiment as R³ and R⁴ in General Formula (II-2).

In General Formula (II-2a) and General Formula (II-2c), R⁵ preferably represents the same embodiment as in General Formula (II-2), R^{4c} preferably represents an alkyl group having 1 to 3 carbon atoms, more preferably represents an alkyl group having 1 or 2 carbon atoms, and particularly preferably represents an alkyl group having 2 carbon atoms.

In General Formula (II-2b) and General Formula (II-2d), R³ preferably represents the same embodiment as in General Formula (II-2). R^{4c} preferably represents an alkyl group having 1 to 3 carbon atoms, more preferably represents an alkyl group having 1 or 3 carbon atoms, and particularly preferably represents an alkyl group having 3 carbon atoms.

Among General Formula (II-2a) to General Formula (II-2d), in order to increase an absolute value of dielectric anisotropy, General Formula (II-2a) and General Formula (II-2c) are preferable, and General Formula (II-2a) is particularly preferable.

In addition, specific preferred examples of the compound represented by General Formula (II-2) include compounds represented by General Formula (II-2e) to General Formula (II-2j) shown below.

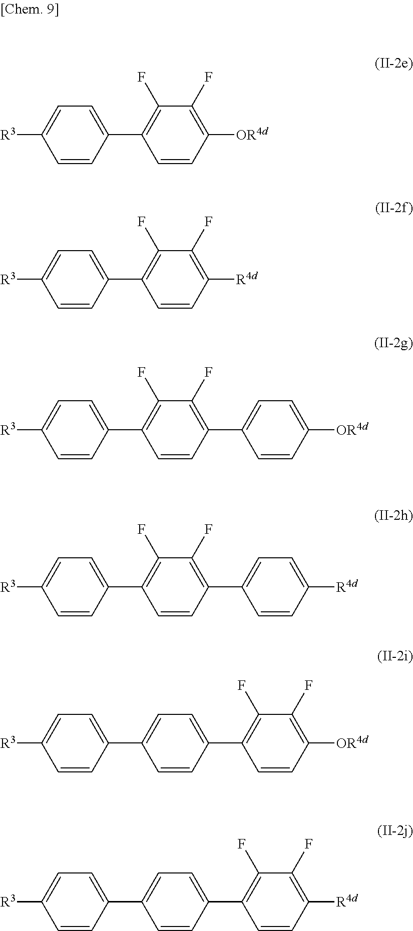

In the formulas, R³ represents an alkyl group having 1to 5 carbon atoms or an alkenyl group having 2 to 5 carbon atoms, R^{4d} represents an alkyl group having 1 to 5 carbon atoms, and R³ and R^{4d} preferably represent the same embodiment as R³ and R⁴ in General Formula (II-2).

In General Formula (II-2e), General Formula (II-2g), and General Formula (II-2i), R³ preferably represents the same embodiment as in General Formula (II-2). R^{4d} preferably represents an alkyl group having 1 to 3 carbon atoms, more preferably represents an alkyl group having 1 or 2 carbon atoms, and particularly preferably an alkyl group having 2 carbon atoms.

In General Formula (II-2f), General Formula (II-2h), and General Formula (II-2j), R³ preferably represents the same embodiment as in General Formula (II-2). R^{4d} preferably represents an alkyl group having 1 to 3 carbon atoms, more preferably represents an alkyl group having 1 or 3 carbon atoms, and particularly preferably represents an alkyl group having 2 carbon atoms.

Among General Formula (II-2e) to General Formula (II-2i), General Formula (II-2e) and General Formula (II-2h) are preferable.

In the liquid crystal layer in the liquid crystal display device of the present invention, the total content of the compounds represented by General Formula (I) and General Formula (II) is preferably 75% by weight to 100% by weight, preferably 80% by weight to 100% by weight, preferably 85% by weight to 100% by weight, preferably 90% by weight to 100% by weight, and preferably 95% by weight to 100% by weight.

The liquid crystal layer in the liquid crystal display device of the present invention may further contain a compound represented by General Formula (III).

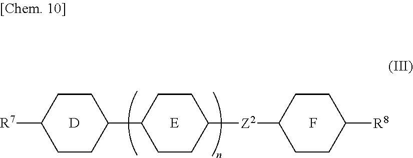

In the formula, R⁷ and R⁸ each independently represent an alkyl group having 1 to 8 carbon atoms, an alkenyl group having 2 to 8 carbon atoms, an alkoxy group having 1 to 8 carbon, atoms or an alkenyloxy group having 2 to 8 carbon atoms, D, E, and F each independently represent a 1,4-phenylene group or a trans-1,4-cyclohexylene, which may be fluorinated, Z² represents a single bond, —OCH₂—, —OCO—, —CH₂O—, or —COO—, —OCO—, and n represents 0, 1, or 2. However, the compounds represented by General Formula (I), General Formula (II-1) and General Formula (II-2) are excluded.

The compound represented by General Formula (III) is preferably contained 1% to 20%, preferably 2% to 15%, and preferably 4% to 10%.

In General Formula (III), R⁷ represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, but

in a case where D represents a trans-1,4-cyclohexylene, R⁷ preferably represents an alkyl group having 1 to 5 carbon atoms or an alkenyl group having 2 to 5 carbon atoms, more preferably represents an alkyl group having 2 to 5 carbon atoms or an alkenyl group having 2 to 4 carbon atoms, still more preferably an alkyl group having 3 to 5 carbon atoms or an alkenyl group having 2 or 3 carbon atoms, and particularly preferably an alkyl group having 3 carbon atoms, and

in a case where D represents a 1,4-phenylene group, which may be fluorinated, R⁷ preferably represents an alkyl group having 1 to 5 carbon atoms or an alkenyl group having 4 or 5 carbon atoms, more preferably represents an alkyl group having 2 to 5 carbon atoms or an alkenyl group having 4 carbon atoms, and still more preferably represents an alkyl group having 2 to 4 carbon atoms.

R⁸ represents an alkyl group having 1 to 8 carbon atoms, an alkenyl group having 2 to 8 carbon, atoms, an alkoxy group having 1 to 8 carbon atoms, or an alkenyloxy group having 3 to 8 carbon atoms.

In a case where F represents a trans-1,4-cyclohexylene, R⁸ preferably represents an alkyl group having 1 to 5 carbon atoms or an alkenyl group having 2 to 5 carbon atoms, more preferably represents an alkyl group having 2 to 5 carbon atoms or an alkenyl group having 2 to 4 carbon atoms, still more preferably represents an alkyl group having 3 to 5 carbon atoms or an alkenyl group having 2 or 3 carbon atoms, and particularly preferably represents an alkyl group having 3 carbon atoms, and in a case where F represents a 1, 4-phenylene group, which may be fluorinated, R⁸ preferably represents an alkyl group having 1 to 5 carbon atoms or an alkenyl group having 4 or 5 carbon atoms, more preferably represents an alkyl group having 2 to 5 carbon atoms or an alkenyl group having 4 carbon atoms, and still more preferably represents an alkyl group having 2 to 4 carbon atoms.

In a case where R⁷ and R⁸ represent an alkenyl group, and D or F to be bonded thereto represents a 1, 4-phenylene group, which may be fluorinated, as the alkenyl group having 4 or 5 carbon atoms, the following structure is preferable.

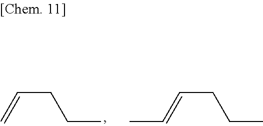

In the formulas, a right terminal is bonded to a ring structure.

Even in this case, an alkenyl group having 4 carbon atoms is still more preferable.

D, E, and F each independently represent a 1,4-phenylene group or trans-1,4-cyclohexylene, which may be fluorinated, and D, E, and F preferably represent a 2-fluoro-1,4-phenylene group, a 2,3-difluoro-1,4-phenylene group, a 1,4-phenylens group, or a trans-1,4-cyclohexylene, more preferably represent a 2-fluoro-1,4-phenylene group or a 2,3-difluoro-1,4-phenylene group, or a 1,4-phenylene a group, and preferably represent a 2,3-difluoro-1,4-phenylene group or a 1,4-phenylene group. Z² represents a single bond, —OCH₂—, —OCO—, —CH₂O—, or —COO—, and preferably represents a single bond, —CF₂O—, or —COO— and preferably represents a single bond.

n represents 0, 1, or 2 and preferably represents 0 or 1. Also, in a case where Z² represents a substituent other than a single bond, n preferably represents 1.

As the compound represented by General Formula (III), in a case where n represents 1, compounds represented by General Formula (III-1c) to General Formula (III-1e) are preferable from a viewpoint of increasing negative dielectric anisotropy, and compounds represented by General Formula (III-1f) to General Formula (III-1j) are preferable from a viewpoint of increasing a response speed.

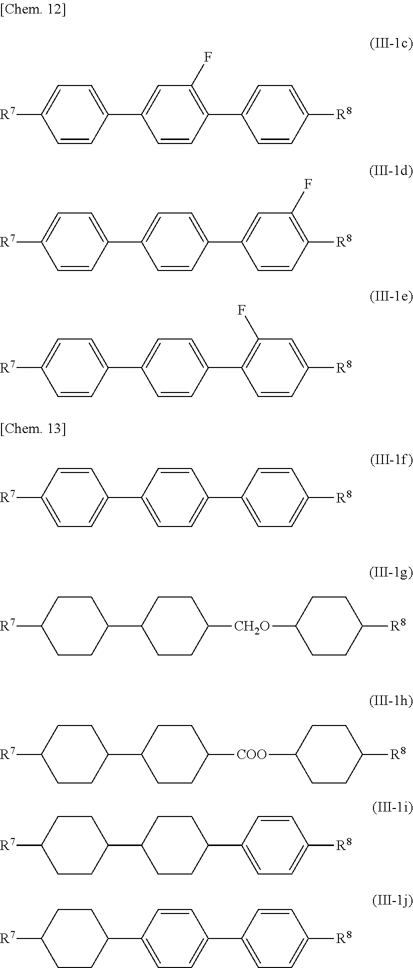

In the formulas, R⁷ and R⁸ each independently represent an alkyl group having 1 to 5 carbon atoms, an alkenyl group having 2 to 5 carbon atoms, or an alkoxy group having 1 to 5 carbon atoms, and R⁷ and R⁸ represent the same embodiment as R⁷ and R⁸ in General Formula (III).

As the compound represented by General Formula (III), in a case where n is 2, compounds represented by General Formula (III-2a) to General Formula (III-2h) are preferable from a viewpoint of increasing negative dielectric anisotropy, compounds represented by General Formula (III-2j) to General Formula ((III-2l) are preferable from a viewpoint of increasing a response speed.

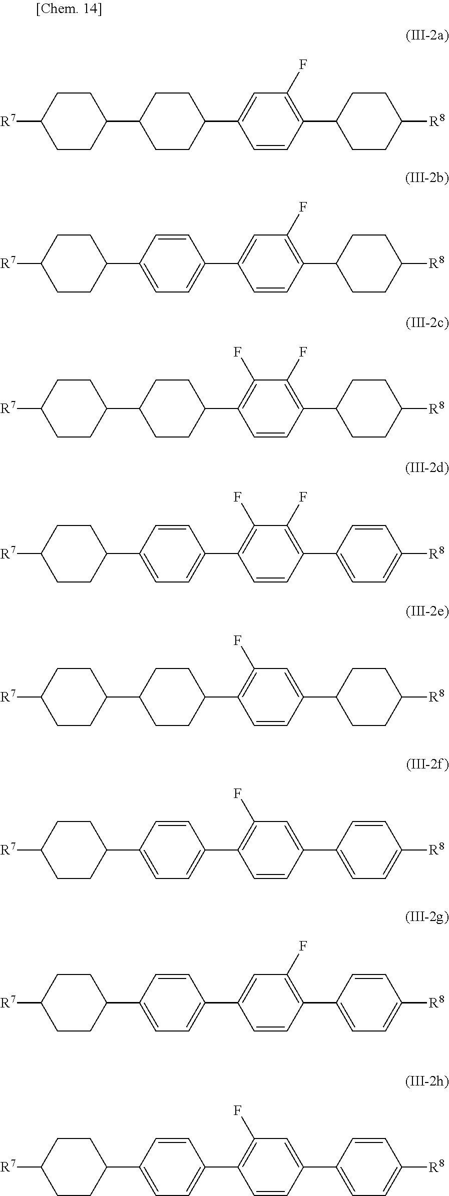

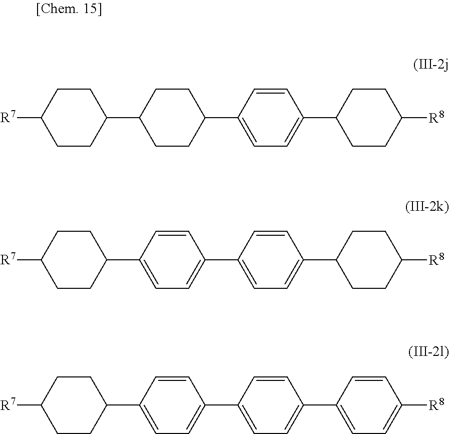

In the formulas, R⁷ and R⁸ each independently represent an alkyl group having 1 to 5 carbon atoms, an alkenyl group having 2 to 5 carbon atoms, or an alkoxy group having 1 to 5 carbon atoms, and R⁷ and R⁸ preferably represent the same embodiment as R⁷and R⁸ in General Formula (III).

As the General Formula (III), in a case where n represents 0, a compound represented by General Formula (III-3b) is preferable from a viewpoint of increasing a response speed.

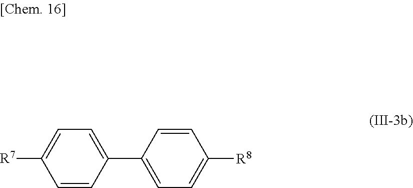

In the formula, R⁷ and R⁸ each independently represent an alkyl group having 1 to 5 carbon atoms, an alkenyl group having 2 to 5 carbon atoms, or an alkoxy group having 1 to 5 carbon atoms, and R⁷ and R⁸ preferably represent the same embodiment as R⁷ and R⁸ in General Formula (III).

R⁷ preferably represents an alkyl group having 2 to 5 carbon atoms and more preferably represents an alkyl group having 3 carbon atoms. R⁸ preferably represents an alkoxy group having 1 to 3 carbon atoms and more preferably represents an alkoxy group having 2 carbon atoms.

The liquid crystal layer in the liquid crystal display device of the present invention may be used in a wide range of a nematic phase-isotropic liquid phase transition temperature (Tₙᵢ), preferably 60° C. to 120° C., more preferably 70° C. to 100° C., and particularly 70° C. to 85° C.

At a temperature of 25° C., the dielectric anisotropy is preferably −2.0 to −6.0, more preferably −2.5 to −5.0, and particularly preferably −2.5 to −4.0.

At a temperature of 25° C., the refractive index anisotropy is preferably 0.08 to 0.13 and more preferably 0.09 to 0.12. Further more specifically, the refractive index anisotropy is preferably 0.10 to 0.12 in a case of corresponding to a thin cell gap and preferably 0.08 to 0.10 in a case of corresponding to a thick cell gap.

The rotational viscosity (γ1) is preferably 150 or less, more preferably 130 or less, and particularly preferably 120 or less.

In the liquid crystal layer in the liquid crystal display device of the present invention, Z, which is a function of the rotational viscosity and the refractive index anisotropy, preferably represents a specific value.

Z=γ1/Δn² [Equation 1]

In the equation, γ1 represents rotational viscosity and Δn represents refractive index anisotropy.

Z is preferably 13,000 or less, more preferably 12,000 or less, and particularly preferably 11,000 or less.

In a case where an active matrix display element is used, the liquid crystal layer in the liquid crystal display device of the present invention necessarily has specific resistance of 10¹² (Ω·m) or more, preferably 10¹³ (Ω·m) and more preferably 10¹⁴ (Ω·m) or more.

The liquid crystal layer in the liquid crystal display device of the present invention, in addition to the aforementioned compounds, may contain a normal nematic liquid crystal, a smectic liquid crystal, a cholesteric liquid crystal, an antioxidant, an ultraviolet ray absorber, a polymerizable monomer, or the like depending on the use.

As the polymerizable monomer, a bifunctional monomer represented by General Formula (V) is preferable.

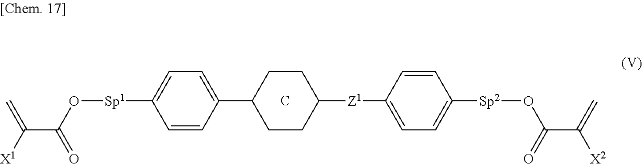

In the formula, X¹ and X² each independently represent a hydrogen atom or a methyl group,

Sp¹ and Sp² each independently represent a single bond, an alkylene group having 1 to 8 carbon atoms or —O—(CH₂)ₛ— (where a represents an integer of 2 to 7 and an oxygen atom is bonded to an aromatic ring),

Z¹ represents —CH═CH—, —CH₂O, —COO—, —OCO—, —CF₂O—, —OCF₂—, —CH₂CH₂—, —CF₂CF₂—, —CH═CH—COO—, —CH═CH—OCO—, —OCOO—CH═CH—, —OCO—CH═CH—, —COO—CH₂CH₂—, —OCO—CH₂CH₂—, —CH₂CH₂—COO—, —CH₂CH₂—COO—, —COO—CH₂—, —OCO—CH₂—, —CH₂—COO—, —CH₂—OCO—, —CY¹═CY²—, (where Y¹ and Y² each independently represent a fluorine atom or a hydrogen atom), —C≡C—, or a single bond,

C represents a 1,4-phenylene group, a trans-1,4-cyclohexylene group, or a single bond, and

all of the 1,4-phenylene groups in the formula may have an arbitrary hydrogen atom substituted with a fluorine atom.

X¹ and X² are preferably any of ail diacrylate derivatives representing a hydrogen atom and all dimethacrylate derivatives having a methyl group, and a compound in which one represents a hydrogen atom and the other represents a methyl group is preferable. With regard to a polymerisation, rate of these compounds, the diacrylate derivatives are the fastest, the dimethacrylate derivatives- are the slowest, and an unsymmetrical compound is intermediate thereof, and a preferred aspect may be used according to the use thereof. In the PSA display element, the dimethacrylate derivatives are particularly preferable.

Sp¹ and Sp² each independently represent a single bond, an alkylene group having 1 to 8 carbon atoms, or —O—(CH₂)ₛ—, and in the PSA display element, at least one preferably represents a single bond, and a compound in which both Sp¹ and Sp² represent a single bond, or an aspect in which one represents a single bond and the other represents an alkylene group having 1 to 8 carbon atoms or —O—(CH₂)ₛ— is preferable. In this case, an alkyl group having 1 to 4 carbon atoms is preferable and s is preferably 1 to 4.

Z¹ preferably represents —OCH₂—, —CH₂O—, —COO—, —OCO—, —CF₂O—, —OCF₂—, —CH₂CH₂—, —CF₂CF₂—, or a single bond, more preferably represents —COO—, —OCO—, or a single bond, and particularly preferably represents a single bond.

C represents a 1,3 -phenylene group in which an arbitrary hydrogen atom may be substituted with a fluorine atom, a trans-1,4-cyclohexylene group, or a single bond, and preferably represents a 1,4-phenylene group or a single bond. In a case where C represents a ring structure other than a single bond, Z¹ preferably represents a linking group other than a single bond, and in a case where C represents a single bond, Z¹ preferably represents a single bond.

From these viewpoints, specifically, in General Formula (V), a ring structure between Sp¹ and Sp² is preferably a structure shown below.

In General Formula (V), in a case where C represents a single bond and the ring structure is formed by two rings, Formula (Va-1) to Formula (Va-5) are preferable, Formula (Va-1) to Formula (Va-3) are more preferable, and Formula (Va-1) is particularly preferable.

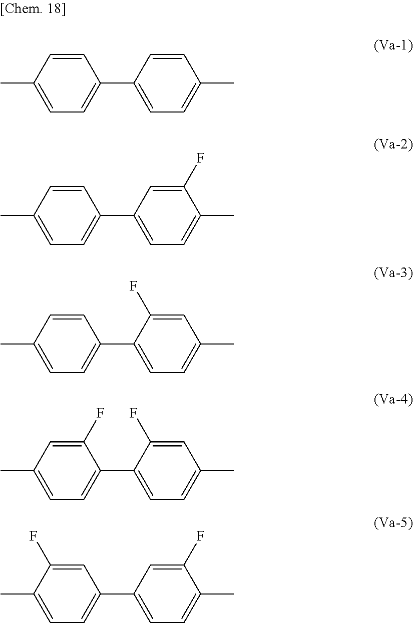

In the formulas, both terminals are bonded to Sp¹ or Sp².

An alignment regulation force of the polymerizable compound including these skeletons after polymerization is optimal for a PSA type liquid crystal display element, since a satisfactory alignment state is obtained, display unevenness is suppressed or is not generated at all.

From the above,, as the polymerizable monomer, General Formula (V-1) to General Formula (V-4) are particularly preferable and General Formula (V-2) is most preferable.

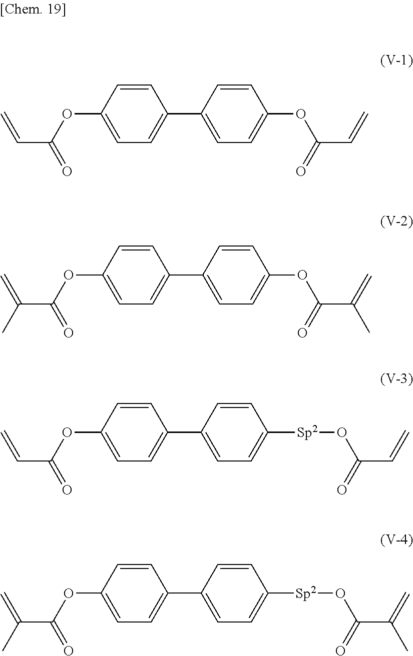

In the formulas, Sp² represents an alkylene group having 2 to 5 carbon atoms.

In a case where the polymerizable monomer is added, polymerization is performed even in a case where the polymerization initiator is not present, but the polymerization initiator may be contained in order to promote polymerization. Examples of the polymerization initiator include benzoin ethers, benzophenones, acetophenones, benzyl ketals, and acyl phosphine oxides. In addition, a stabilizer may be added in order to improve storage stability. Examples of the stabiliser which may be used include hydroquinones, hydroquinone monoalkyl ethers, tertiary butyl catechols, pyrogallols, thiophenols, nitro compounds, β-naphthylamines, β-naphthols, and nitroso compounds.

The liquid crystal layer of the present invention is useful for a liquid crystal display element, useful for an Active Matrix Liquid Crystal Display element (AM-LGD), a TN (nematic liquid crystal display element), a. Super Twisted Hematic Liquid Crystal Display element (BTM-LCD), an In-Plane Switching Liquid Crystal Display element (OCB-LCD and IPS-LCD), and particularly useful for an Mi-LCD, and the liquid crystal layer of the present invention may be used for a liquid crystal display element for a PSA mode, a PSVA mode, a VA mode, an IPS mode, or an ECB mode.

(Retardation Film)

(Polymerizable Liquid Crystal Compound)

The liquid crystal compound (polymerizable liquid crystal compound) having the polymerizable functional group of the present, invention shows crystallinity in a composition including other liquid crystal compounds. In addition, the polymerizable liquid crystal compound may not show crystallinity by itself.

For example, a bar-like polymerizable liquid crystal compound having a rigid moiety referred to as mesogen in which a plurality of structures such as a 1,4-phenylene group and a 1,4-cyclohexylene group are linked to each other, as disclosed in Handbook of Liquid Crystals (edited by D. Demus, J. W. Goodby, G. W. Gray, H. W. Spiess, and V. Vill, published by Wiley-VCH Verlag GmbH & Co. KGaA, 1998), Kikan Kagaku Sosetsu No. 22, Chemistry of Liquid Crystals (edited by The Chemical Society of Japan, 1994), or JP-A-7-294735, JP-A-8-3111, JP-A-8-29618, JP-A-11-80090, JP-A-11-116538, JP-A-11-148079, or the like, and a polymerizable functional group such as a vinyl group, an acryl group, and a (meth) acryl group; or a bar-like polymerizable liquid crystal compound having an maleimide group, as disclosed in JP-A-2004-2373 or JP-A-2004-99446 is exemplified. Among these, a bar-like liquid crystal compound having a polymerizable group is preferable since it is easy to produce a liquid crystal whose liquid crystal temperature range includes a temperature lower and higher than room temperature.

Further, the polymerizable liquid crystal composition of the present invention is constituted by one or more of the polymerizable liquid crystal compound, and the polymerization initiator, and if necessary, a surfactant and other additives. In a case of producing a cholesteric liquid crystal, the polymerizable liquid crystal composition of the present-invention further contains a chiral compound.

As a retardation film in the liquid crystal display device of the present invention, an optically anisotropic body obtained by polymerizing a polymerizable liquid crystal composition 25% by weight or more of a liquid crystal compound having two or more polymerizable functional groups is used.

As the liquid crystal compound having two or more polymerizable functional groups, specifically, a compound represented by the following General Formula (I) is preferable.

[Chem. 20]

P¹-(Sp¹)ₘ₁-MG-R¹ (1)

In the formula, P¹ represents a polymerizable functional group, Sp¹ represents an alkylene group having 0 to 18 carbon, atoms (the alkylene group may be substituted with one or more halogen atoms, a CN group, or an alkyl group having 1 to 8 carbon atoms having a polymerizable functional group, and one CH; group present in this group or two or more CH₂ groups non-adjacent to each other each independently may be substituted with —O—, —S—, —NH—, —N(CH₃)—, —CO—, —COO—, —OCO—, —OCOO—, —SCO—, —COS—, or —CH≡C— as long as an oxygen atom is not directly bonded to another oxygen atom, m1 represents 0 or 1, MG represents a mesogenic group or a mesogenic supporting group, R¹ represents a hydrogen atom, a halogen atom, a cyano group, or an alkyl group having 1 to 18 carbon atoms, the alkyl group may be substituted with one or more halogen atoms or ON, one CH; group present in this group or two or more CH2 groups non-adjacent to each other each independently may be substituted with —O—, —S—, —NH—, —N(CH₃)—, —CO—, —COO—, —OCO—, —OCOO—, —SCO—, —COS—, or —CH≡C— as long as an oxygen atom is not directly bonded to another oxygen atom, or R¹ represents a structure represented by General Formula (1-a):

[Chem. 21]

—(Sp^{1a})ₘₐ—P^{1a} (1-a)

(wherein P^{1a} represents a polymerizable functional group, Sp^{1a} represents the same meaning as the Sp¹, and ma represents 0 or 1),

the mesogenic group or the mesogenic supporting group represented by MG is represented by General Formula (1-b):

[Chem. 22]

—Z0-(A1-Z1)ₙ-(A2-Z2)ₗ-(A3-Z3)ₖ-A4-Z4-A5-Z5- (1-b)

wherein A1, A2, A3, A4, and A5 each independently represent a 1,4-phenylene group, a 1,4-cyclohexylene group, a 1,4-cyclohexenyl group, a tetrahydropyran-2,1-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidin-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, and

may have, as a substituent, one or more of F, Cl, CF₃, OCF₃, a CN group, an alkyl group having 1 to 8 carbon atoms, an alkoxy group, an alkanoyl group, an alkanoyloxy group, an alkenyl group having 2 to 8 carbon atoms, an alkenyloxy group, an alkenoyl group, an alkenoyloxy group, and a substituent represented by General Formula (1-c):

[Chem. 23]

-(A)ₙ₁-(Sp^{1c})-_{mc}—P^{c} (1-c)

(wherein P^{c} represents a polymerizable functional group, A represents —O—, —COO—, —OCO—, —OCH₂—, —CH₂O—, —CH₂CH₂OCO—, —COOCH₂CH₂—, —OCOCH₂CH₂—, or a single bond, Sp^{1c} represents the same meaning as the Sp¹, n1 represents 0 or 1, and mc represents 0 or 1),

Z0, Z1, Z2, Z3, Z4, and Z5 each independently represent —OCO—, —OCO—, —CH₂CH₂—, —OCH₂—, —CH₂═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group having 2 to 10 carbon atoms which may have a halogen atom or a single bond, and

n, l, and k each independently represent S or band satisfy 0≦n+l+k≦3),

with the proviso that in the Formula (1), two Or more polymerizable functional groups are present.

P¹, P^{1a}, and P^{c} preferably represent a substituent selected from the polymerizable group represented, by the following Formula (P-1) to Formula (P-20).

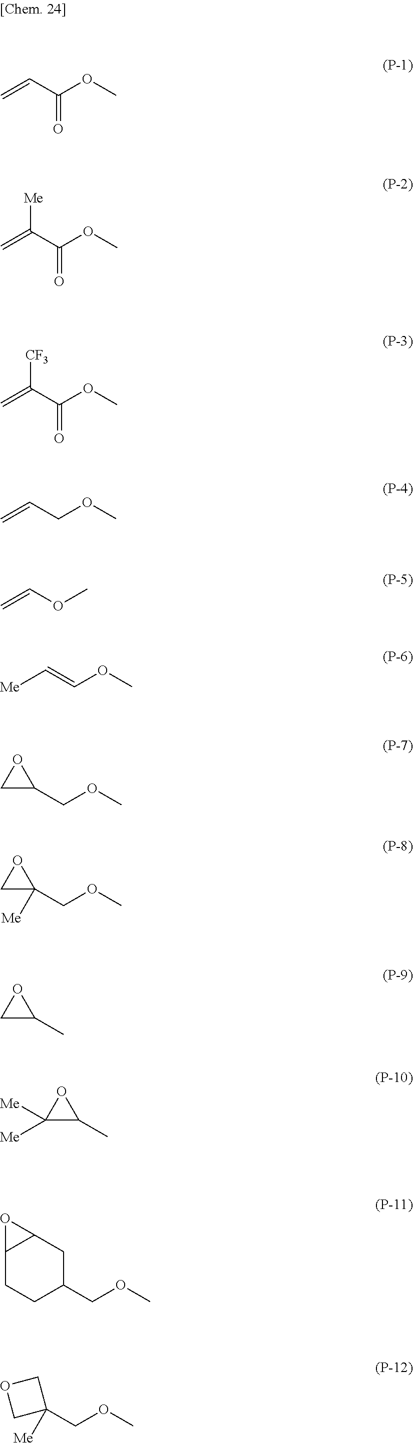

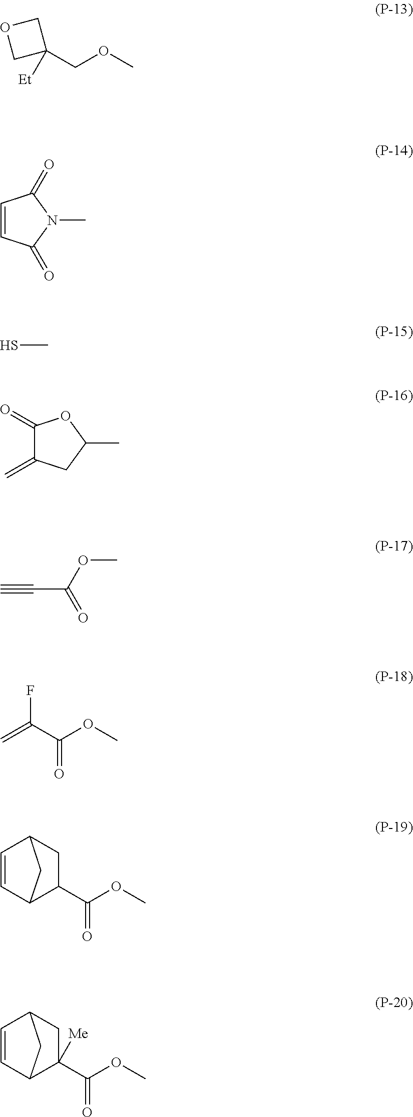

Among these polymerizable functional groups, Formula (P-1), or Formulas (P-2), (P-7), (P-12), and (P-13) are preferable and Formulas (P-1), (P-7), and (P-12) are more preferable from a viewpoint of increasing polymerizing properties and storage stability.

One type of 2 or more types of the liquid crystal compound having two or more polymerizable functional groups may be used and 1 type to 6 types are preferable and 2 types to 5 types are more preferable.

The content of the liquid crystal compound having two or more polymerizable functional groups is preferably 25% to 100% lay mass, more preferably 30% to 100% by mass, and particularly preferably 35% to 100% by mass within the polymerizable liquid crystal composition.

As the liquid crystal compound having two or more polymerizable functional groups, a compound having two polymerizable functional groups is preferable and a compound represented by the following General Formula (2) is preferable.

[Chem. 25]

p^{2a}-(Sp^{2a})ₘ₂-Z0-(A1-Z1)ₙ-(A2-Z2)ₗ(A3-Z3)ₖ-A4-Z4-A5-Z5-(Sp^{2b})ₙ₂P^{2b} (2)

In the formula, A1, A2, A3, A4, and A5 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a

1,2,3,4-tetrahydronaphthalene-2, 6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, and

a substituent thereof represents one or more of F, Cl, CF₃, OCF₃, CN groups, alkyl groups having 1 to 8 carbon atoms, alkoxy groups, alkanoyl groups, alkanoyloxy groups, alkenyl groups having 2 to 8 carbon atoms, alkenyloxy groups, alkenoyl groups, or alkenoyloxy groups. In addition, Z2, Z1, Z2, Z3, Z4, and Z5 each independently represent —OCO—, —OCO—, —CH₂CH₂—, —OCH₂—, —CH₂O—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, or an alkyl group having 2 to 10 carbon atoms which may have a halogen atom or a single bond, and

n, k, and l each independently represent 0 or 1 and satisfy 0≦n+l+k≦3.

P^{2a} and P^{2b} represent a polymerizable functional group, Sp^{2a} and Sp^{2b} each independently represent an alkylene group having 0 to 18 carbon atoms (the alkylene group may be substituted with one or more halogen atoms or CN, and one CH₂ group present in this group or two or more CH₂ groups non-adjacent to each other each independently may foe substituted with —O—, —S—, —NH—, —N(CH₃)—, —CO”, —COO—, —OCO—, —OCOO—, —SCO—, —COS—, or —C≡C— as long as an oxygen atom is not directly bonded to another oxygen atom, and m2 and n2 each independently represent 0 or 1.

n, l, and k each independently represent 0 or 1 and satisfy 0≦n+l+k≦3.

P^{2a} and P^{2b} preferably represent a substituent selected from the polymerizable group represented by the following Formula (P-1) to Formula (P-20).

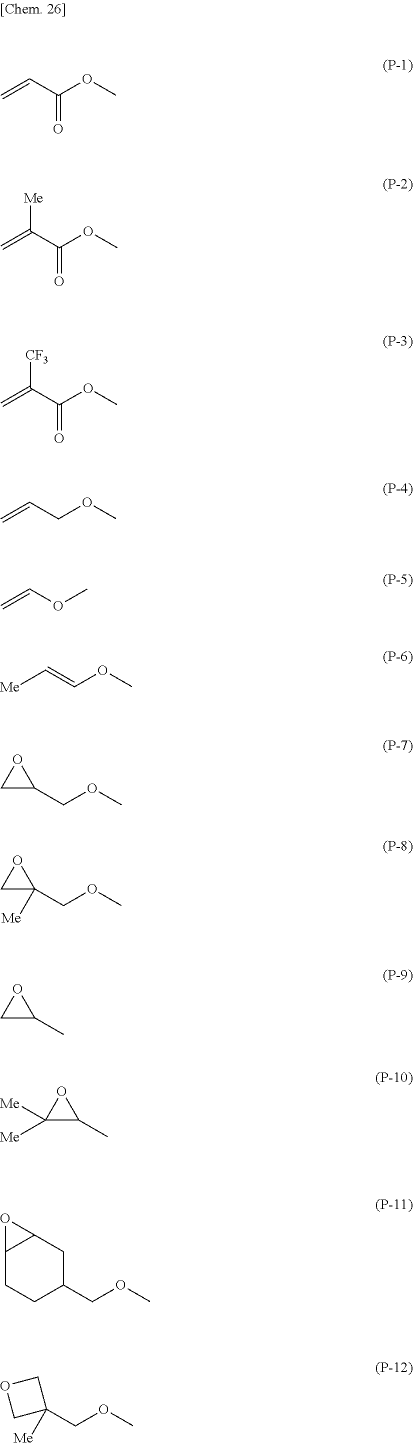

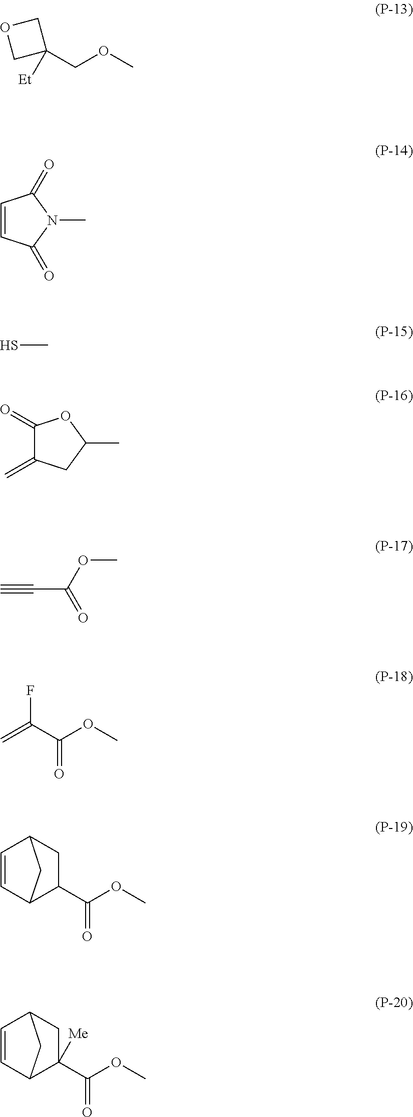

Among these polymerizable functional groups, Formula (P-1), or Formulas (P-2), (P-7), (P-12), and (P-13) are preferable and Formulas (P-1), (P-7), and (F-12) are more preferable, from a viewpoint of increasing polymerizing properties and storage stability.

Further, as one example of General Formula (2), General Formulas (2-1) to (2-4) may be exemplified, but not limited to these general formulas.

[Chem. 27]

P^{2a}-(Sp^{2a})ₘ₂-Z0-A4-Z4-A5-Z5-(Sp^{2b})ₙ₂P^{2b} (2-1)

P^{2a}-(Sp^{2a})ₘ₂-Z0-A3-Z3-A4-Z4-A5-Z5-(Sp^{2b})ₙ₂-P^{2b} (2-2)

P^{2a}-(Sp^{2a})ₘ₂-Z0-A2-Z2-A3-Z3-A4-Z4-A5-Z5-(Sp^{2b})ₙ₂-P^{2b} (2-3)

P^{2a}-(Sp^{2a})ₘ₂-Z0-A1-Z1-A2-Z2-A3-Z3-A4-Z4-A5-Z5-(Sp^{2b})ₙ₂-P^{2b} (2-4)

In the formulas, P^{2a}, P^{2b}, Sp^{2a}, Sp^{2b}, A1, A2, A3, A4, A5, Z0, Z1, Z2, Z3, Z4, Z5, m2 and n2 represent the same definition as in General Formula (2).

As a specific example of the polymerizable liquid crystal compound having two polymerizable functional groups, compounds of Formulas (2-5) to (2-29) are exemplified, but not limited to the following compounds.

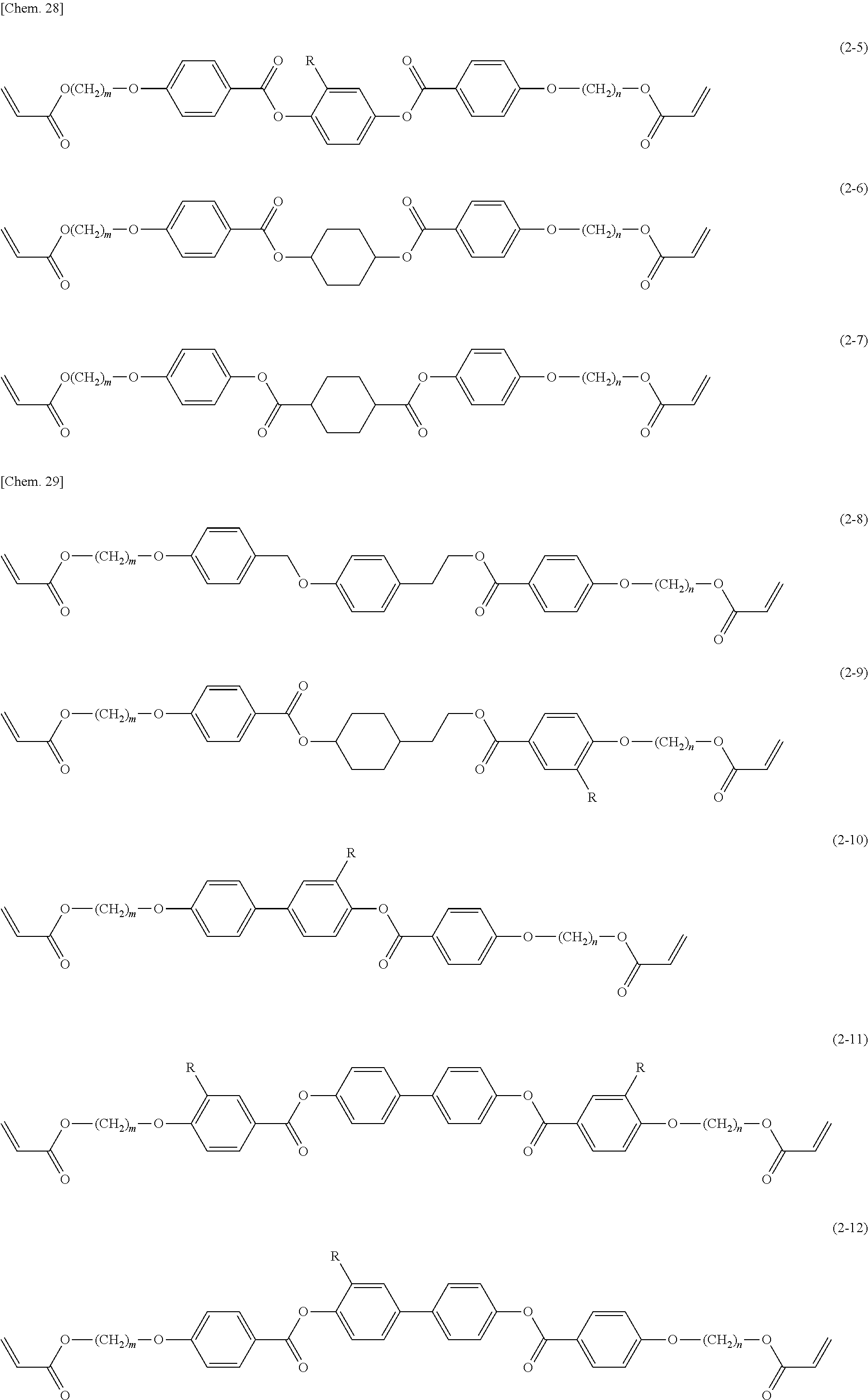

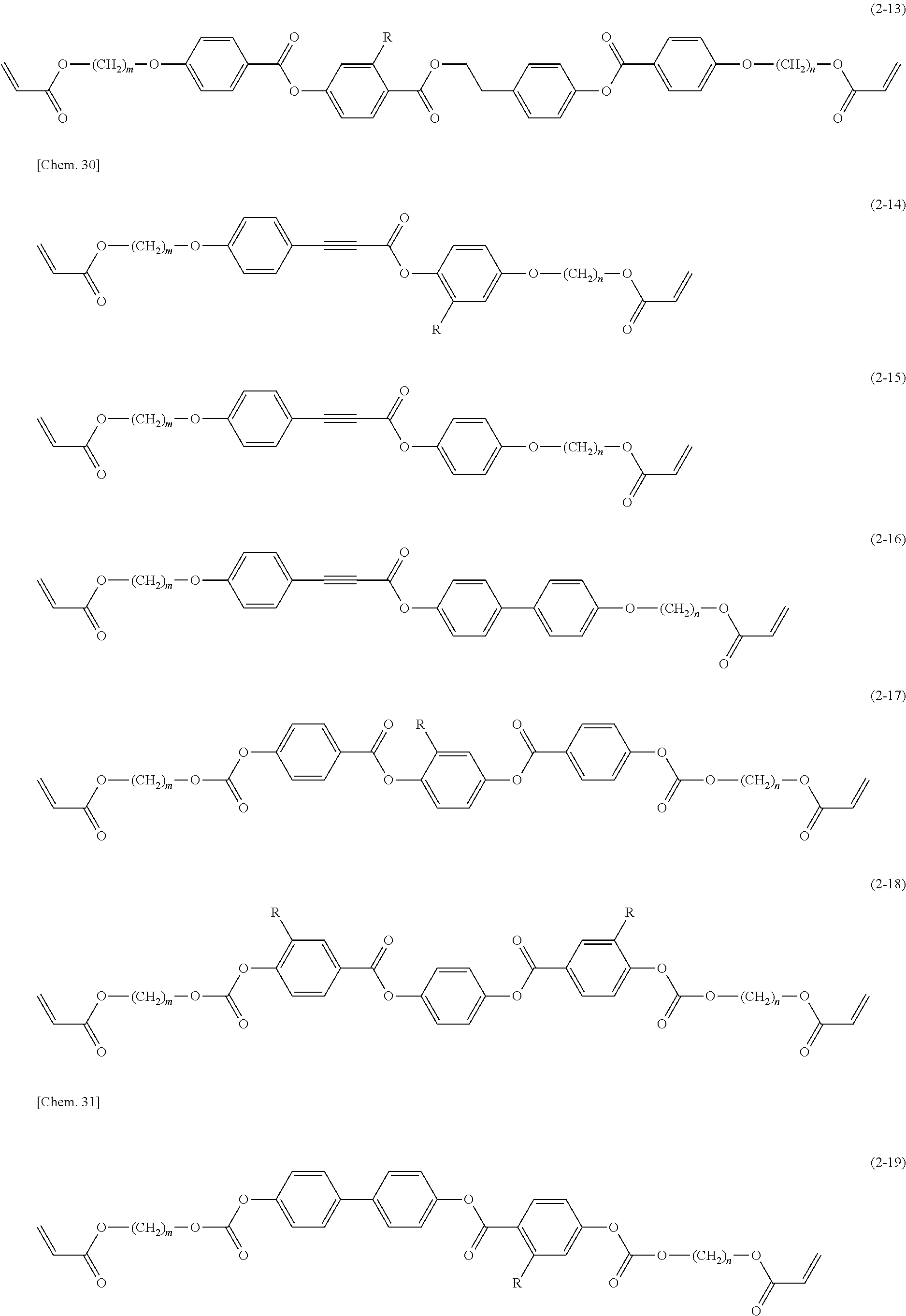

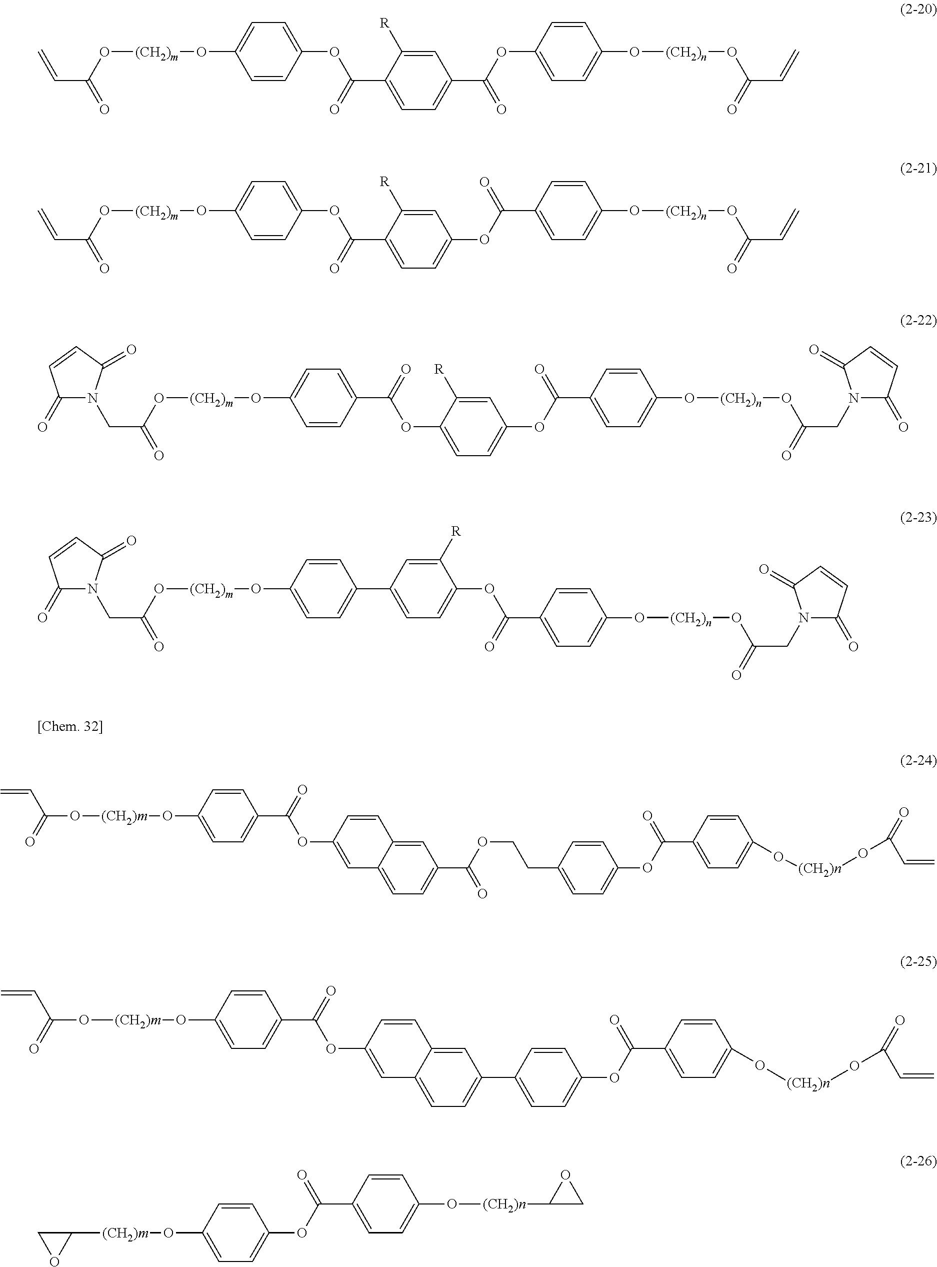

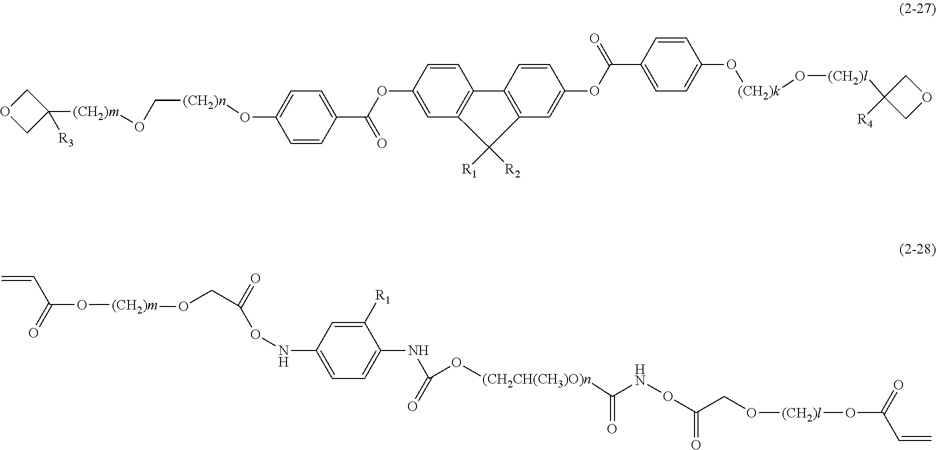

In the formulas, in and n each independently represent an integer of 1 to 18, R represents a hydrogen atom, a halogen atom, an alkyl group having 1 to 6 carbon atoms, an alkoxy group having 1 to 6 carbon atoms, or a cyano group, and in a case where these groups represent an alkyl group having 1 to 6 carbon atoms or an alkoxy group having 1 to 6 carbon atoms, all of the groups may be unsubstituted or may foe substituted with 1 or 2 or more halogen atoms.

One type or 2 or more types of the liquid crystal compound having two polymerizable functional groups may be used, and 1 type to 5 types are preferable and 2 types to 5 types are more preferable.

The content of the liquid crystal compound having two polymerizable functional groups is preferably 25% to 100% by mass, more preferably 30% to 100% by mass, and particularly preferably 35% to 100% by mass within the polymerizable composition.

The liquid crystal compound having two or more polymerizable functional groups is preferably a compound having three polymerizable functional groups. Examples thereof include General Formulas (3-1) to (3-18) and not limited to the following general formulas.

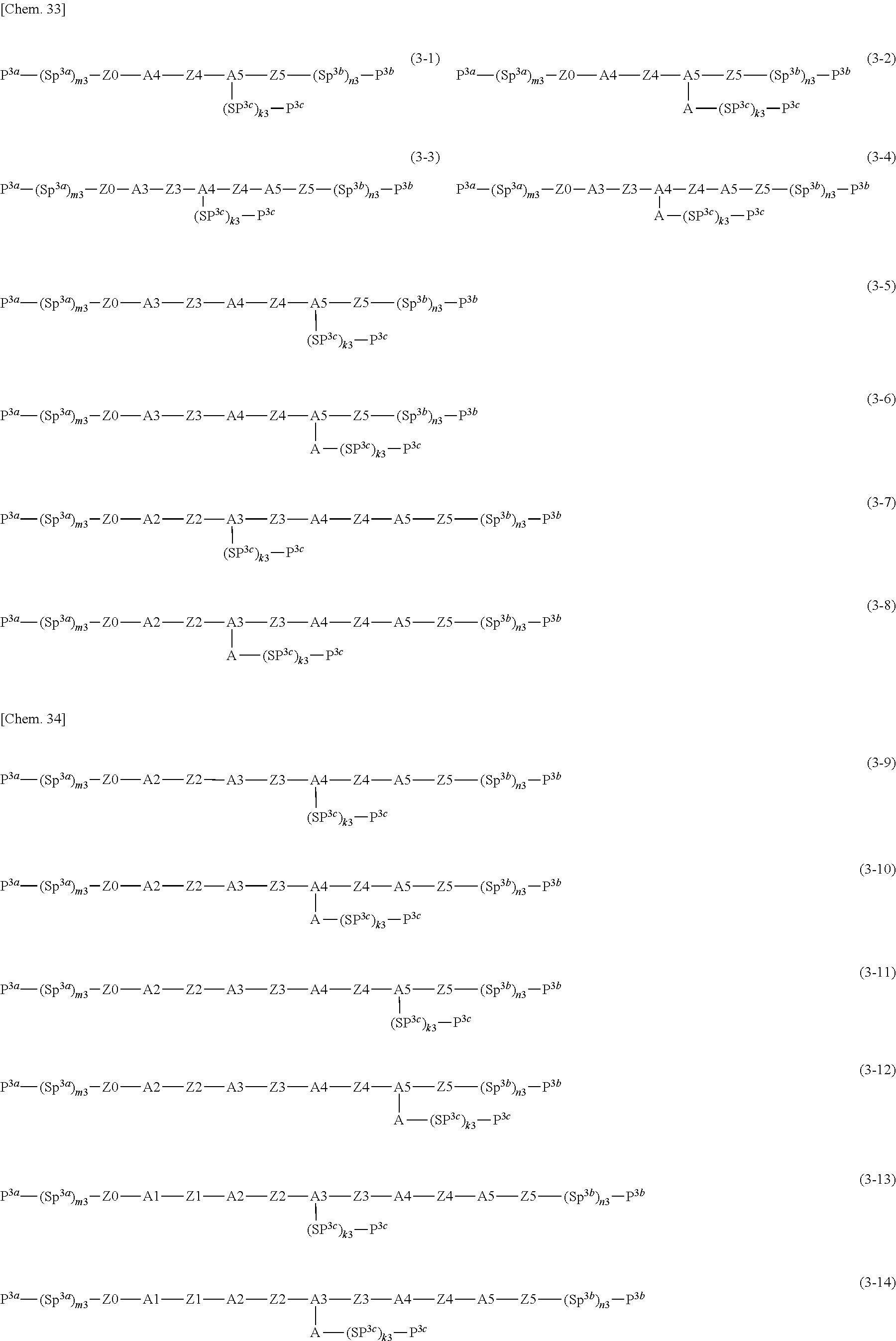

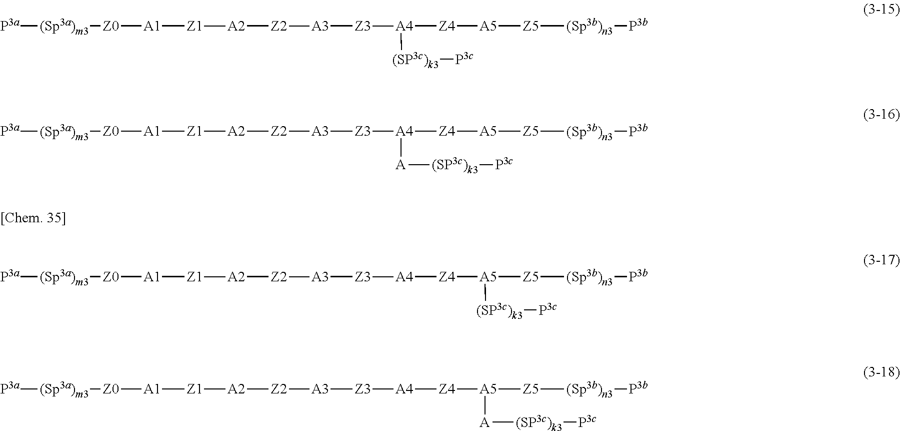

In the formulas, A1, A2, A3, A4, and A5 represent the same definition as in General Formula (2). In addition, Z0, Z1, Z2, Z3, Z4, and Z5 represent the same definition as in General Formula (2).

P^{3a}, P^{3b}, and P^{3b} each independently represent a polymerizable functional group, Sp^{3a}, Sp^{3b}, and Sp^{3c} each independently represent an alkylene group having 0 to 1 carbon atoms (the alkylene group may be substituted with one or more halogen atoms or CN, and one CH₂ group present in this group or two or more CH₂ groups non-adjacent to: each other each independently may be substituted with—O—, —S—, —NH—, —N(CH₃)—, —CO—, —COO—, —OCO—, —OCOO—, —SCO—, —COS—, or —C≡C— as long as an oxygen atom is not directly bonded to another oxygen atom, and m3, n3, and k3 each independently represent 0 or 1.

Specific examples of the polymerizable liquid crystal compound having two polymerizable functional group include compounds of Formulas (3-19) to (3-26), but the examples are not limited to the following compounds.

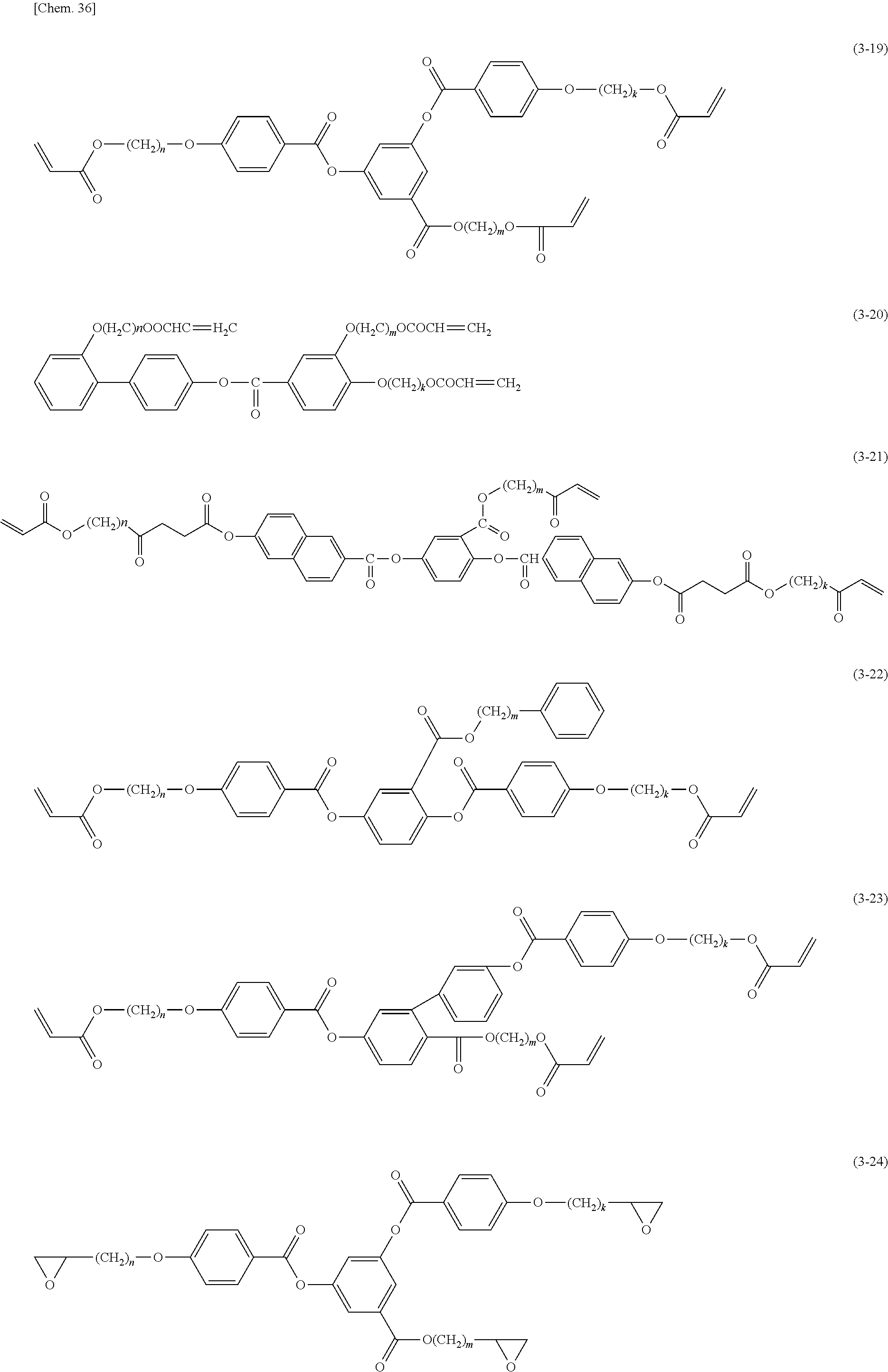

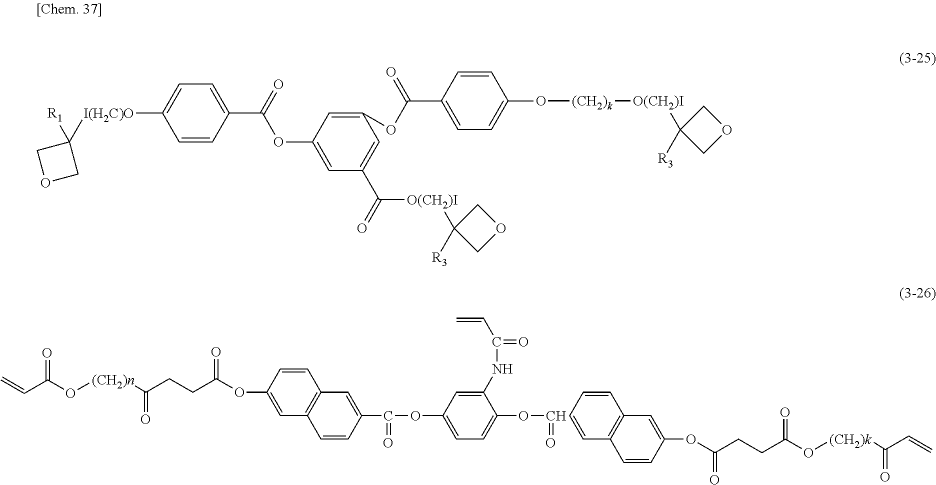

One type or 2 or more types of the liquid crystal compound having three polymerizable functional groups may be used, but 1 type to 4 types are preferable and 1 type to 3 types are more preferable.

The content of the liquid crystal compound having three polymerizable functional groups is preferably 0% to 80% by mass, more preferably 0% to 70% by mass, and particularly preferably 0% to 60% by mass within the polymerizable liquid crystal composition.

The polymerizable liquid crystal composition of the present invention may further contain a liquid crystal compound having one polymerizable functional group.

Specific preferred examples of the liquid crystal compound having one polymerizable functional group include a compound represented by the following General Formula (4).

[Chem. 38]

P4-(Sp4)m4-MG-R⁴ (4)

In the formula, P⁴ represents a polymerizable functional group, Sp⁴ represents an alkylene group having 0 to 18 carbon atoms (the alkylene group may be substituted with one or more halogen atoms or CN, and one CH₂ group present in this group or two or more CH₂ groups non-adjacent to each other each independently may be substituted with—O—, —S—, —NH—, —N(CH₃)—, —CO—, —COO—, —OCO—, —OCOO—, —SCO—, —COS—, or —C═C— as long as an oxygen atom is not directly bonded to another oxygen atom,

m4 represents 0 or 1, MG represents a mesogenic group or a mesogenic supporting group,

R⁴ represents a hydrogen atom, a halogen atom, a cyano group, or an alkyl group having 1 to 18 carbon atoms, but the alkyl group may be substituted with one or more halogen atoms or CM, and one CH₂ group present in this group or two or more CH₂ groups to each other each independently may be substituted with —O—, —S—, —NH—, —N(CH₃)—, —CO—, —COO—, —OCO—, —OCOO—, —SCO—, —COS—, or —C≡C— as long as an oxygen atom is not directly bonded to another oxygen atom.

P⁴ preferably represents a substituent selected front, polymerizable groups represented by the following Formula (P-1) to Formula (P-20).

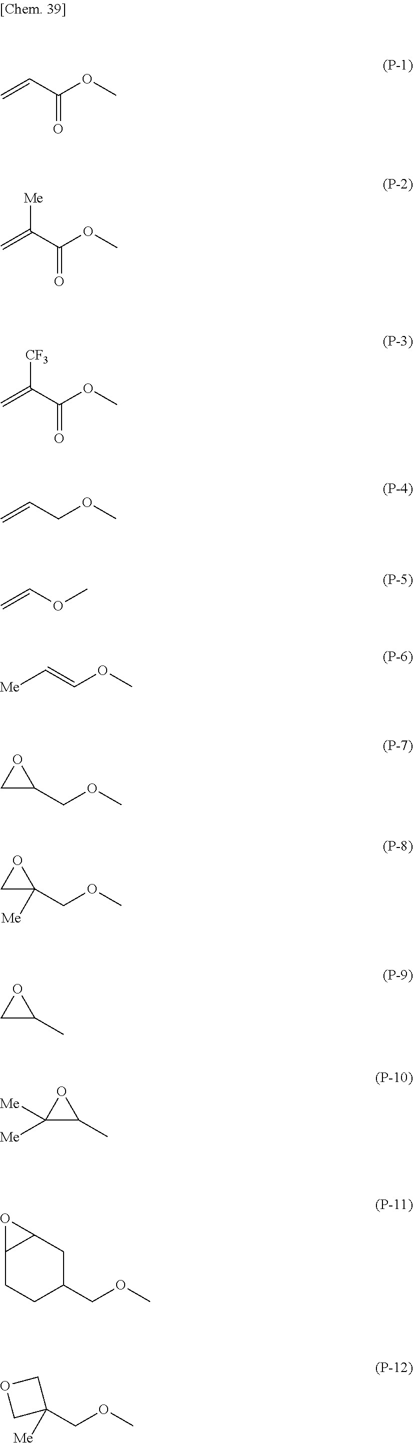

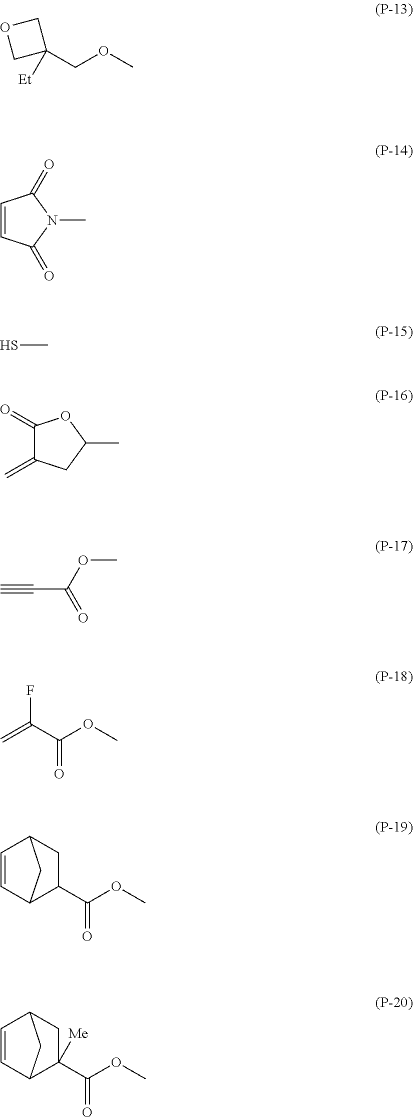

Among these polymerizable functional groups, Formula (P-1) or Formulas (P-2), (P-7), (P-12), and (P-13) are preferable, and Formulas (P-1), (P-7), and (P-12) are more preferable, from a viewpoint of increasing polymerizing properties storage stability.

Example of the mesogenic group or the mesogenic supporting group represented by MG include a group represented by General. Formula (4-b).

[Chem. 40]

-Z0-(A1-Z1)ₙ₄-(A2-Z2)ₖ₄-(A3-Z3)₁₄-A4-Z4-A5-Z5- (4-b)

In General Formula (4-b), A1, A2, A3, A4 and A5 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, and may have, as a substituent, one or more of F, Cl, CF₅, OCF₃, CN groups, alkyl groups having 1 to 8 carbon atoms, alkoxy groups, alkanoyl groups, alkanoyloxy groups, or alkenyl groups having 2 to 3 carbon atoms, Z0, Z1, Z2, Z3, Z4 and Z5 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group having 2 to 10 carbon atoms which may have a halogen atom, or a single bond, and n, l, and k each independently represent 0 or 1 and satisfy 0≦n+l+k<3.

As one example of General Formula (4), General Formulas (4-1) to (4-4) are exemplified, but the example is not limited to the following general formulas.

[Chem. 41]

P^{4a}-(Sp^{4a})ₘ-Z0-A4-Z4-A5-Z5-(Sp^{4b})ₙ₄-R⁴ (4-1)

P^{4a}-(Sp^{4a})ₘ-Z0-A3-Z3-A4-Z4-A5-Z5-(Sp^{4b})ₙ₄-R⁴ (4-2)

P^{4a}-(Sp^{4a})ₘ-Z0-A2-Z2-A3-Z3-A4-Z4-A5-Z5-(Sp^{4b})ₙ₄-R⁴ (4-3)

P^{4a}-(Sp^{4a})ₘ-Z0-A1-Z1-A2-Z2-A3-Z3-A4-Z4-A5-Z5-(Sp^{4b})ₙ₄-R⁴ (4-4)

In the formulas, A1, A2, A3, A4, and A5 represent the same definition as in General Formula (4-b). Also, Z0, Z1, Z2, Z3, Z4, and Z5 represent the same definition as in General Formula (4-b).

P^{4a} and P^{4b} each independently represent a polymerizable functional group, Sp^{4a} and Sp^{4b} each independently represent an alkylene group having 0 to 18 carbon, atoms (the alkylene group may be substituted with one or more halogen atoms or CN, and one CH₂ group present in this group or two or more CH₂ groups non-adjacent to each other each independently may be substituted with —O—, —S—, —NH—, —N(CH₃)—, —CO—, —COO—, —OCO—, —OCOO—, —SCO—, —COS—, or —C≡C— as long as an oxygen atom is not directly bonded to another oxygen atom), and m4 and n4 each independently represent 0 or 1.

Examples of the compound represented by General Formula (4) include compounds represented by the following Formulas (4-5) to (4-31), but the examples are not limited to these.

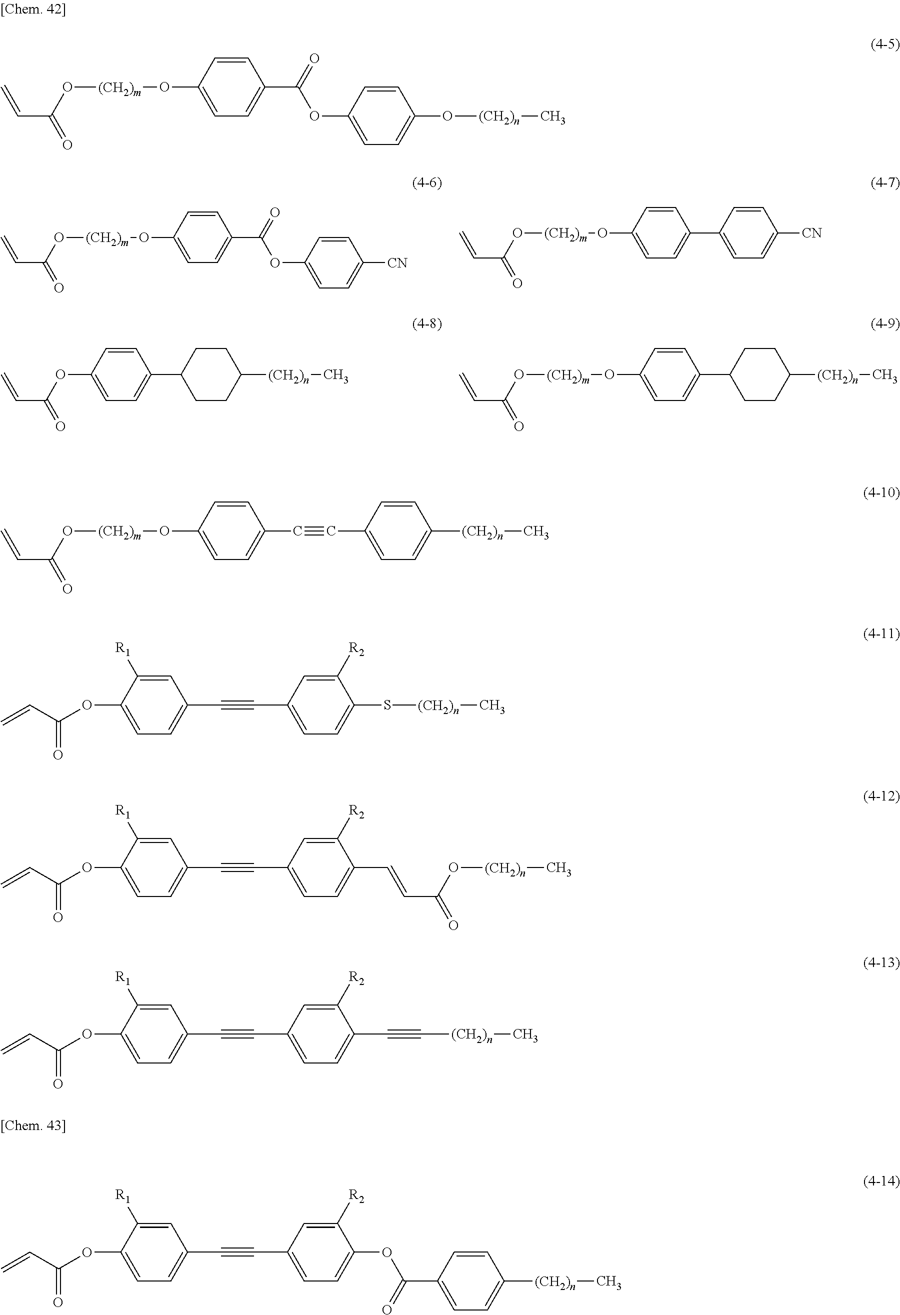

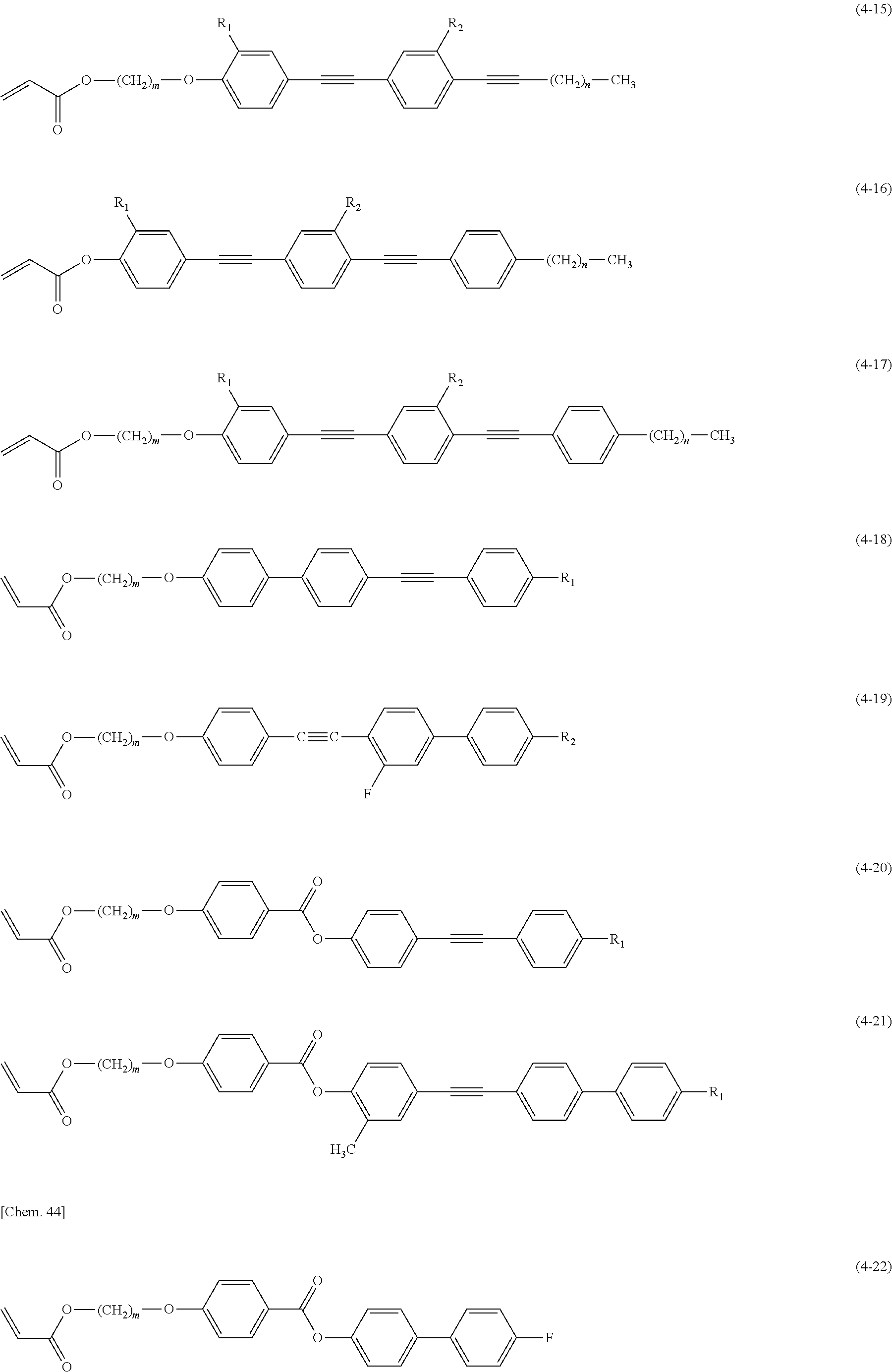

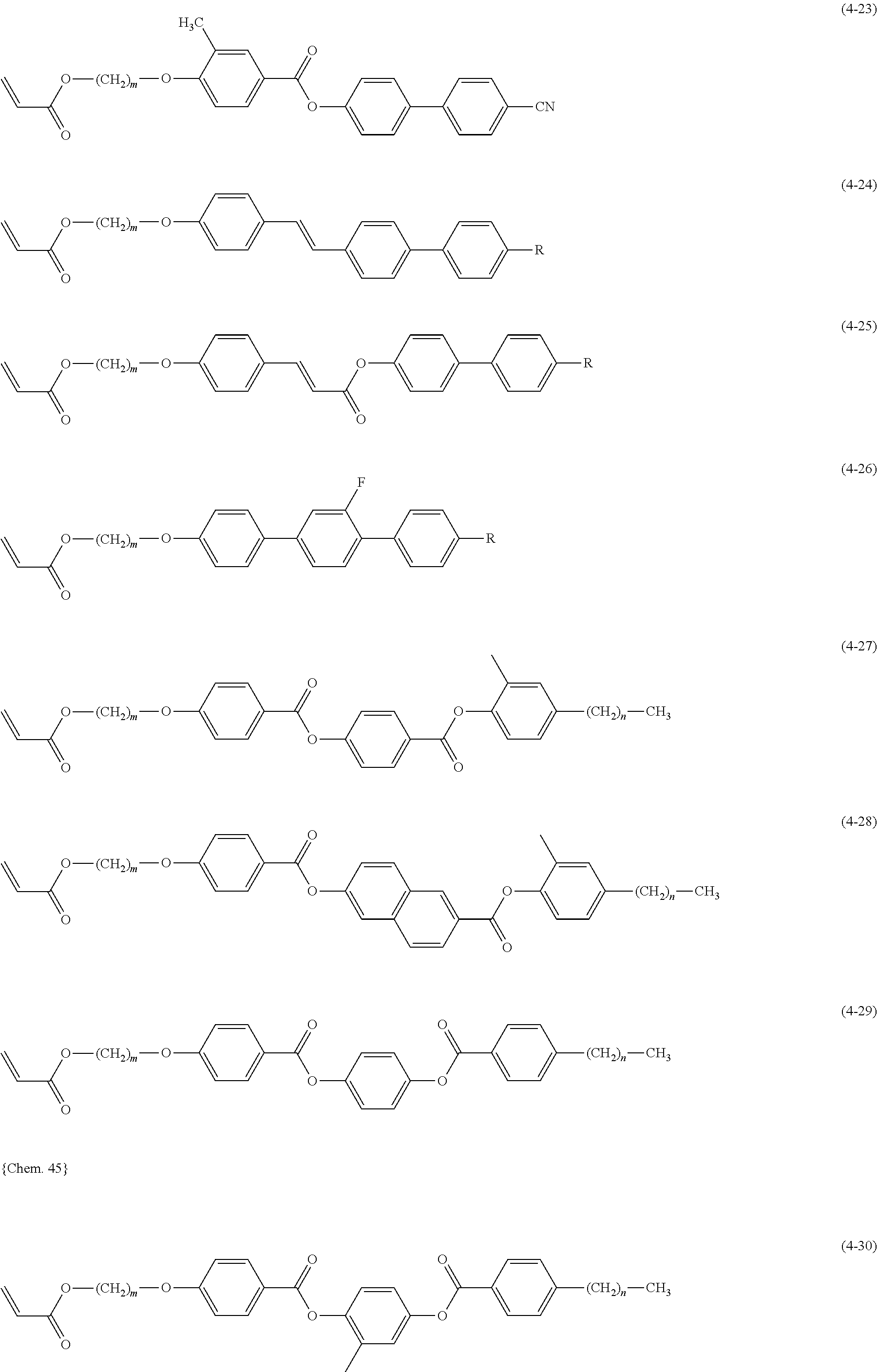

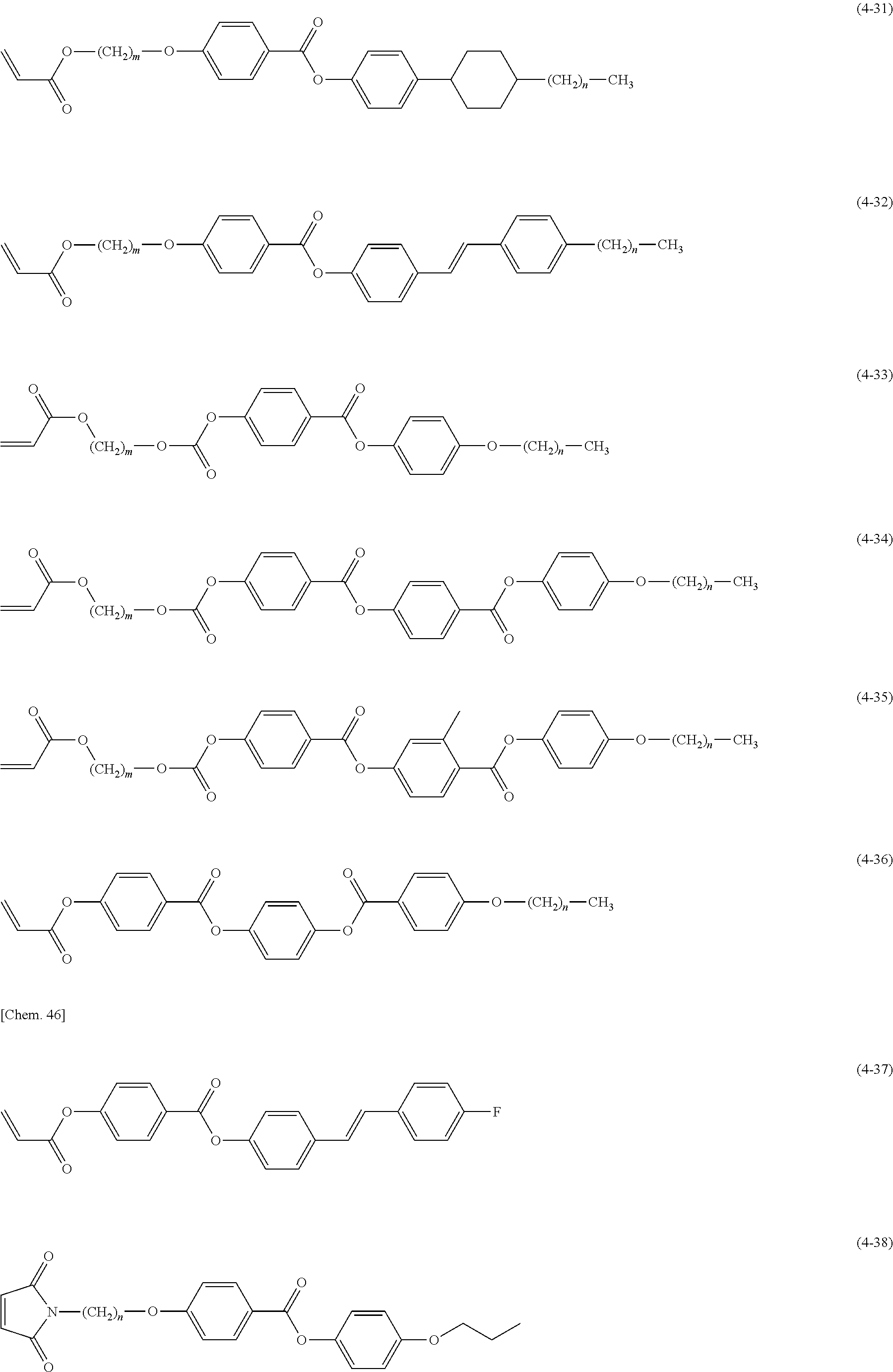

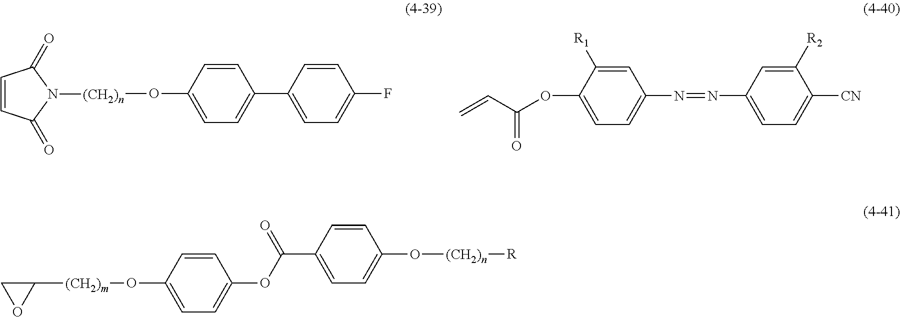

In the formulas, m and n each independently represent an integer of 1 to 18, R, R¹, and R² each independently represent a hydrogen atom, an alkyl group having 1 to 6 carbon atoms, an alkoxy group having 1 to 6 carbon atoms, a carboxyl group, or a cyano group, in a case where these groups represent an alkyl group having 1 to 6 carbon atoms or an alkoxy group having 1 to 6 carbon atoms, all of the groups may be unsubstituted or may be substituted with 1 or 2 or more halogen atoms.

One type or 2 or more types of the liquid crystal compound having one polymerizable functional, group may be used, but 1 type to 5 types are preferable: and 1 type to 4 types are more preferable.

The content of the liquid crystal compound having one polymerizable functional group is preferably 0% by mass or more, more preferably 10% by mass or more, particularly preferably 20% by mass or more, preferably 75% by mass or less, more preferably 70% by mass or less, and particularly preferably 65% by mass or less within the polymerizable liquid crystal composition.

(Other Components)

(Chiral Compound)

In the polymerizable liquid, crystal composition: of the present invention, a chiral compound may be blended for the purpose of obtaining a chiral nematic phase. Among the chiral compound, a compound having a polymerizable functional group within a molecule is preferable. In addition, the chiral compound of the present invention may show crystallinity or non-crystallinity.

The chiral compound used in the present invention preferably has one or more polymerizable functional groups. As this compound, for example, a polymerizable chiral compound including chiral saccharides such as isosorbide, isomannitol, and glucoside and having a rigid moiety such as a 1,4-phenylene group and a 1,4-cyclohexylene and a polymerizable functional group such as a vinyl group, an acrylcyl group, a (meta)acryloyl group, and a maleimide group, as disclosed in JP-A-11-193287, JP-A-2001-158788, JP-T-2006-52669, JP-A-2007-269639, JP-A-2007-269640, 2009-84178 and the like; a polymerizable chiral compound including terpenoid derivatives as disclosed in JP-A-8-239666; a polymerizable chiral compound including a mesogenic group and spacers having a chiral moiety as disclosed in NATURE VOL 35 pages 467 to 469 (published on Nov. 30, 1995), MATURE VOL 392 pages 476 to 479 (published on Apr. 2, 1998); or a polymerizable chiral compound including a binaphthyl group as disclosed in JP-T-2004-504285 and JP-A-2007-248945 is exemplified. Among these, a chiral compound having a great helical twisting power (HTP) is preferable for the polymerizable liquid crystal composition of the present invention.

It is necessary to adjust the blending amount of the chiral compound appropriately depending on the helical twisting power of the compound, but the chiral compound is preferably contained in the amount of 0% to 25% by mass, more preferably 0% to 20% by mass, and particularly preferably 0% to 15% by mass within the polymerizable liquid crystal composition.

As one example of general formula of the chiral compound, General Formulas (5-1) to (5-4) may be exemplified but the example is not limited to the following general formulas.

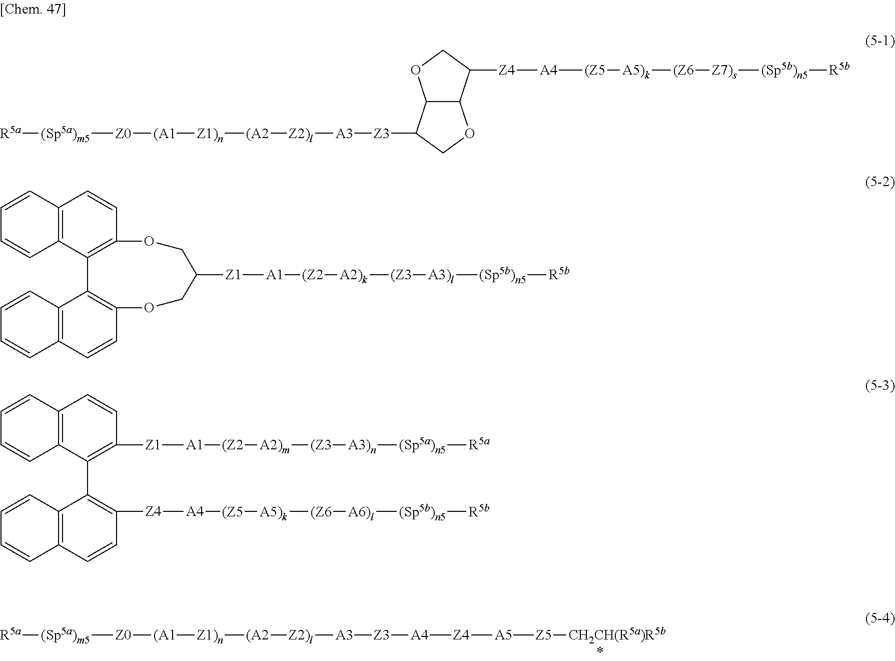

In the formulas, Sp⁵ represents an alkylene group having 0 to 18 carbon atoms, the alkylene group may be substituted with one or more halogen atoms, a CN group, or an alkyl group having 1 to 8 carbon atoms having a polymerizable functional group, and one CH2 group present in this group or two or more CH₂ groups non-adjacent to each other each independently may be substituted with —O—, —S—, —NH—, —N(CH₃)—, —CO—, —COO—, —OCO—, —OCOO—, —SCO—, —COS—, or —C≡C— as long as an oxygen atom is not directly bonded to another oxygen atom,

A1, A2, A3, A4, and A5 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, n, l, and k each independently represent 0 or 1 and satisfy 0≦n+l+k≦3,

m5 represents 0 or 1,

R^{5a} and R^{5b} represent a hydrogen atom, a halogen atom, a cyano group, or an alkyl group having 1 to 18 carbon atoms, the alkyl group may be substituted with one or more halogen atoms or CN, and one CH₂ group present in this group, or two or more CH₂ groups non-adjacent to each other each independently may be substituted with —O—, —S—, —NH—, —N(CH₅)—, —CO—, —COO—, —OCO—, —OCOO—, —SCO—, —COS—, or —C≡C— as long as an oxygen atom is not directly bonded to another oxygen atom, or

R^{5a} and R^{5b} represent General Formula (5-a).

[Chem. 4 8]

-P^{5a} (5-a)

In the formula, P^{5a} represents a polymerizable functional group and Sp^{5a} represents the same meaning as Sp³.

P^{5a} preferably represents a substituent selected from the polymerizable groups represented by the following Formula (P-1) to Formula (P-20).

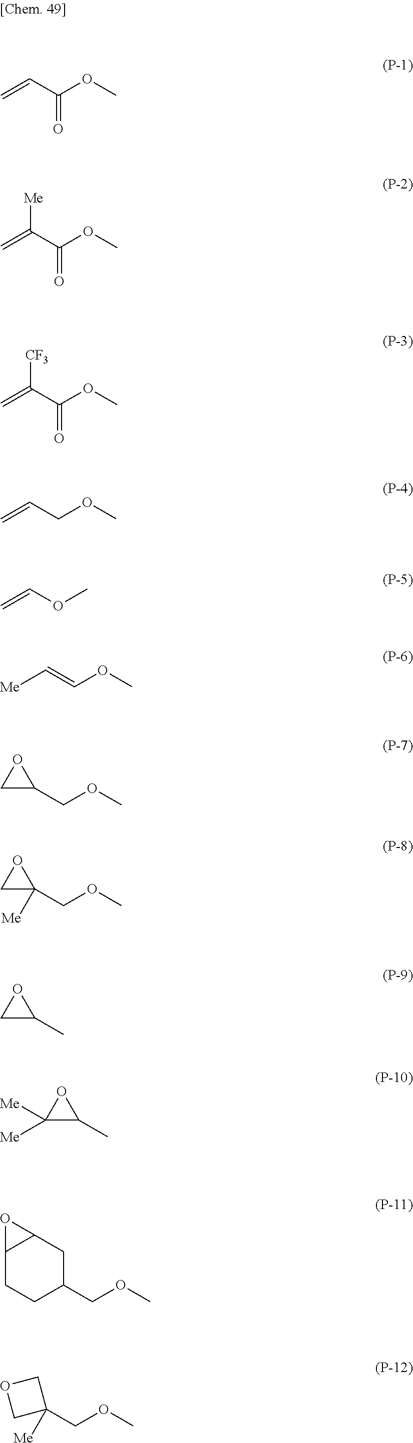

Among the polymerizable functional groups, Formula (P-1), or Formulas (P-2), (P-7), (P-12), and (P-13) are preferable and Formulas (P-1), (P-7), and (P-12) are more preferable from a viewpoint of increasing polymerizing properties and storage stability.

Specific examples of the chiral compound may include compounds of compounds (5-5) to (5-25) but the examples are not limited to the following compounds.

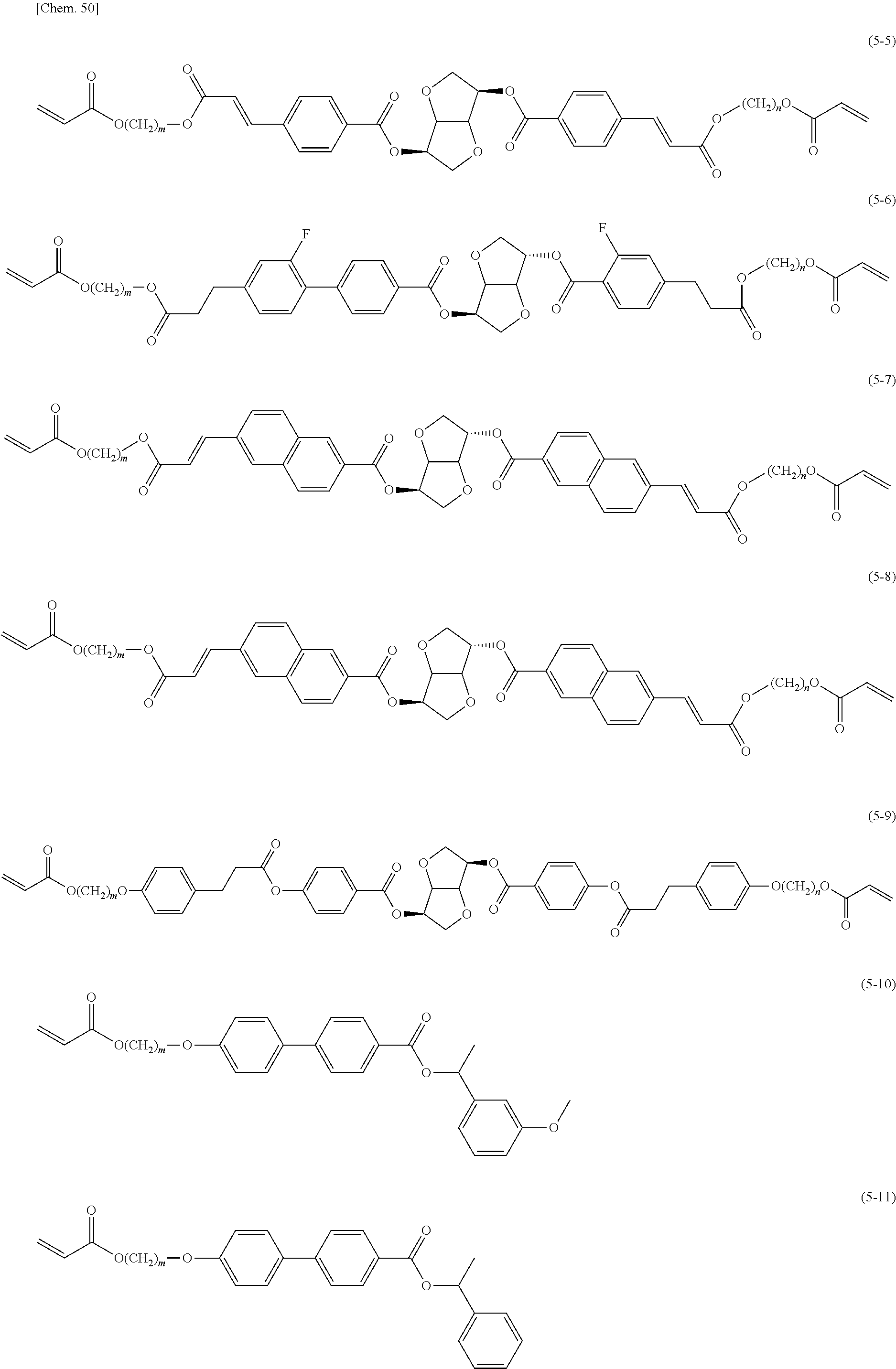

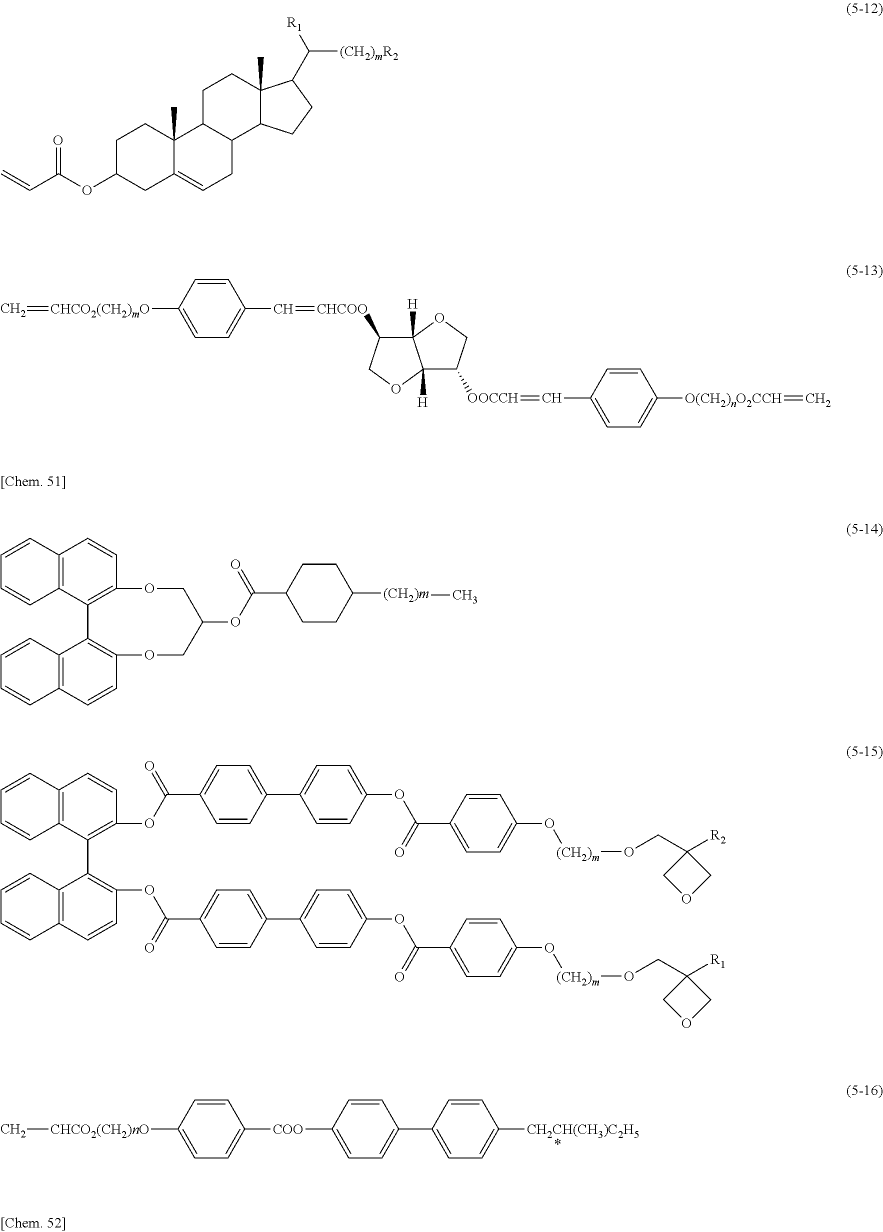

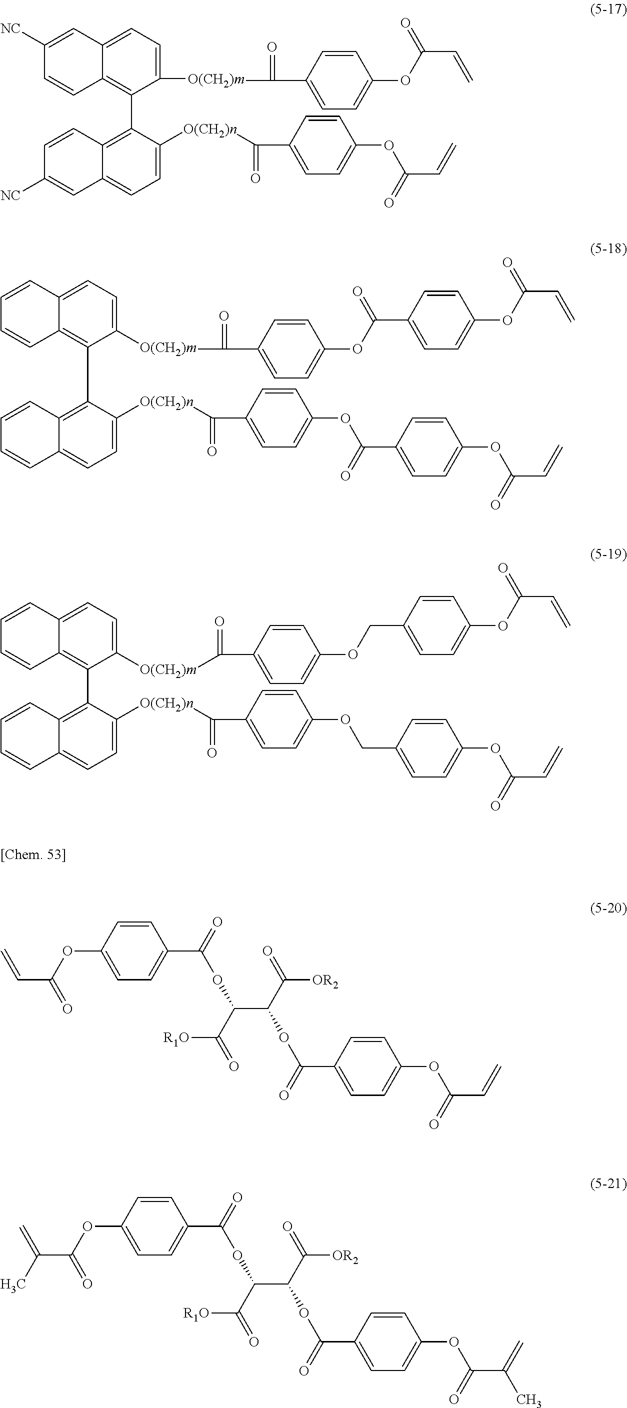

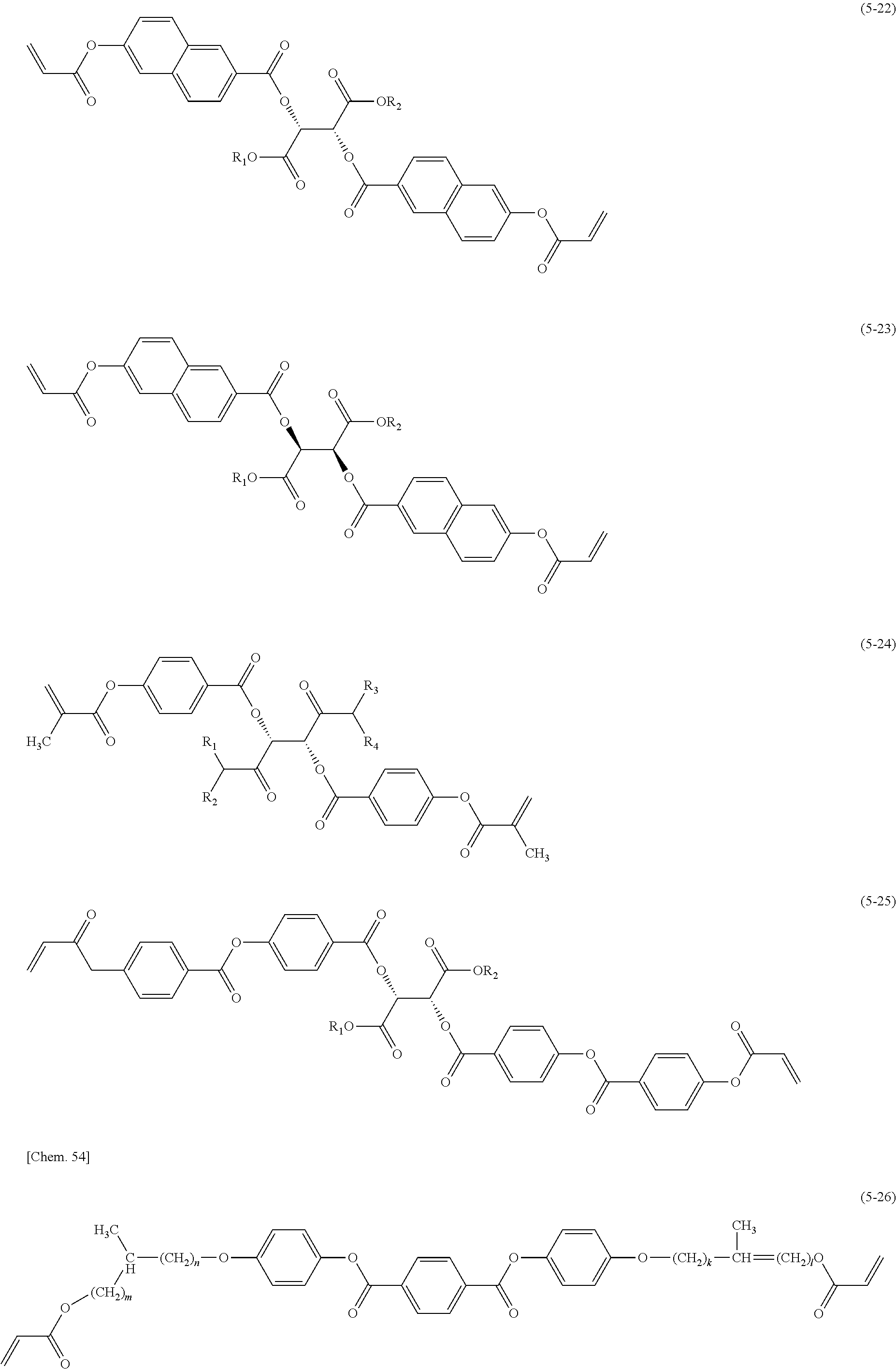

In the formulas, m, n, k, and l each independently represent an integer of 1 to 18, R₁ to R₄ each independently represent a hydrogen atom, an alkyl group having 1 to 6 carbon atoms, an alkoxy group having 1 to 6 carbon atoms, a carboxyl group, or a cyano group. In a case where these groups represent an alkyl group having 1 to 6 carbon atoms or an alkoxy group having 1 to 6 carbon atoms, all of the groups may be unsubstituted or may be substituted with 1 or 2 or more halogen atoms.

(Organic Solvent)

An organic solvent is added to the polymerizable liquid crystal composition of the present invention and the composition may be used as a polymerizable liquid crystal composition solution. The organic solvent to be used is not particularly limited, but an organic: solvent allowing the polymerizable liquid crystal compound to show satisfactory solubility is preferable, and an organic solvent which can foe dried at a temperature of 100° C. or less is preferable. Examples of this solvent, include aromatic hydrocarbon such as toluene, xylene, cumene, and mesitylene, an ester-based, solvent such as methyl acetate, ethyl acetate, propyl acetate, and butyl acetate, a ketone-based solvent such as methyl ethyl ketone, methyl isobutyl ketone, cyclohexanone, and cyclopentanone, an ether-based solvent such as tetrahydrofuran, 1,2-dimethoxyethane, and anisole, an amide-based solvent such as N,N-dimethyl formamide and N-methyl-2-pyrrolidone, propylene glycol monomethyl ether acetate, diethylene glycol monomethyl ether acetate, y-butyrolactone and chlorobenzene. These may be used alone or two or more types may be used in combination, and one or more types of the ketone-based solvent, an ether-based solvent, an ester-based solvent and an aromatic hydrocarbon-based solvent is preferably used from a viewpoint, of solution stability.

The ratio of the organic solvent to be used is not particularly limited as long as the solvent does not remarkably impair a coated state, since the polymerizable liquid crystal composition used in the present invention is normally coated. The content of the organic solvent, contained in the polymerizable liquid crystal composition solution is preferably 1% to 60% by mass, more preferably 3% to 55% by mass, and particularly preferably 5% to 50% by mass.

When the polymerizable liquid crystal compound is dissolved in the organic solvent, the compound is preferably heated and stirred in order to dissolve uniformly. The heating temperature at the time of heating and stirring may be appropriately adjusted in consideration of solubility of the polymerizable liquid crystal compound to be used in the organic: solvent, and the heating temperature is preferably 15° C. to 110° C., more preferably 15° C. to 105° C., still more preferably 15° C. to 100° C., and particularly preferably 20° C. to 90° C. from a viewpoint of productivity.

In addition, when the polymerizable liquid crystal composition is prepared, the composition is preferably stirred and mixed by a dispersion stirrer. As a specific example of the dispersion stirrer, a disperser having an impeller such as a disper, a propeller, and a turbine blade, a paint shaker, a planetary type stirrer, a shaking apparatus, a shaker, or rotary evaporator can be used. In addition to the above, an ultrasonic irradiation apparatus can be used.

It is preferable to appropriately adjust the number of stirring revolution depending on a stirrer to be used, when the polymerizable liquid crystal composition solution is prepared. The number of stirring revolution is preferably 10rpm to 1000 rpm, more preferably 50 rpm to 800 rpm, and particularly preferably 150 rpm to 600 rpm, in order to obtain a uniform polymerizable liquid crystal composition solution.

(Polymerization Inhibitor)

A polymerization inhibitor is preferably added in order to increase solution solubility of the polymerizable liquid crystal composition of the present invention. Examples of the polymerization inhibitor include a phenol-based compound, a quinone-based compound, an amine-based compound, a thioether-based compound and a nitroso compound.

Examples of the phenol-based compound include p-methoxyphenol, cresol, t-butyl catechol, 3,5-di-t-butyl-4-hydroxytoluene, 2,2′-methylene bis(4-methyl-6-t-butyl phenol), 2,2′-methylene bis(4-ethyl-6-t-butyl phenol), 4.4′-thiobis(3-methyl-6-t-butyl phenol), 4-methoxy-1-naphthol, and 4,440 -dialkoxy-2,2′-bi-1-naphthol.

Examples of the quinone-based compound include hydroquinone, methylhydroquinone, tert-butylhydroquinone, p-benzoquinone, methyl-p-benzoquinone, tert-butyl-p-benzoquinone, 2,5-diphenylbenzoquinone, 2-hydroxy-1,4-naphthoquinone, 1,4-naphthoquinone, 2,3-dichloro-1,4-naphthoquinone, anthraquinone, and diphenoquinone.

Example of the amine-based compound include p-phenylene diamine, 4 -aminodiphenylamine, N,N′-diphenyl-p-phenylene diamine, N-i-propyl-N′-phenyl-p-phenylene diamine, N-(1,3-dimethyl butyl)-N′-phenyl-p-phenylene diamine, N,N′-di-2-naphthyl-p-phenylene diamine, diphenylamine, N-phenyl-β-naphthylamine, 4,4′-dicumyl-diphenylamine, and 4.4′-dioctyl-diphenylamine.

Examples of the thioether-based compound include phenothiazine and distearyl thiodipropionate.

Examples of the nitroso-based compound include N-nitroso diphenylamine, N-nitroso phenyl naphthylamine, N-nitroso dinaphthylamine, p-nitroso phenol, nitroso benzene, p-nitroso diphenylamine, α-nitroso-β-naphthol, N,N-dimethyl p-nitroso aniline, p-nitroso diphenylamine, p-nitrone dimethylamine, p-nitrone-N,N-diethylamine, N-nitroso ethanolamine, N-nitroso di-n-butylamine, N-nitroso-N-n-butyl-4-butanolamine, N-nitroso-diisopropanolamine, N-nitroso-N-ethyl-4-butanolamine, 5-nitroso-8-hydroxyquinoline, N-nitroso morpholine, N-nitroso-N-phenyl hydroxylamine ammonium salt, nitroso benzene, 2,4,6-tri-tert-butyl nitrone benzene, N-nitroso-N-methyl-p-toluene sulfonamide, N-nitroso-N-ethyl urethane, N-nitroso-N-n-propyl urethane, 1-nitroso-2-naphthol, 2 -nitroso-1-naphthol, 1-nitroso-2-naphthol-3,6-sodium sulfate, 2-nitroso-1-naphthol-4-sodium sulfate, 2-nitroso-5-methyl aminophenol hydrochloride, and 2-nitroso-5-methyl aminophenol hydrochloride.

The addition amount of the polymerization inhibitor is preferably 0.01% to 1.0% by mass and more preferably 0.05% to 0.5% by mass with respect to the polymerizable liquid crystal composition.

(Antioxiclant)

An antioxidant is preferably added in Order to increase solution solubility of the polymerizable liquid crystal composition of the present invention. Examples of this compound include hydroquinone derivatives, a nitrosamine-based polymerization inhibitor, and a hindered phenol-based antioxidant, and specific examples thereof include tert-butyl hydroquinone, methyl hydroquinone, “Q-1300” and “Q-1301” of Wako Pure Chemical Industries, Ltd., and “IRGANOX 1010”, “IRGANOX 1035”, “IRGANOX 1076”, “IRGANOX 1038”, “IRGANOX 1135”, “IRGANOX 1330”, “IRGANOX 1425”, “IRGANOX 1520”, “IRGANOX 1726”, “IRGANOX 245”, “IRGANOX 259”, “IRGANOX 3114”, “IRGANOX 3790”, “IRGANOX 5057”, “IRGANOX 565” of BASF SE.

The addition amount of the antioxidant is preferably 0.01% to 2.0% by mass and more preferably 0.05% to 1.0% by mass with respect to the polymerizable liquid crystal composition.

(Photopolymerization Initiator)

The polymerizable liquid crystal composition of the present invention preferably contains a photopolymerization initiator. At least I type or more of the photopolymerization initiator is preferably contained. Specific examples thereof include “Irgacure 651”, “Irgacure 184”, “Darocar 1173”, “Irgacure 907”, “Irgacure 627”, “Irgacure 368, “Irgacure 379, “Irgacure 819”, “Irgacure 2959”, “Irgacure 1800”, “Irgacure 250”, “Irgacure 754”, “Irgacure 784”, “Irgacure OXE01”, “Irgacure OXE02”, “Lucirin TPO”, “Darocur 1173”, and “Darocur MBF” manufactured by BASF SE, “Esacure 1001M”, “Esacure KIP150”, “Speedcure BEM”, “Speedcure BMS”, “Speedcure MBP”, “Speedcure PBZ”, “Speedcure ITX”, “Speedcure DETX”, “Speedcure EBD”, “Speedcure MBB”, and “Speedcure BP” manufactured by LAMBSON, LTD., “Kavacure DMBI” manufactured by Nippon Kayaku Co.,Ltd., “TAZ-A” manufactured by Nihon Siberhegner K.K. (currently, DKSH Japan K.K.), “ADEKA OPTOMER SP-152”, “ADEKA OPTOMER SP-170”, “ADEKA OPTOMER N-1414”, “ADEKA OPTOMER N-1606”, “ADEKA OPTOMER N-1717”, and “ADEKA OPTOMER N-1919” manufactured by ADEKA Corporation.

The use amount of the photopolymerization initiator is preferably 0.1% to 10% by mass and particularly preferably 0.5% to 5% by mass with respect to the polymerisable liquid crystal composition. These may be used alone or two or more types may be used in combination, and a sensitizer may be added.

(Thermal Polymerization Initiator)

As a thermal polymerization initiator used at the time of thermal polymerization, a well-known thermal polymerization initiator may be used and for example, organic peroxides such as methyl acetoacetates peroxide, cumene hydroperoxide, benzoyl peroxide, bis (4-t-butyl cyclohexyl)peroxy dicarbonate, t-butylperoxy benzoate, methyl ethyl ketone peroxide, 1,1-bis(t-hexylperoxy)3,3,5-trimethyl cyclohexane, p-pentahydroperoxide, t-butyl hydroperoxide, dicumyl peroxide, isobutyl peroxide, di(3-methyl-3-methoxybutyl)peroxydicarbonate, and 1,1-bis(t-butyl peroxy)cyclohexane; an azonitrile compound such as 2,2′-azobisisobutyronitrile and 2,2′-azobis(2,4-dimethyl valeronitrile); an azoamidine compound such as 2,2′-azobis (2-methyl-N-phenyl propione-amidine)dihydrochloride; an azoamide compound such as 2,2′azobis(2-methyl-N-[1,1-bis(hydroxymethyl)-2-hydroxyethyl]propionamide); and an alkylato compound such as 2,2′azobis (2,4,4-trimethyl pentane) may be used. The content of the thermal polymerisation initiator is preferably 0.1 to 10 mass and particularly preferably 1% to 6% by mass. These may be used alone or 2 or more types thereof may be used in combination.

(Surfactant)

The polymerizable liquid crystal composition of the present invention may contain at least 1 type or more of a surfactant in order to reduce unevenness of the film thickness when the composition is made into an optically anisotropic body. Examples of the surfactant which may be contained include alkyl carboxylate, alkyl phosphate, alkyl sulfonate, fluoroalkyl carboxylate, fluoroalkyl phosphate, fluoroalkyl sulfonate, polyoxyethylene derivatives, fluoroalkyl ethylene oxide derivatives, polyethylene glycol derivatives, an alkyl ammonium salt, and a fluoroalkyl ammonium salt, and a fluorine-containing surfactant is particularly preferable.

Specific examples thereof include “Megafac F-114”, “Megafac F-251”, “Megafac F-281”, “Megafac F-410”, “Megafac F-430”, “Megafac F-444”, “Megafac F-472SF”, “Megafac F-477”, “Megafac F-510”, “Megafac F-511”, “Megafac F-552”, “Megafac F-553”, “Megafac F-554”, “Megafac F-555”, “Megafac F-556”, “Megafac F-557”, “Megafac F-558”, “Megafac F-559”, “Megafac F-510”, “Megafac F-561”, “Megafac F-562”, “Megafac F-563”, “Megafac F-565”, “Megafac F-567”, “Megafac F-568”, “Megafac F-56S”, “Megafac F-570”, “Megafac F-571”, “Megafac R-40”, “Megafac R-41”, “Megafac R-43”, “Megafac R-94”, “Megafac RS-72-K”, “Megafac RS-75”, “Megafac RS-76-E”, “Megafac RS-76-NS”, “Megafac RS-90”, “Megafac EXP.TF-1367”, “Megafac EXP.TF1437”, “Megafac EXP.TF1537”, and “Megafac EXP.TF-2066” (all of the above are manufactured by DIC Corporation),

“Ftergent 100”, “Ftergent 100C”, “Ftergent 110”, “Ftergent 150”, “Ftergent 150CH”, “Ftergent 100A-K”, “Ftergent 300”, “Ftergent 310”, “Ftergent 320”, “Ftergent 400STS”, “Ftergent 251”, “Ftergent 215M”, “Ftergent 212M”, “Ftergent 215M”, “Ftergent 250”, “Ftergent 222F”, “Ftergent 212D”, “FTX-218”, “Ftergent 209F”, “Ftergent 245F”, “Ftergent 20SG”, “Ftergent 240G”, “Ftergent 212P”, “Ftergent 220P”, “Ftergent 228P”, “DFX-18”, “Ftergent 601AD”, “Ftergent 602A”, “Ftergent 650A”, “Ftergent 750FM”, “FTX-730FM”, “Ftergent 73QFL”, “Ftergent 710FS”, “Ftergent 710FM”, “Ftergent 710FL”, “Ftergent 750LL”, “FTX-730LS”, and “Ftergent 730LM”, (all of the above are manufactured by NEOS COMPANY LIMITED),

“BYK-300”, “BYK-302”, “BYK-306”, “BYK-307”, “BYK-310”, “BYK-315”, “BYK-320”, “BYK-322”, “BYK-323”, “BYK-325”, “BYK-330”, “BYK-331”, “BYK-333”, “BYK-337”, “BYK-340”, “BYK-344”, “BYK-370”, “BYK-375”, “BYK-377”, “BYK-350”, “BYK-352”, “BYK-354”, “BYK-355”, “BYK-356”, “BYK-353N”, “BYK-361N”, “BYK-357”, “BYK-390”, “BYK-392”, “BYK-0V3500”, “BYK-UV3510”, BYK-W3570”, and “BYK-Silclean3700” (all of the above are manufactured by BYK Japan K.K.),

“TEGO Rad2100”, “TEGO Rad2011”, “TEGO Rad220GN”, “TEGO Rad2250”, “TEGO Rad2300”, “TEGO Rad25GO”, “TEGO Rad2600”, “TEGO Rad2650”, “TEGO Rad2700”, “TEGO Flow300”, “TEGO Flow370”, “TEGO Flow425”, “TEGO Flow ATF2”, “TEGO Flow ZFS460”, “TEGO Glide100”, “TEGO Glide100”, “TEGO Glide130”, “TEGO Glide410”, “TEGO Glide411”, “TEGO Glide415”, “TEGO Glide432”, “TEGO Glide440”, “TEGO Glide450”, “TEGO Glide482”, “TEGO Glide A115”, “TEGO Glide B1484”, “TEGO Glide ZG400”, “TEGO Twin4000”, “TEGO Twin4100”, “TEGO Twin4200”, “TEGO Wet240”, “TEGO Wet250”, “TEGO Wet.260”, “TEGO Wet265”, “TEGO Wet270”, “TEGO Wet280”, “TEGO Wet500”, “TEGO Wet505”, “TEGO Wet510”, “TEGO Wet520”, and “TEGO Wet KL245” (all of the above are manufactured by Evonik Japan Co., Ltd.), “FC-4430” and “FC-4432” (all of the above are manufactured by 3M Japan Limited), “Unicycle MS” (all of the above are manufactured by DAIKIN INDUSTRIES, LTD.), “Surfion S-241”, “Surflon S-242”, “Surflon S-243”, “Surflon S-420”, “Surflon S-611”, “Surflon S-651”, and “Surflon S-386” (all of the above are manufactured by AGC SEIMI CHEMICAL CO., LTD.), “DISPARLON GX-S80EF”, “DISPARLON OX-881”, “DISPARLON OX-833”, “DISPARLON OX-77EF”, “DISPARLON OX-710”, “DISPARLON 1922”, “DISPARLON 1927”, “DISPARLON 1958”, “DISPARLON P-410EF”, “DISPARLON P-420”, “DISPARLON P-425”, “DISPARLON FP-7”, “DISPARLON 1970”, “DISPARLON 330”, “DISPARLON LF-1980”, “DISPARLON LF-1982”, “DISPARLON LF-1983”, “DISPARLON LF-1034”, “DISPARLON LF-1985”, “DISPARLON LHP-90”, “DISPARLON LHP-91”, “DISPARLON LHP-95”, “DISPARLON LHP-96”, “DISPARLON OX-715”, “DISPARLON 1930N”, “DISPARLON 1931”, “DISPARLON 1933”, “DISPARLON 1934”, “DISPARLON 1711EF”, “DISPARLON 1751N”, “DISPARLON 1761”, “DISPARLON LS-009”, “DISPARLON LS-001”, and “DISPARLON LS-050” (all of the above are manufactured by Kusumoto Chemicals, Ltd.), “PF-151N”, “PF-636”, “PF-6320”, “PF-656”, “PF-6520”, “PF-652-NF”, and “PF-3320” (all of the above are manufactured by OMNOVA Solutions Inc.), “Polyflow No. 7”, “Polyflow No. 50E”, “Polyflow No. 50EHF”, “Polyflow No. 54N”, “Polyflow No. 75”, “Polyflow No. 77”, “Polyflow No. 85”, “Polyflow No. 85HF”, “Polyflow No. 90”, “Polyflow No. 90D-50”, “Polyflow No. 95”, “Polyflow No. 99C”, “Polyflow KL-400K”, “Polyflow KL-400HF”, “Polyflow KL-401”, “Polyflow KL-402”, “Polyflow KL-403”, “Polyflow KL-404”, “Polyflow KL-100”, “Polyflow LE-604”, “Polyflow KL-700”, “Flowlen AC-300”, “Flowlen AC-303”, “Flowlen AC-324”, “Flowlen AC-326F”, “Flowlen AC-530”, “Flowlen AC-903”, “Flowlen AC-903HF”, “Flowlen AC-1160”, “Flowlen AC-1190”, “Flowlen AC-2000”, “Flowlen AC-2300C”, “Flowlen AO-82”, “Flowlen AO-98”, and “Flowlen AD-108” (all of the above are manufactured by KYOEISHA CHEMICAL Co., LTD), WL-7001”, “L-7002”, “8032ADDITIVE”, “57ADDTIVE”, “L-7064”, “FZ-2110”, “FZ-2105”, “67ADDTIVE”, and “8616ADDTIVE” (all of the above are manufactured by Dow Corning Toray Co., Ltd.).

The addition amount of the surfactant is preferably 0.01% to 2% by mass and more preferably 0.05% to 0.5% by mass with respect to the polymerizable liquid crystal composition.

In addition, by using the aforementioned surfactant, a tilt angle of an air interface can be effectively reduced in a case where the polymerizable liquid crystal composition of the present invention is made into an optically anisotropic body.

The polymerizable liquid crystal composition of the present invention has an effect of effectively reducing a tilt angle of an air interface when the composition is made into an optically anisotropic body and a compound having a repeating unit represented by the following General Formula (6) and a weight average molecular weight of 100 or more is exemplified as a surfactant other than the above.

[Chem. 55]

—(CR¹¹R¹²—CR¹³R¹⁴)— (6)

In the formula, R¹¹, R¹², R¹³ and R¹⁴ each independently represent a hydrogen atom, a halogen atom, or a hydrocarbon group having 1 to 20 carbon atoms, and a hydrogen atom in the hydrocarbon group may be substituted with one or more halogen atoms

Preferred examples of the compound represented by General Formula (6) include polyethylene, polypropylene, polyisobutylene, paraffin, fluidized paraffin, chlorinated polypropylene, chlorinated paraffin, and chlorinated fluidized paraffin.

The compound represented by General Formula (6) is preferably added in the step of mixing the polymerizable compound in the organic solvent, and heating and stirring the compound to prepare a polymerizable solution, but the compound may be added in the step of mixing the photopolymerization initiator in the polymerizable solution after the above, or may be added in both steps.

The addition amount of the compound represented by General Formula (6) is preferably 0.01% to 1% by mass and more preferably 0.05% to 0.5% by mass with respect to the polymerizable liquid crystal composition solution.

A chain-transfer agent is preferably added in order to further improve adhesion of an optically anisotropic body to abase material in a case where the polymerizable liquid crystal composition of the present invention solution is made into the optically anisotropic body. As the chain-transfer agent, a thiol compound is preferable, monothiol, dithiol, trithiol, and tetrathiol compounds are more preferable, and a trithiol compound is still more preferable. Specifically, compounds represented by the following General Formulas (6-1) to (6-12) are preferable.

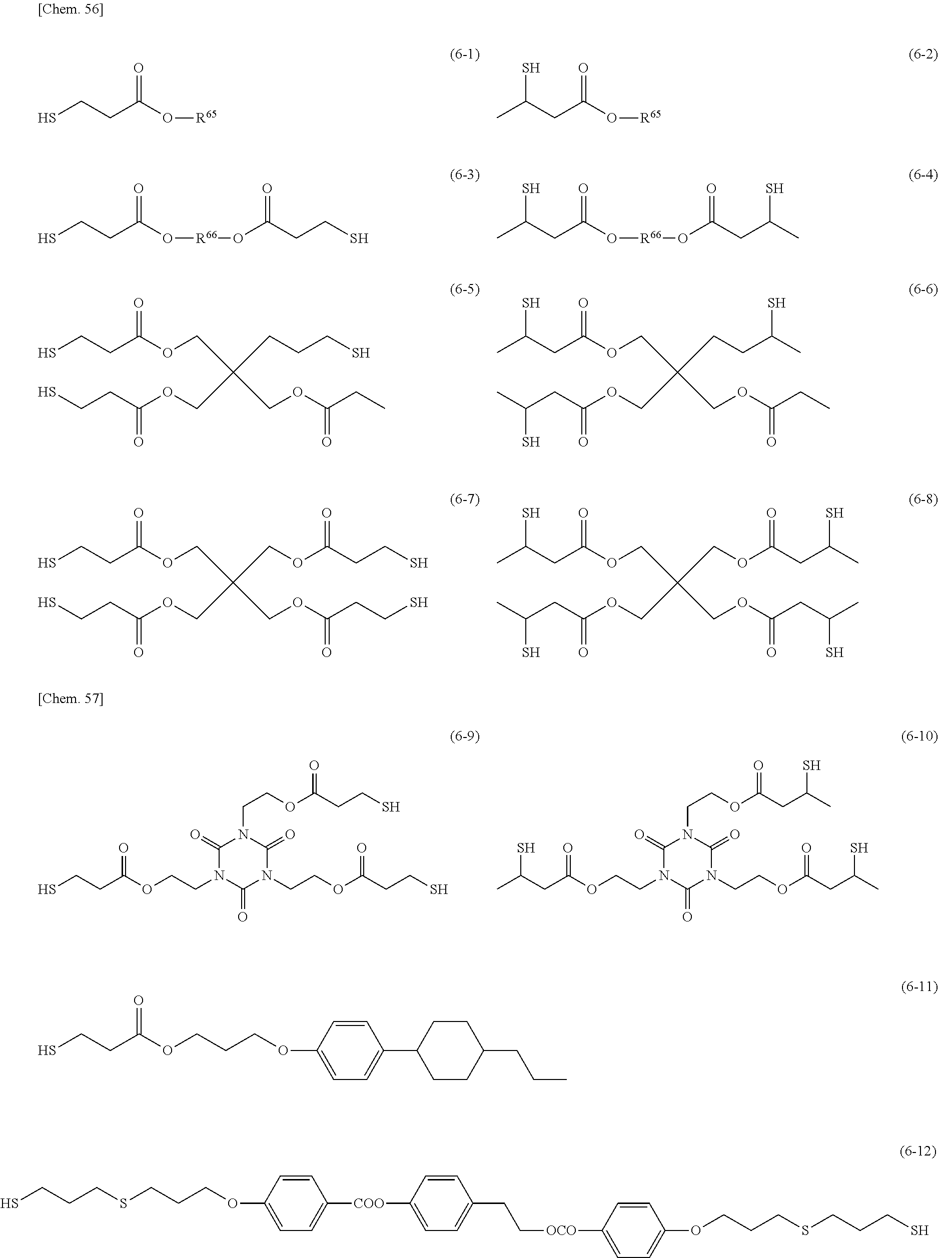

In the formulas, R⁶⁵ represents an alkyl group having 2 to 18 carbon atoms, the alkyl group may be linear or branched, one or more methylene groups in the alkyl group has an oxygen atom and a sulfur atom not directly bonded to each other and may be substituted with an oxygen atom, a sulfur atom, —CO—, —OCO—, —COO—, or —CH═CH—, R⁶⁶ represents an alkylene group having 2 to 18 carbon atoms, and one or more methylene groups in the alkylene group has an oxygen atom and a sulfur atom not directly bonded to each other and may be substituted with an oxygen atom, a sulfur atom, —CO—, —OCO—, —COO—, or —CH═CH—.

The chain-transfer agent is preferably added in the step of mixing the polymerizable liquid crystal compound in the organic solvent, and heating and stirring the compound to prepare a polymerizable solution, but the agent may be added in the step of mixing the polymerization initiator in the polymerizable solution after the above, or may be added in both steps.

The addition amount of the chain-transfer agent is preferably 0.5% to 10% by mass and more preferably 1.0% to 5.0% by mass with respect to the polymerizable liquid crystal composition.

Further, a non-polymerizable liquid crystal compound or a polymerizable compound having no crystal unity may be added if necessary, in order to adjust physical properties. The polymerizable compound having no crystallinity is preferably added in the step of mixing the polymerizable compound in the organic solvent, and heating and stirring the compound to prepare a polymerizable solution, but the non-polymerizable liquid crystal compound may be added in the step of mixing the polymerization initiator to the polymerizable solution after the above, or may be added in both steps. The addition amount of these compounds is preferably 20% by mass or less, more preferably 10% by mass or less, and still more preferably 5% by mass or less with respect to the polymerizable liquid crystal composition.

An additive such as a thixotropic agent, an ultraviolet ray absorber, an infrared ray absorber, an antioxidant, or a surface treating agent, may be added to the polymerizable mixture or the polymerizable composition of the present invention according to the purpose, to the extent that an aligning ability of the liquid crystal is not considerably degraded.

(Optically Anisotropic Body)

The polymerizable liquid crystal composition of the present invention is applied to a base material having an aligning ability, liquid crystal molecules in the polymerizable liquid crystal composition of the present invention are aligned uniformly in a state where a smectic phase and a nematic phase are retained and polymerized to obtain an optically anisotropic body of the present invention.

The retardation film of the present invention is not particularly limited as long as the retardation film improves view angle dependency by an influence of birefringence properties of the liquid crystal molecules, and various alignment modes can be applied. For example, an alignment mode of a positive A plate, a negative A plate, a positive C plate, a negative C plate, a biaxial plate, a positive O plate, and a negative O plate can be applied. Among these, a positive A plate and a negative C plate are preferably used. Further, lamination of the positive A plate and the negative C plate are more preferable.

Here, the positive A plate means an optically anisotropic body in which the polymerizable liquid crystal composition is homogeneously aligned. In addition, the negative C plate means an optically anisotropic body in which the polymerizable liquid crystal composition is aligned in a cholesteric manner.

In the liquid crystal cell according to one embodiment of the present invention, the positive A plate is preferably used as a first retardation film in order to widen a view angle by compensating dependency of a polarizing axis-orthogonal view angle. Here, the positive A plate satisfies a relationship of “nx>ny=nz”, when a refractive index in an in-plane delayed phase axis direction of a film is nx, a refractive index in an in-plane advanced phase axis direction of a film is ny, and a refractive index in a thickness direction of a film is nz. As the positive A plate, an in-plane retardation value at a wavelength of 550 nm is preferably in the range of 30 to 500 nm. In addition, the retardation value in a thickness direction is not particularly limited. An Nz coefficient is preferably in the range of 0.9 to 1.1.

In addition, in order to eliminate birefringence of the liquid crystal molecules, so-called a negative C plate having negative refractive index anisotropy is preferably used as a second retardation film, in addition, the negative C plate may be laminated on the positive A plate.

Here, the negative C plate is a retardation film -which satisfies “nx=ny>nz”, when a refractive index in an in-plane delayed phase axis direction of a retardation film is nx, a refractive index in an in-plane advanced phase a is direction of a retardation film is ny, and a refractive index in a thickness direction of a retardation film is nz. The retardation value in a thickness direction of the negative C plate is preferably in the range of 20 to 400 nm.

In addition, the refractive index anisotropy in a thickness direction is represented by a retardation value Rth in a thickness direction defined in Equation (2). The retardation value Rth in a thickness direction can be calculated by using an in-plane retardation value R⁰, a retardation value R₅₀ measured by inclining a delayed axis by 50° as an inclined axis, a thickness of a film d, and an average refractive index no of a film to obtain nx, ny, and nz by numerical calculation from Equation (1) and the next Equations (4) to (7), and substituting these with Equation (2). In addition, the Nz coefficients can be calculated from Equation (3). Hereinafter, the same applies to other descriptions in the present specification.

R₀=(nx−ny)×d (1)

Rth=[(nx+ny)/2−nz]×d (2)

Nz coefficient=(nx−nz)/(nx−ny) (3)

R₅₀=(nx−ny′)×d/cos (φ) (4)

(nx+ny+nz)/3=n0 (5)

where,

φ=sin⁻¹[sin(50°)/n₀] (6)

ny′=ny×nz/[ny²×sin²(φ)+nz²×cos²(φ)]^{1/2} (7)

In a commercially available apparatus for measuring retardation, the numerical calculation described herein is automatically performed within the apparatus and the in-plane retardation value R⁰ or the retardation value Rth in a thickness direction is usually automatically displayed. Examples of this measuring apparatus include RETS-100 (manufactured by Otsuka Chemical Co., Ltd.).

(Base Material)

The base material used for the optically anisotropic body of the present invention is a base material commonly used for a liquid crystal device, a display, an optical part, or an optical film. The base material is not particularly limited as long as the base material has thermal resistance against beating at the time of drying the applied polymerizable composition solution of the present invention. Examples of this base material include a glass base material, a metal base material, a ceramic base material, and an organic material such as a plastic base material. In particular, in a case where the base material is an organic material, examples thereof include cellulose derivatives, polyolefin, polyester, polyolefin, polycarbonate, polyacrylate, polyallylate, polyether sulfone, polyamide, polyphenylene sulfide, polyphenylene ether, nylon, and polystyrene. Among these, a plastic base material such as polyester, polystyrene, polyolefin, cellulose derivatives, polyallylate, and polycarbonate is preferable. The shape of the base material may have a curved surface in addition to a flat plate. This base material may have an electrode layer, a reflection prevention function, and a reflection function, if necessary.

The base material may be surface treated in order to improve coating properties and adhesive properties of the polymerizable liquid crystal composition of the present invention. Examples of the surface treatment include an ozone treatment, a plasma treatment, a corona treatment, and a si lane coupling treatment.

(Coating)

Examples of a coating method for obtaining the optically anisotropic body of the present invention include the well-known methods such as an applicator method, a bar coating method, a spin coating method, a roll coating method, a direct, gravure coating method, a reverse gravure coating method, a flexo coating method, an ink jet method, a die coating method, a cap coating method, a dip coating, and a slit, coating method. After the polymerizable liquid crystal composition is applied, the composition is dried.

(Polymerization Step)

A polymerization operation of the polymerizable liquid crystal composition of the present invention is generally performed by irradiating the composition with an ultraviolet, ray or heating the composition, in a state where the liquid crystal compound in the polymerizable liquid crystal composition is horizontally aligned, vertically aligned, or aligned in a hybrid manner or aligned in a cholesteric manner (plane alignment) with respect to the base material. In a case where polymerization is performed by irradiation with light, specifically, the composition is preferably irradiated with an ultraviolet, ray of 390 nm or less and most preferably light, having a wavelength of 250 to 370 nm. However, in a case where the polymerizable composition is decomposed by an ultraviolet, ray of 390 nm or less, it is preferable to perform polymerization with an ultraviolet ray of 390 nm or more. The ray is preferably diffused and unpolarized.

(Polymerization Method)

Examples of the method for polymerizing liquid polymerizable liquid crystal composition of the present invention include a method for irradiating the composition with an active energy ray and a thermal polymerization method. However, a method for irradiating the composition with an active energy ray is preferable from a viewpoint of advancing the reaction at room temperature. Among these, a method for irradiating the composition with light such as an ultraviolet ray is preferable from a viewpoint of a simple operation. The temperature at the time of irradiation is a temperature in which the polymerizable liquid crystal composition of the present invention can retain a liquid crystal phase, and the temperature of 50° C. or less is preferable as much as possible in order to avoid inducement of thermal polymerization of the polymerizable liquid crystal composition. In addition, the liquid crystal composition normally shows a liquid crystal phase within from C (solid phase)-N (nematic) transition temperature (hereinafter, abbreviated as a C-N transition temperature.) to an N-I transition temperature range, in the step of increasing a temperature. Meanwhile, in the step of decreasing a temperature, since the composition takes a thermodynamically non-equilibrium state, the composition may retain a liquid crystal state, without, being aggregated even in the C-N transition temperature or lower. This state is referred to as a supercooled state. In the present, invention, the liquid crystal composition, in a supercooled state is included in a state where the liquid crystal phase is retained. Specifically, the composition is preferably irradiated with an ultraviolet ray of 390 nm or less and most, preferably irradiated with light having a wavelength of 250 to 370 nm. However, in a case where the polymerization composition is decomposed by irradiation with an ultraviolet ray of 390 nm or less, it is preferable to perform polymerization with an ultraviolet ray of 390 nm or more. The ray is preferably diffused and unpolarized. The irradiation intensity of the ultraviolet ray is preferably in the range of 0.05 kW/m² to 10 kW/m². In particular, the range of 0.2 kW/m² to 2 kW/m² is preferable. In a case where the intensity of the ultraviolet ray is less than 0.05 kW/m², it takes a great, period of time to complete the polymerization. Meanwhile, in a case where the intensity exceeds 2 kW/m², there is possibility that the liquid crystal molecule in the polymerizable liquid crystal composition tends to be photodecomposed or generation of a great, amount, of polymerization heat increases the temperature during the polymerization, and a change in an order parameter of the polymerizable liquid crystal causes a disorder of retardation of the polymerized film.

In addition, in order to promote the proceeding of a polymerization reaction of a coating film, the coating film which has been polymerization cured by irradiation with an active energy ray may be thermally cured. The coating film is preferably thermally cured at high temperature, which is 200° C. or more.

After only a particular portion is polymerized by irradiation with an ultraviolet ray using a mask, if an alignment state of the non-polymerized portion is changed by applying an electrical field, a magnetic field, or a temperature, and then the non-polymerized, portion is polymerized, it is possible to obtain an optically anisotropic body having a plurality of areas with a different alignment direction.

In addition, when only the particular portion is polymerized by irradiation with an ultraviolet ray using a mask, if an electrical field, a magnetic field, or a temperature is applied to the polymerizable liquid crystal composition in the non-polymerized state in advance so as to control an alignment, and the composition is polymerized by irradiating the composition with a mask thereon with light, while the non-polymerized state is retained, it is possible to obtain an optically anisotropic body having a plurality of areas with a different alignment direction.

The optically anisotropic body obtained by polymerizing the polymerizable liquid crystal composition of the present invention can be used as a single optically anisotropic body by separating the optically anisotropic body from a substrate, or as an optically anisotropic body as it is without being separated from the substrate. In particular, since the optically anisotropic body hardly contaminates other members, it is useful to use the optically anisotropic body as a substrate to be laminated, or to use by attaching the optically anisotropic body to other substrates.

(Alignment Treatment)

In addition, an alignment film may be provided in the base material such that the polymerizable composition is aligned when the polymerizable composition solution of the present invention is applied and dried. Examples of the alignment treatment include a stretching treatment, a rubbing treatment, an irradiation treatment with a polarized ultraviolet and visible ray, an ion beam treatment, and an oblique vapor deposition treatment of SiO₂ to the base material. In a case where the alignment film is used, a well-known alignment film is used as the alignment film. Examples of the well-known alignment film include polyamide, polysiloxane, polyamide, polyvinyl alcohol, polycarbonate, polystyrene, polyphenylene ether, polyallylate, polyethylene terephthalate, polyether sulfone, an epoxy resin, an epoxyacrylate resin, an acryl resin, and compounds such as a coumarin compound, a chalcone compound, a cinnamate compound, a fulgide compound, an anthraquinone compound, an azo compound, and an aryl ethene compound. As a compound for performing the alignment treatment by rubbing, a compound, in which crystallization of a material is promoted by inputting a heating step in the alignment treatment or after the alignment treatment, is preferable. Among the compounds for performing the alignment treatment other than rubbing, an optical alignment material is preferably used.

(Color Filter)

The liquid crystal display device of the present invention may have a color filter. The color filter is configured to include a black matrix and at least, a PGB three color pixel unit. Any methods may be used to form a color filter, layer. According to one example, a step of obtaining a colored pixel is repeated the number of required times, in Which a coloring composition including a pigment carrier and a color pigment dispersed therein is applied to be a predetermined pattern and the pattern is cured, so as to be able to form a color filter layer. As a pigment included in the coloring composition, an organic pigment and/or an inorganic pigment. may be used. The coloring composition may include I type or the organic or the inorganic pigment and may include a plurality of types of the organic pigment and/or the inorganic pigment. The pigment preferably has high coloring development properties and heat resistance, and particularly resistance to thermal decomposition, and normally, the organic pigment is used. In below, specific examples of the organic pigment which can be used for the coloring composition are shown by a color index number.

As the organic pigment of a red coloring composition, for example, a red pigment such as C.I.Pigment Red 7, 14, 41, 48:2, 48:3, 48:4, 81:1, 81:2, 81:3, 81:4, 146, 168, 177, 178, 179, 184, 185, 187, 200, 202, 208, 210, 246, 254, 255, 264, 270, 272, and 279 can be used. As the organic pigment of the red coloring composition, a mixture of a red pigment and a yellow pigment may be used.

As the yellow pigment, for example, C.I.Pigment Yellow 1, 2, 3, 4, 5, 6, 10, 12, 13, 14, 15, 16, 17, 18, 24, 31, 32, 34, 35, 35:1, 36, 36:1, 37, 37:1, 40, 42, 43, 53, 55, 60, 61, 62, 63, 65, 73, 74, 77, 81, 83, 93, 94, 95, 37, 98, 100, 101, 104, 106, 108, 109, 110, 113, 114, 115, 116, 117, 118, 119, 120, 123, 126, 127, 128, 129, 138, 147, 150, 151, 152, 153, 154, 155, 156, 161, 162, 164, 166, 167, 168, 169, 170, 171, 172, 173, 174, 175, 176, 177, 179, 130, 181, 182, 185, 187, 188, 193, 194, 199, 198, 213, and 214 can be used.

As the organic pigment of a green coloring composition, for example, a green pigment such as C.I.Pigment Green 7, 10, 36, and 37 can be used. As the organic pigment of the green coloring composition, a mixture of the green pigment and the yellow pigment may be used. As the yellow pigment, for example, the same pigment exemplified for the red coloring composition can be used.

As the organic pigment of a blue coloring composition, for example, a blue pigment such as C.I.Pigment Blue 15, 15:1, 15:2, 15:3, 15:4, 15:6, 16, 22, 60, and 64 can be used. As the organic pigment of the blue coloring composition, a mixture of the blue pigment and a violet pigment may be used. As the violet pigment, for example, C.I.Pigment Violet I, 19, 23, 27, 29, 30, 32, 37, 40, 42, or 50 can be used.

As the inorganic pigment, metal oxide powders such as yellow lead, zinc yellow, bengala (red iron oxide (III)), cadmium red, ultramarine blue, Prussian blue, chromic oxide green, and cobalt green, metal sulfide powders, or metal powders can be used. The inorganic pigment can be used in combination with the organic pigment, for example, in order to achieve satisfactory coating properties, sensitivity, and development properties, while a balance of chroma and brightness is obtained.

The coloring composition may further include a coloring component other than the pigment. For example, the coloring composition may include a dye as long as the coloring composition can achieve sufficient thermal resistance. In this case, toning using the dye is possible.

The pigment carrier included in the aforementioned coloring composition is configured to include a resin, a precursor thereof or a mixture thereof. As the resin, a thermoplastic: resin, a thermosetting resin, and a photosensitive resin are included, and as the precursor, a multifunctional monomer which generates a resin upon radiation exposure or an oligomer is included. These can be used alone or two or more types thereof may be used in combination. In a case where the coloring composition is cured upon irradiation with light such as an ultraviolet ray, for example, a photopolymerization initiator may be added to the coloring composition, or a sensitizer may be added in some cases. Also, the coloring composition may further include a chain-transfer agent such as multifunctional thiol. The coloring composition can be manufactured by, for example, finely dispersing one or more types of the pigment in the pigment carrier and the organic solvent, if necessary, with the aforementioned photopolymerization initiator, using a disperser such as a triple roll mill, a double roll mill, a sand mill, a kneacter, and an attritor. The coloring composition including two or more types of the pigment may be manufactured by preparing a dispersion including a different pigment and mixing this dispersion. When the pigment is dispersed in the pigment carrier and the organic solvent, a dispersion auxiliary agent such as a resin type pigment dispersant, a surfactant and pigment derivatives can be used. The dispersion auxiliary agent improves dispersivity of the pigment and suppresses reaggregation of the dispersed pigment. Therefore, in a case where the coloring composition obtained by dispersing the pigment in the pigment carrier and the organic solvent using the dispersion auxiliary agent is used, a color filter having excellent transparency is obtained.

The dispersion auxiliary agent is preferably used, for example, 0.1 to 40 parts by weight and more preferably 0.1 to 30 parts by weight with respect to 100 parts by weight of the pigment in the coloring composition.

The resin type pigment dispersant includes a moiety having affinity to the pigment which adsorbs to the pigment and a moiety having compatibility with the pigment carrier. The resin type pigment dispersant adsorbs to the pigment to stabilize dispersivity of the pigment in the pigment carrier. As the resin type pigment dispersant, for example, an oily dispersant including polycarboxylate such as polyurethane and polyacrylate, unsaturated polyamide, polycarboxylic acid, polycarboxylic acid amine salt, polycarboxylic acid partial amine salt, polycarboxylic acid ammonium salt, polycarboxylic acid alkylamine salt, polysiloxane, long-chain polyaminoamide phosphate, a hydroxyl group-containing polycarboxylate, modified products thereof, amide formed by reacting poly(lower alkylene imine) and polyester having a free carboxyl group and salts thereof; a water-soluble resin or a water-soluble polymer compound including an acrylic acid-styrene copolymer, a methacrylic acid-styrene copolymer, an acrylic acid-acrylate copolymer, an acrylic acid-methacrylate copolymer, a methacrylic acid-acrylate copolymer, a methacrylic acid-methacrylate copolymer, a styrene-maleic acid copolymer, polyvinyl alcohol, and polyvinyl pyrrolidone; polyesters, modified polyacrylates, ethylene oxide/propylene oxide added compounds, phosphates, and mixtures of two or more types thereof can be used.

In addition, a planarizing layer coated with an overcoat may be provided on the surface of the color filter layer.

(Alignment Film)

The liquid crystal display device of the present invention may have an alignment film on the surface where the first substrate and the liquid crystal composition on the second substrate are in contact with each other, in order to cause the liquid crystal composition to be aligned,

As a material for the alignment film, a transparent organic material such as polyamide, polyamide, BCB (benzo cyclo butane polymer), and polyvinyl alcohol can be used. Particularly, a polyamide alignment film is preferable, in which polyamic acid synthesized from diamine such as aliphatic or alicyclic diamine including p-phenylene diamine and 4,4′-diaminodiphenyl methane, and butane tetracarboxylic acid anhydride, aliphatic or alicyclic tetracarboxylic acid anhydride such as 2,3,5-tricarboxycyclopentyl acetic acid anhydride, aromatic tetracarboxylic acid anhydride such as pyromellitic acid dianhydride, is imidated. In this case, as a method for imparting alignment, it is general to use rubbing, but in a case where a vertical alignment film is used, it is possible to use the film without imparting alignment.

As the material for the alignment film, an optical alignment material including chalcone, cinnamate, cinnamoyl, or an azo group in the compound can be used. The material may be used in combination with a material such as polyamide and polyamide, and in this case, for the alignment film, rubbing or an optical alignment technology may be used. Examples or the optical alignment material include polyimide having cyclic cycloalkane, fully aromatic polyacrylate, polyvinyl cinnamate disclosed in JP-A-5-232473, polyvinyl ester of paramethoxycinnamic acid, cinnamate derivatives disclosed in JP-A-6-287453 and JP-A-6-289374, and maleimide derivatives disclosed in JP-A-2002-265541. Specifically, compounds represented by the following Formula (7-1) to Formula (7-11) are preferable.

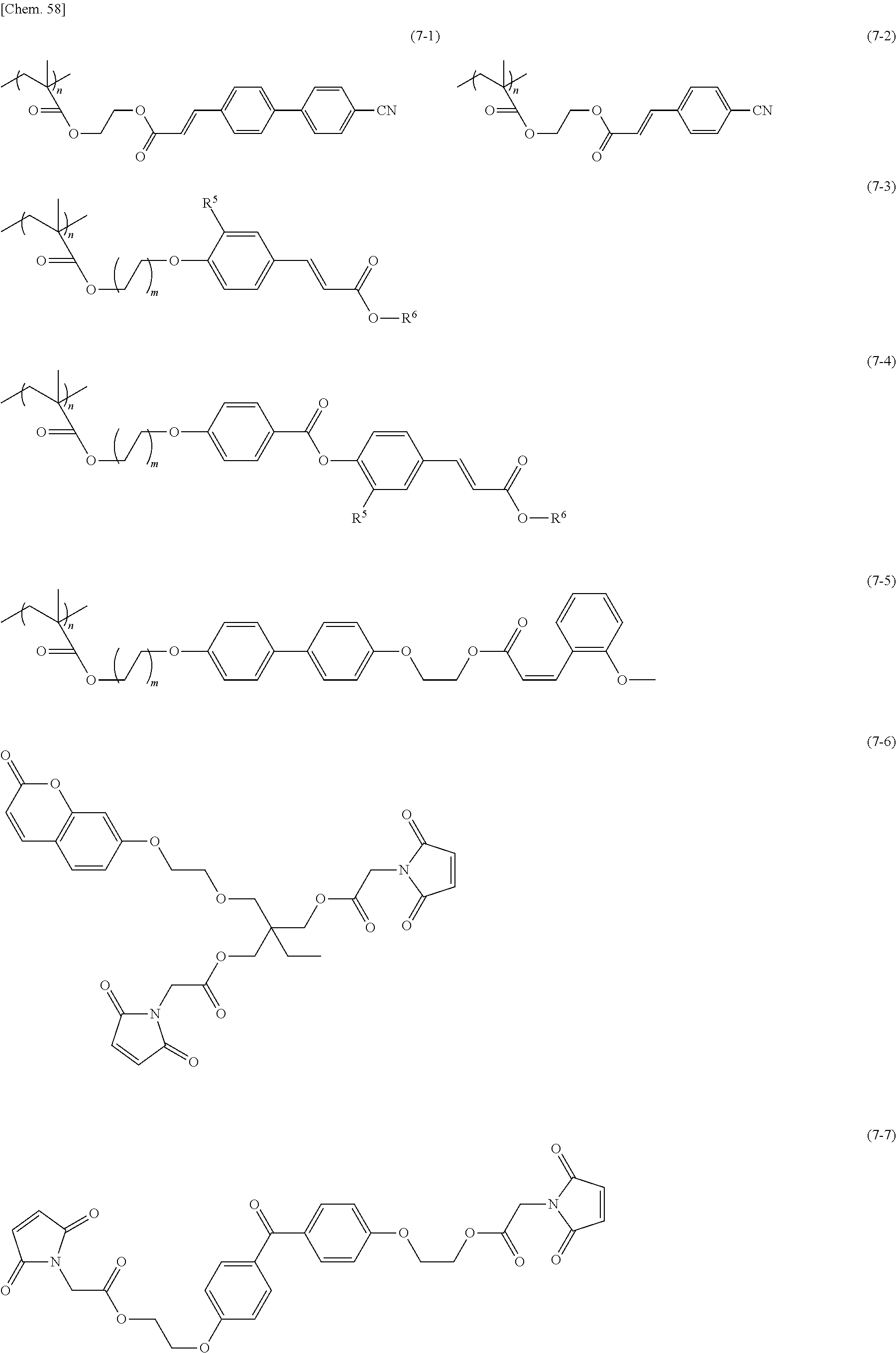

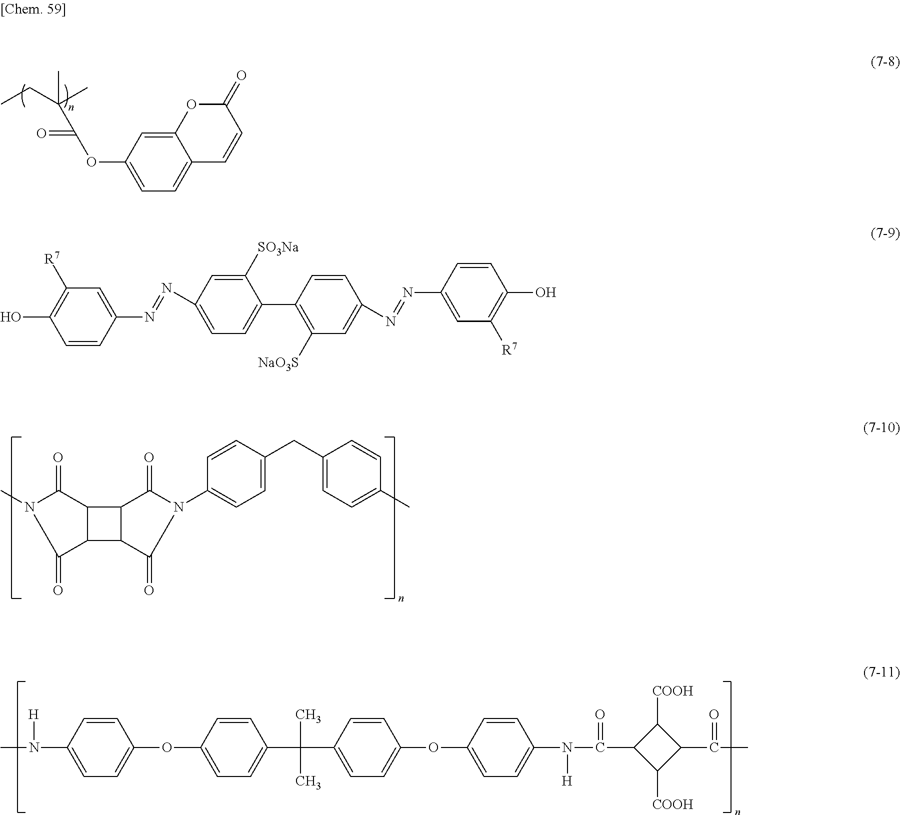

In the formulas, R⁵ represents a hydrogen atom, a halogen atom, an alkyl group having 1 to 3 carbon atoms, an alkoxy group, or a nitro group, R⁶ represents a hydrogen atom or an alkyl group having 1 to 10 carbon atoms, the alkyl group may be linear or branched, an arbitrary hydrogen atom in the alkyl group may be substituted with a fluorine atom, one —CH₂— in the alkyl group or two or more —CH₂— non-adjacent to each other each independently may be substituted with —O—, —S—, —CO—, —COO—, —OCO—, —CO—S—, —S—CO—, —O—CO—O—, —CO—NH—, 1'NH—CO—, or —C═C—, and CH₃ at the terminal may be substituted with CF₃, CCl₃, a cyano group, a nitro group, an isocyano group, or a thioisocyano group, n represents 4 to 100,000 and m represents an integer of 1 to 10.

R⁷ represents a polymerizable functional group selected from the group consisting of a hydrogen atom, a halogen atom, a halogenated alkyl group, an allyloxy group, a cyano group, a nitro group, an alkyl group, a hydroxyalkyl group, an alkoxy group, a carboxy group or alkali metal salts thereof, an alkoxycarbonyl group, a halogenated methoxy group, a hydroxyl group, a sulfonyloxy group or alkali metal salts thereof, an amino group, a carbamoyl group, a sulfamoyl group or a (meta)acryloyl group, a (meta)acryloyloxy group, a (meta)acryloyl amino group, a vinyl group, a vinyloxy group and an maleimide group.

In the alignment film, it is general to form a resin film by applying the alignment film material to the substrate according to a method such as a spin coating method, but a uniaxial drawing method, a Langmuir-Blodgett method, or the like can be used.

(Transparent Electrode)

In the liquid crystal display device of the present invention, as a material for a transparent electrode, conductive metal oxides can be used, and as the metal oxides, indium oxide (In₂O₃), tin oxide (SnO₂), zinc oxide (ZnO), indium tin oxide (In₂O₃—SnO₂), indium zinc oxide (In₂O₃—ZnO), niobium added, titanium dioxide (Ti₁₋ₓNbₓO₂), fluorine-doped tin oxide, graphene nanoribbon, or metal nanowires can be used, and zinc oxide (ZnO), indium tin oxide (In₂O₃—SnO₂), or indium zinc oxide (In₂O₃—ZnO) is preferable. For patterning of this transparent conductive film, a photoetching method or a method for using a mask can be used.

A combination of the liquid crystal display device and a backlight can be used for various purposes such as liquid crystal televisions, monitors of personal computers, mobile phones, displays of smart phones, note-type personal computers, personal digital assistants, and digital sinages. Examples of the backlight include a cold cathode tube type backlight, a 2 wavelength peak pseudo white backlight and a 3 wavelength peak backlight, which uses a light emitting diode using an inorganic material or an organic EL element.

(Backlight)

A configuration of the backlight is not particularly limited. The backlight may use any one of a light guide type or a direct type. The light guide type backlight portion includes a light source and a diffusion board and a direct type backlight portion includes a light source and a diffusion board. The light source to be used is not particularly limited and any of a light bulb, a light emitting diode (LED), and an electroluminescence panel (ELP), one or a plurality of a cold cathode fluorescent lamps (CCFL) and hot cathode fluorescent lamps (CCFL) can be used.

In addition, for the backlight, members such as a reflective plate and a luminance improving film can be used in order to increase efficiency of using light. Further, when the liquid crystal display device is formed, for example, 1 layer or 2 or more layers of the parts such as a diffusion board, a protection board, a prism array, a lens array sheet, and a light diffusion board can be appropriately disposed in addition to the aforementioned members.

(Polarizing Layer)

The liquid crystal display device of the present invention may have a polarizing layer. The polarizing layer is a member having a function of converting natural light to linearly polarized light. The polarizing layer is preferable as long as the layer is a film having: a polarizing function. Examples thereof include a film in which urea or a dichroic pigment is adsorbed to a polyvinyl alcohol-based film and stretched, a film in which a polyvinyl alcohol-based film is stretched and urea, or a dichroic dye or a dichroic pigment is adsorbed thereto, a film in which an aqueous solution containing a dichroic dye is applied to a substrate to form a polarizing layer, and a wire grid polarizer.

As a polyvinyl alcohol-based resin, a resin obtained by gelating a polyvinyl acetate-based resin can be used. Examples of the polyvinyl acetate-based resin include a copolymer of vinyl acetate and another monomer which can be copolymerized with vinyl acetate, in addition to polyvinyl acetate, which is a homopolymer of vinyl acetate. Examples of the another monomer which can be copolymerized with vinyl acetate include unsaturated carboxylic acids, olefins, vinyl ethers, unsaturated sulfonic acids, and acrylamides having an ammonium group. A film forming method of the polyvinyl alcohol-based resin is not particularly limited and a film can be formed according to a well-known method. The thickness of a polyvinyl alcohol-based raw film is not particularly limited and for example, the thickness is about 10 to 150 μm.

In a case where the urea is used as the dichroic pigment, normally, a method is adopted in which a polyvinyl alcohol-based resin is dipped into an aqueous solution containing urea and potassium iodide to dye. In a case where the dichroic dye is used as the dichroic pigment, normally, a method is adopted in which a polyvinyl alcohol-based resin is dipped into an aqueous solution containing a water-soluble dichroic dye to dye.

In a case of a film in which a polarizing layer is formed by applying the aqueous solution containing a dichroic dye to the substrate, the dichroic pigment to be coated differs depending on the type of the base material to be used, and examples thereof include water-soluble dyes such as a direct dye and an acidic dye and amine salts thereof, and non-water soluble pigments such as a disperse dye and an oil-soluble dye. These pigments are normally dissolved in water and an organic solvent, and in some cases, are applied to a base material which has been subjected to rubbing and corona treatments by adding a surfactant. The organic solvent differs depending on solvent resistance, and generally examples thereof include alcohols such as methanol, ethanol, and isopropyl alcohol, cellosolves such as methyl cellosolve and ethyl cellosolve, ketones such as acetone and methyl ethyl ketone, amides such as dimethyl formamide and N-methyl pyrrolidone, and aromatic organic solvents such as benzene and toluene. The coating amount of the pigment differs depending on polarizing performance of the pigment, and generally 0.05 to 1.0 g/rrf and preferably 0.1 to 0.8 g/rrf. As a method for coating a pigment liquid to a base material, various coating methods such as bar coating, spray coating, roll coating, and gravure coating are exemplified.

In a case where a wire grid polarizer is used, a polarizer formed by a conductive material such as Al, Cu, Ag, Cu, M, Cr, and Si is preferably used.

Also, the polarizing layer may further include a film, which is a protective film, if necessary. Examples of the protective film include a polyolefin film such as polyethylene, polypropylene and a norbornene-based polymer, a polyethylene terephthalate film, a polymethacrylate film, a polyacrylate film, a cellulose ester film, a polyethylene naphthalate film, a polycarbonate film, a polysulfone film, a polyether sulfone film, a polyether ketone film, a polyphenylene sulfide film, and a polyphenylene oxide film.

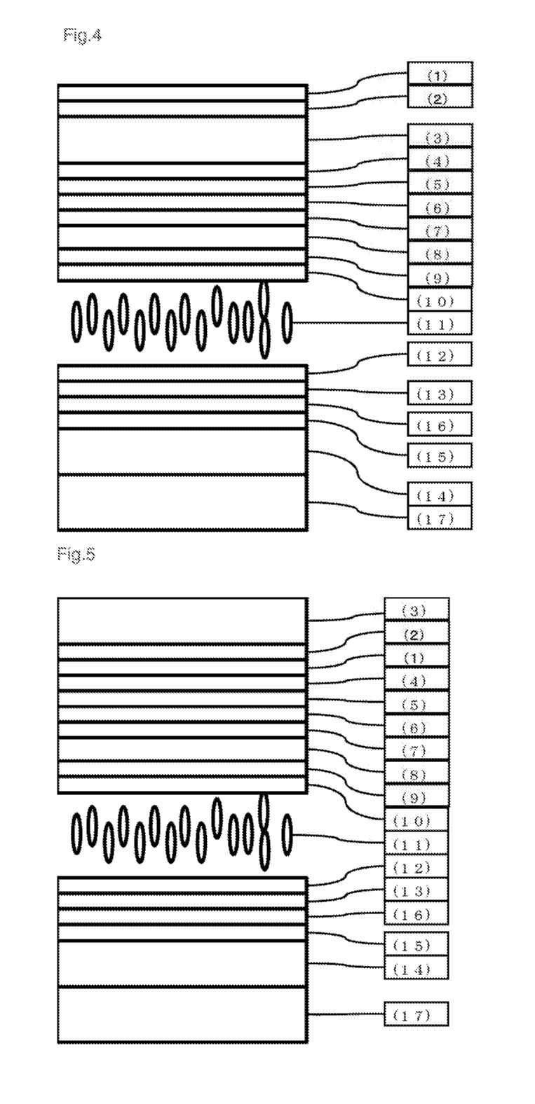

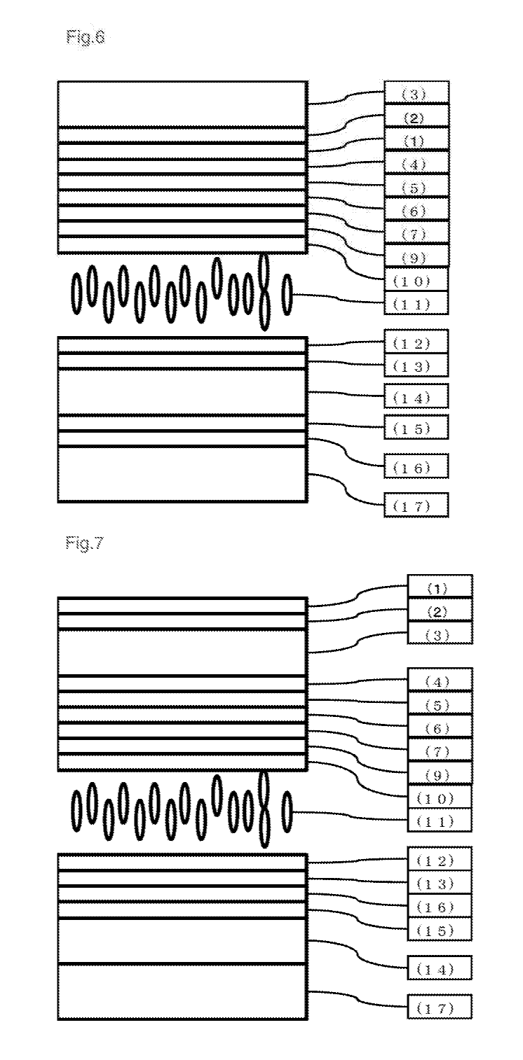

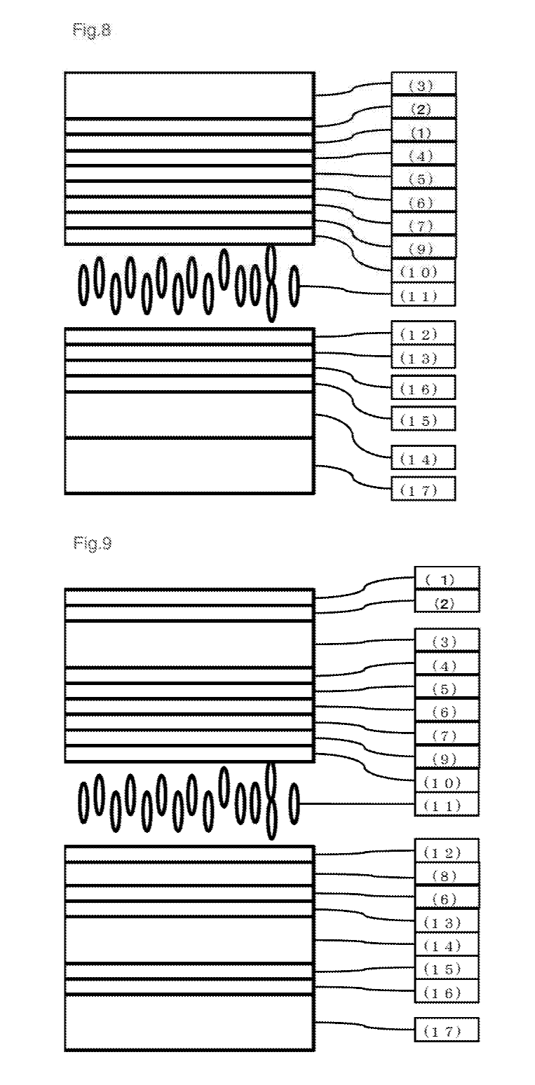

In one embodiment of the present invention, an in-cell polarizing layer, in which a polarizing layer is disposed within a liquid crystal cell, may be provided. One example of the liquid crystal display device of this case is illustrated in FIGS. 3 to 8.

(Adhesive Layer)

An adhesive layer for the attachment to the liquid crystal cell may be provided to an optical member having the aforementioned polarizing layer. The adhesive layer can be provided for the attachment to members other than the liquid crystal cell. An adhesive for forming the adhesive layer is not particularly limited, and for example, an adhesive including an acrylic polymer, a silicone-based polymer, polyester, polyurethane, polyamide, polyether, or a fluorine-based or rubber-based polymer as a base polymer can be appropriately selected to be used. In particular, an adhesive having excellent optical transparency, showing adhesive properties of appropriate wettability, aggregating properties, and adhesiveness, and having excellent weather resistance and heat resistance as the acrylic adhesive can be preferably used. In addition to the above, an adhesive layer having low moisture absorptivity and excellent heat resistance is preferable, from a viewpoint of preventing a foaming phenomenon or peeling phenomenon caused by moisture absorption, preventing a decrease in optical properties caused by a difference in thermal expansion or bending of the liquid crystal cell, and formation of the liquid crystal display device with high quality and excellent durability. Also, the adhesive power of the adhesive layer is preferably 1 N/25 mm or more and more preferably 5 N/25 mm or more, from a viewpoint of workability (reworkability) of fixing and attaching of the polarizing plate. The upper limit is not particularly limited. The adhesive layer may contain an additive to be added to the adhesive layer such as a resin of natural substances or synthesized substances, in particular, a resin for imparting adhesive properties, a glass fiber, glass beads, a metal powder, a filler composed of other inorganic powders, a pigment, a coloring agent, and an antioxidant. Also, the adhesive layer may contain fine particles to show light diffusing properties. The adhesive layer with different compositions or types may be provided on one side or both sides of the polarizing plate or the optical member as a superimposing layer. In a case where the adhesive layer is provided to both sides, the adhesive layer with different compositions, types, or thicknesses can be provided to the front and back of the polarizing plate or the optical member. The thickness of the adhesive layer can be appropriately determined depending on the purpose of the use or adhesive power, and is generally 1 to 500 μm, preferably 5 to 200 μm, and particularly preferably 10 to 100 μm.

(Liquid Crystal Display Device)

The liquid crystal display device is a display element in which a liquid crystal substance fills between optically transparent substrates such as a glass. The liquid crystal display device displays an image such that a molecule alignment of the liquid crystal substance is changed by electric control from a display controller (not illustrated), a polarized, state of the light of the backlight polarized by the polarizing plate disposed on the rear side of the liquid crystal cell, and the light amount transmitting the polarizing plate disposed on the viewing side of the liquid crystal cell is controlled. In the liquid crystal display device of the embodiment, a bar-like liquid crystal molecule having negative dielectric anisotropy is aligned. The liquid crystal cell of the present: invention is characterized to have an “in-cell type retardation film”, in which a retardation film, is included the inside, of the liquid crystal cell, which is pinched by a pair of the optically transparent substrates.

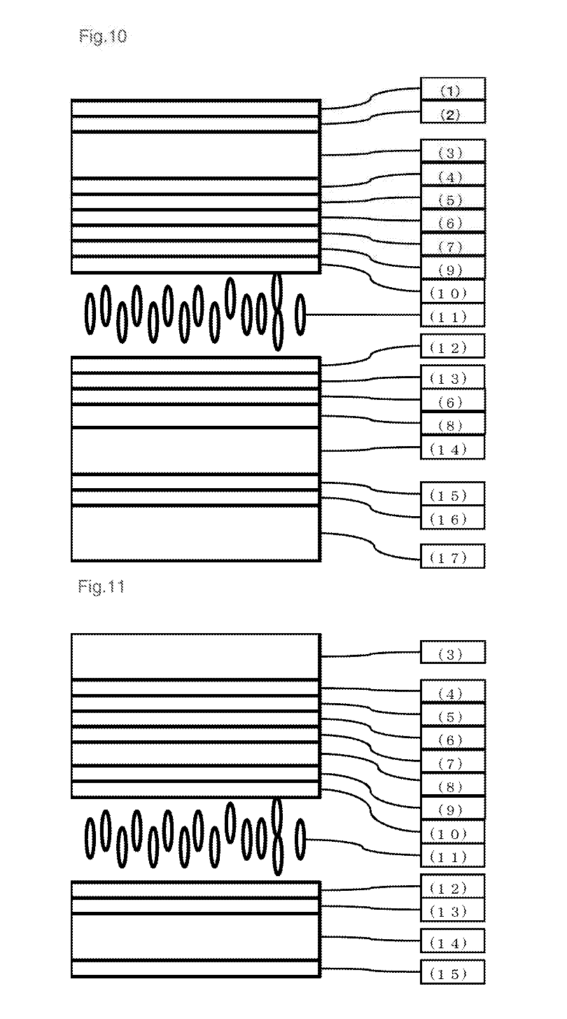

The retardation film disposed in the inside of the liquid crystal cell uses a polymerized optically anisotropic body, in a state where the polymerizable liquid crystal composition is aligned. In addition, the liquid crystal display device shown in FIGS. 1 and 2 is merely one alignment example and the position where the retardation film is provided is not limited to this example. For example, the retardation film may be provided to a desired position, for example, between the electrode and the alignment film on the rear side (FIGS. 9 and 10).

In addition, in the present application, the ring structure, the linking group, and the substituent present in general formulas are respectively independent in each general formula.

### EXAMPLES

Hereinafter, a part of most preferred aspect of the present invention will be described using Examples, but the present invention is not limited to these Examples. In addition, of the composition in the following Examples and Comparative Examples means “% by mass”.

In Examples, measured properties are as follows.

Tₙᵢ: Nematic phase-isotropic liquid phase transition temperature (° C)

Δn: Refractive index anisotropy at a temperature of 25° C.

Δε: Dielectric anisotropy at a temperature of 25° C.

η: Viscosity (mPa·s) at a temperature of 20° C.

γ₁: Rotational viscosity (mPa·s) at a temperature of 25° C.

d_{gap}: Gap of a cell between the first substrate and the second substrate (μm)

VHR: Voltage holding ratio (%) at a temperature of 70° C.

(A value of the ratio of a measured voltage to an initial voltage represented by %, the measured, voltage was measured, at a frame time of 200 ms and a pulse width of 64 μs when, the liquid crystal composition is injected to a cell having a cell thickness of 3.5 μm and a voltage of 5 V is applied.)

ID: Ion density (pC/cm²) at a temperature of 70° C.

(A value of an ion density which was measured at a frequency of 0.05 Hz when the liquid crystal composition is injected to a cell having a cell thickness of 3.5 μm and a voltage of 20 V is applied by MTR-1 (manufactured by TOYO Corporation) )

Burn-in:

Evaluation of burn-in of the liquid, crystal display element was performed such that after a predetermined fixed pattern :was displayed within a display area for 1,000 hours, a residual: image level of the fixed, pattern was visually evaluated according to the following 4 stages, when the fixed pattern was displayed uniformly over the entire screen.

A: No residual image

B: Acceptable level to have an extremely less residual image

C: Unacceptable level to have a residual image

D: Quite deteriorated to have a residual image

The following abbreviations are used for description of the compounds in Examples.

(Side Chain)

n —CₙH₂ₙ₊₁ Linear alkyl group having a carbon atom, of n

n- CₙH₂ₙ₊₁—Linear alkyl group having a carbon atom of n

-On —OCₙH₂ₐ₊₁ Linear alkoxyl group having a carbon atom of n

nO- CₙH₂ₙ₊₁O—Linear alkoxyl group-having a carbon atom of n

-V —CH═CH₂

V- CH₂═CH—

-V1 —CH═CH—CH₃

1V- CH₃—CH═CH—

-2V —CH₂—CH₂—CH═CH₃

V2- CH₃═CH—CH₂—CH₂—

-2V1 —CH₂—CH₂—CH═CH—CH₃

1V2- CH₃—CH═CH—CH₂—CH₂

(Ring Structure)

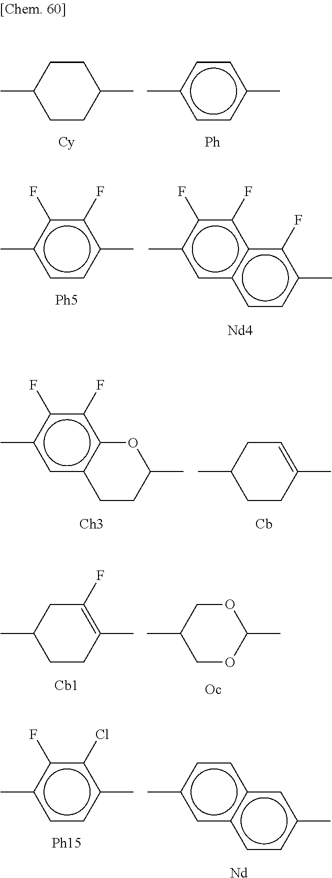

[Preparation of Polymerizable Liquid Crystal Composition]

The polymerizable liquid crystal composition of the present invention used for a retardation film was prepared as follows.

(Preparation of Polymerizable Liquid Crystal Composition 1)

34 parts of a compound (A1), 10 parts of a compound (A2), 28 parts of a compound (B1), 28 parts of a compound (B2), 0.1 parts of a compound (B1), 0.2 parts of a compound (I1), 300 parts of propylene glycol monomethylether acetate (PGMEA) (D1), which is an organic solvent, and a compound (G1) were stirred for 1 hour at a solution temperature of 60° C. and a stirring speed of 500 rpm, using a stirrer having stirring propellers. The resultant, was filtrated by adjusting a filtration pressure to 0.20 MPa using a 0.2 μm (PTFE, film thickness: 60 μm) membrane filter to obtain a polymerizable liquid crystal composition 1 of the present invention.

(Preparation of Polymerizable Liquid Crystal Composition 2)

49 parts of a compound (A1), 11 parts of a compound (A2), 7 parts of a compound (B1), 12 parts of a compound (B2), 10 parts of a compound (B3), 11 parts of a compound (C1), 0.1 parts of a compound (E1), 0.2 parts of a compound (I1), 300 parts of propylene glycol monomethylether acetate (PGMEA) (D1), which is an organic solvent, and a compound (G1) were stirred for 1 hour at a solution temperature of 60° C. and a stirring speed of 500 rpm, using a stirrer having stirring propellers. The resultant, was filtrated by adjusting a filtration pressure to 0.20 MPa using a 0.2 μm (PTFE, film thickness: 60 μm) membrane filter to obtain a polymerizable liquid crystal composition 2 of the present invention.

(Preparation of Polymerizable Liquid Crystal Compositions 3 to 20 and Comparative Polymerizable Liquid Crystal Compositions 1 to 20).

The compounds shown in Tables 1 to 4 were prepared in the same manner as the preparation of the polymerizable liquid crystal compositions 1 and 2 to obtain polymerizable liquid crystal compositions 3 to 24 of the present invention, and comparative polymerizable liquid crystal compositions 1 to 20.

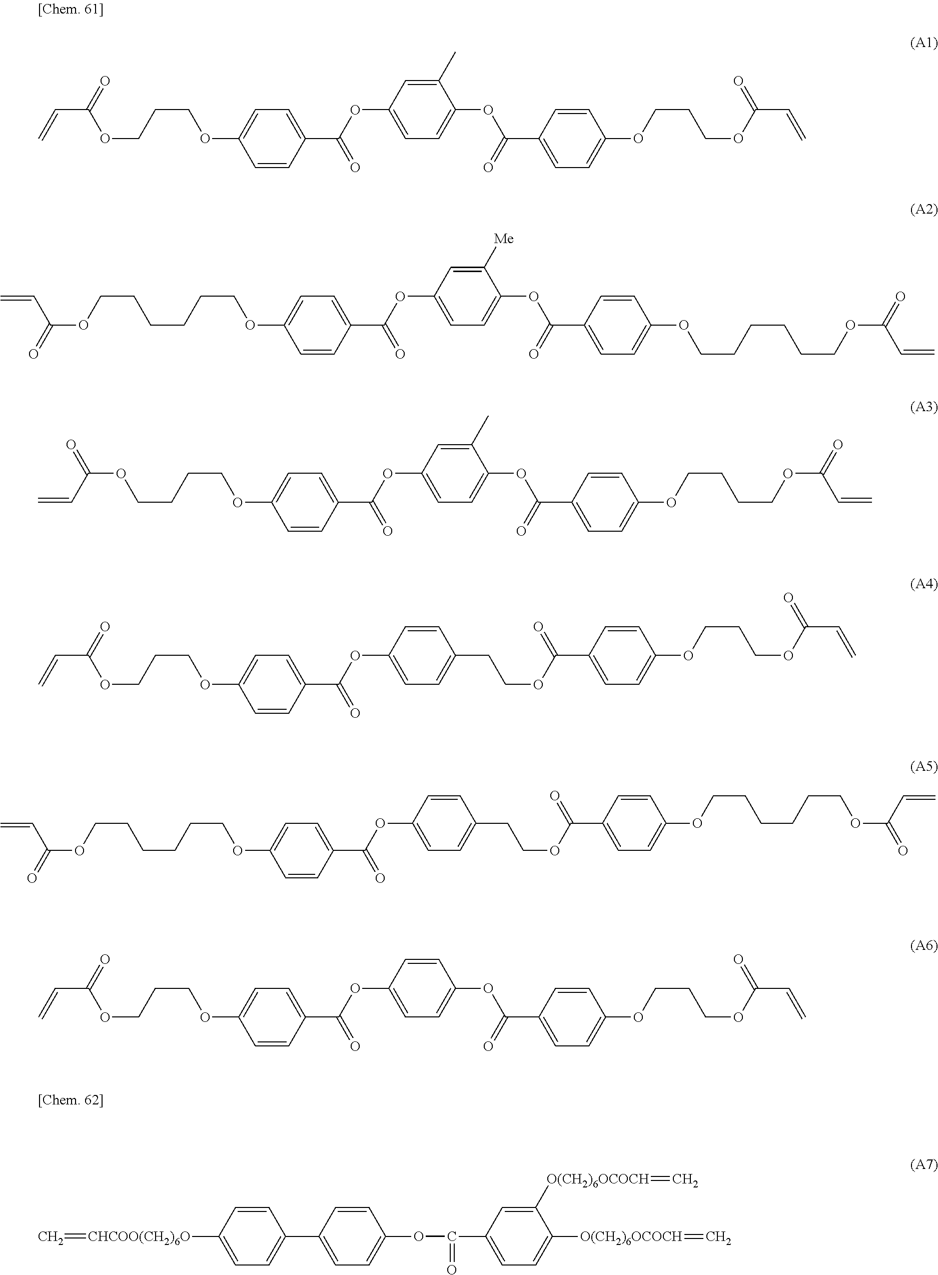

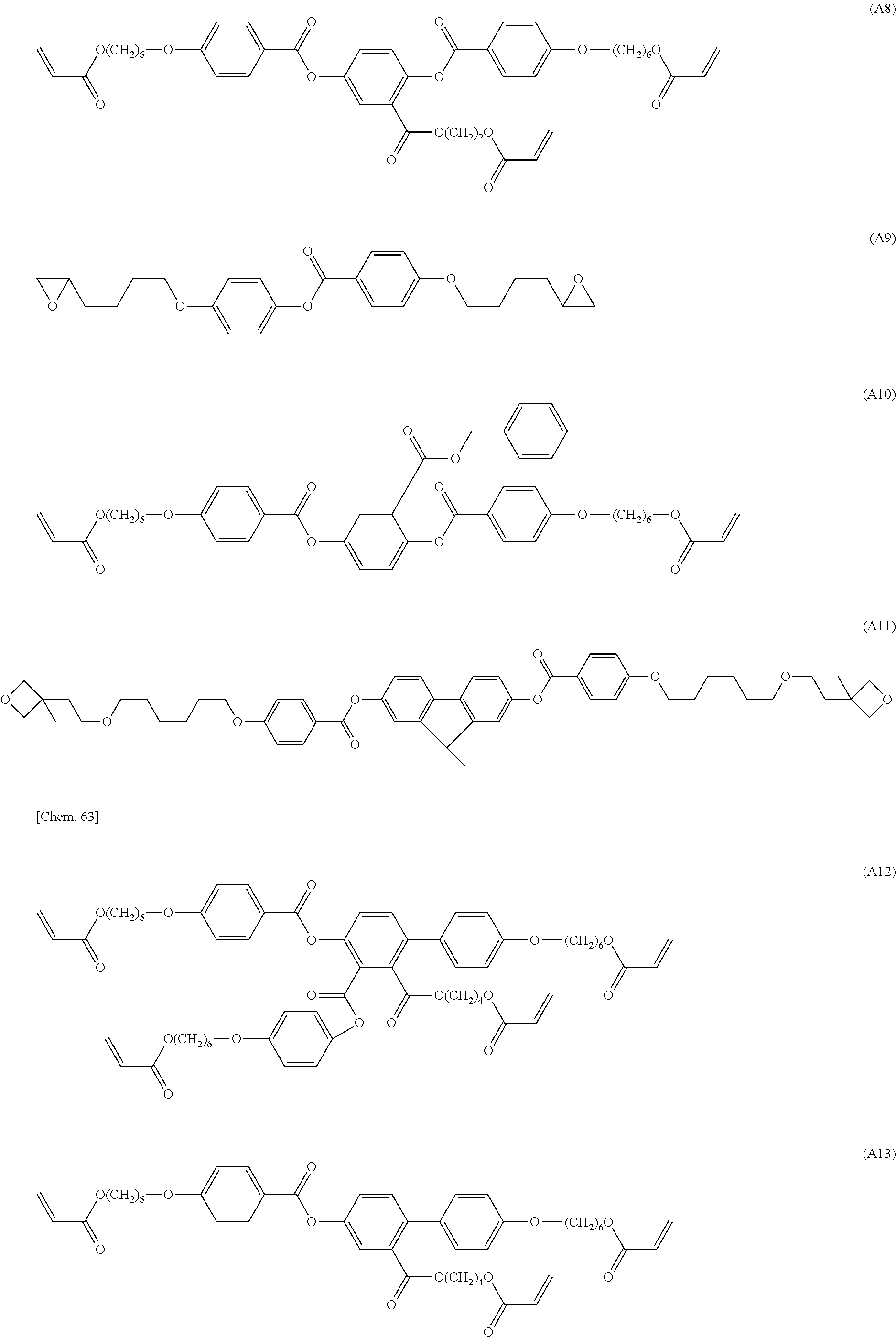

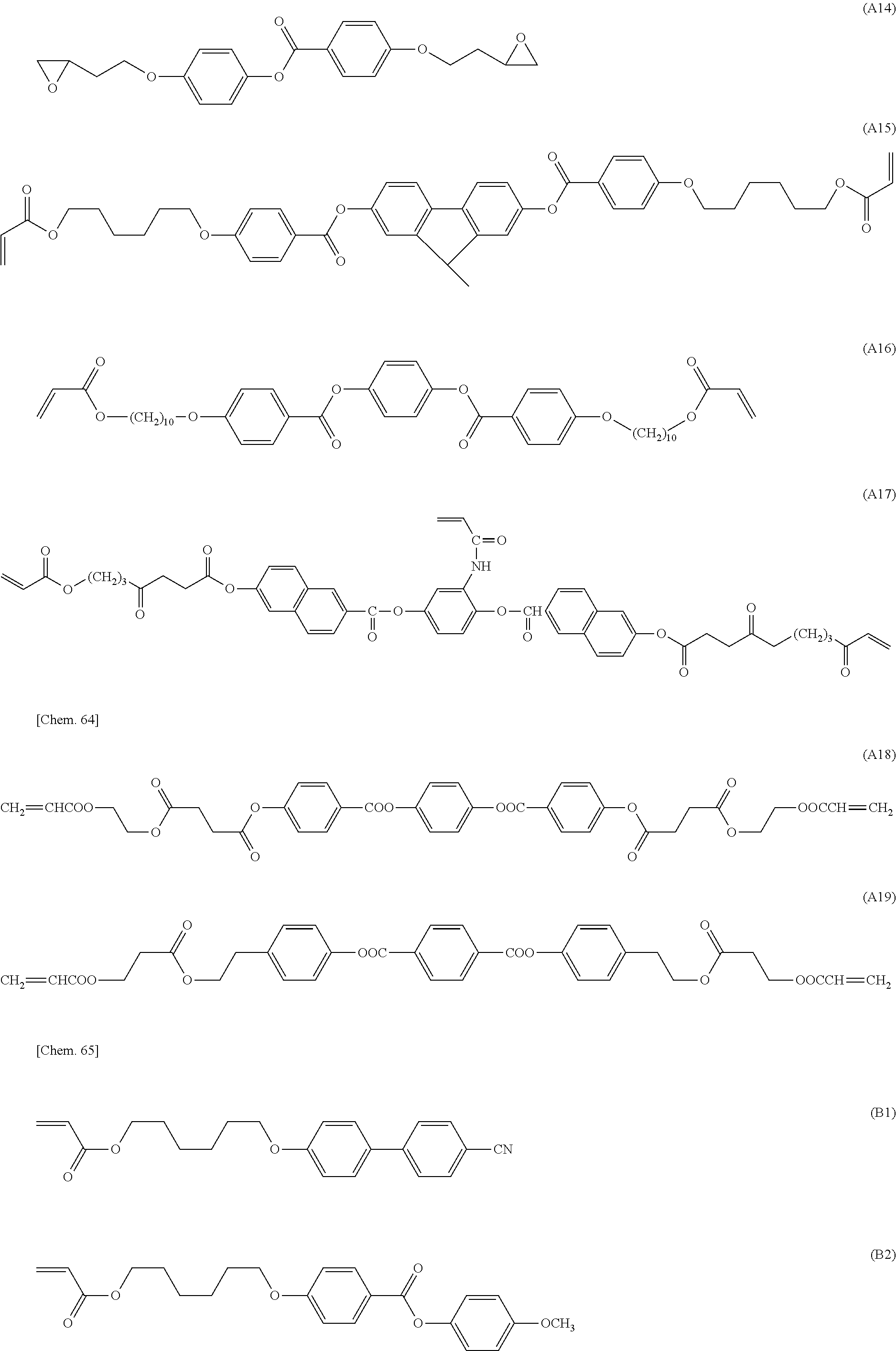

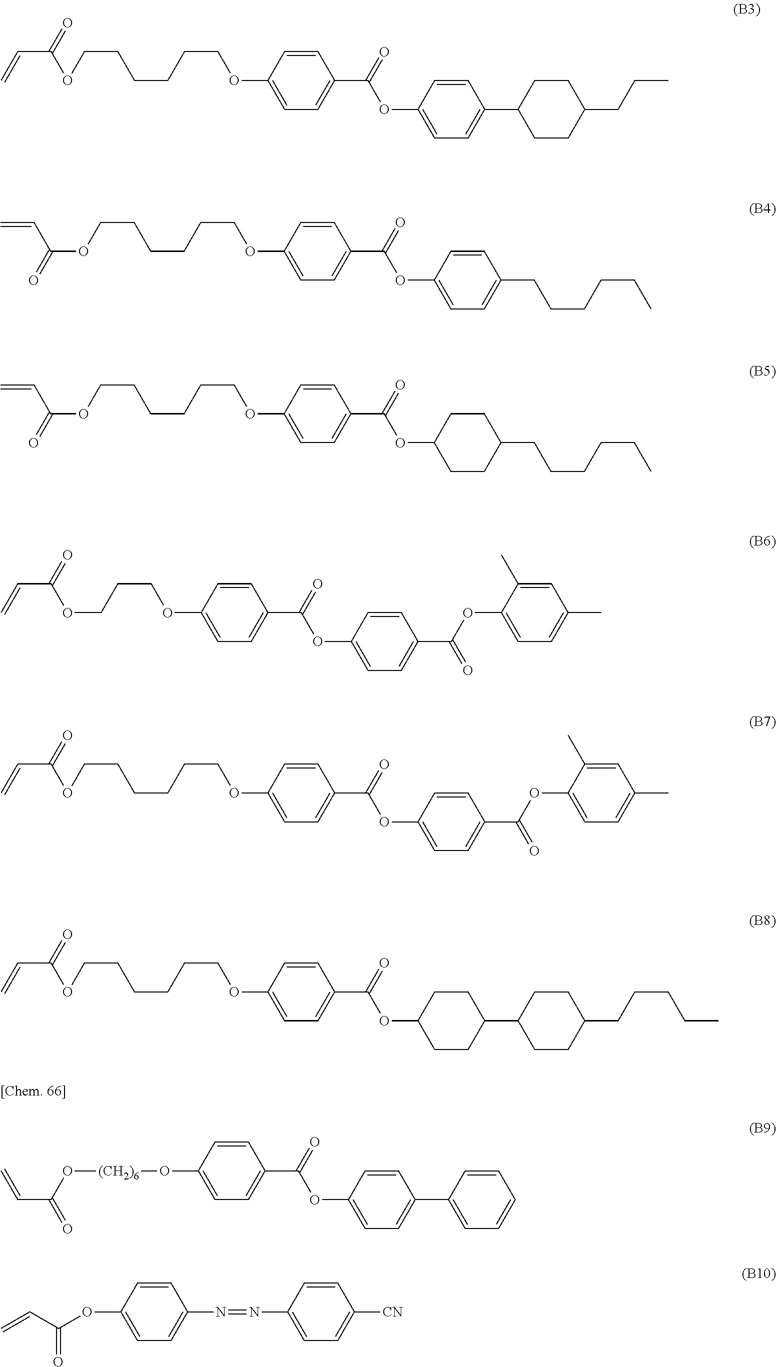

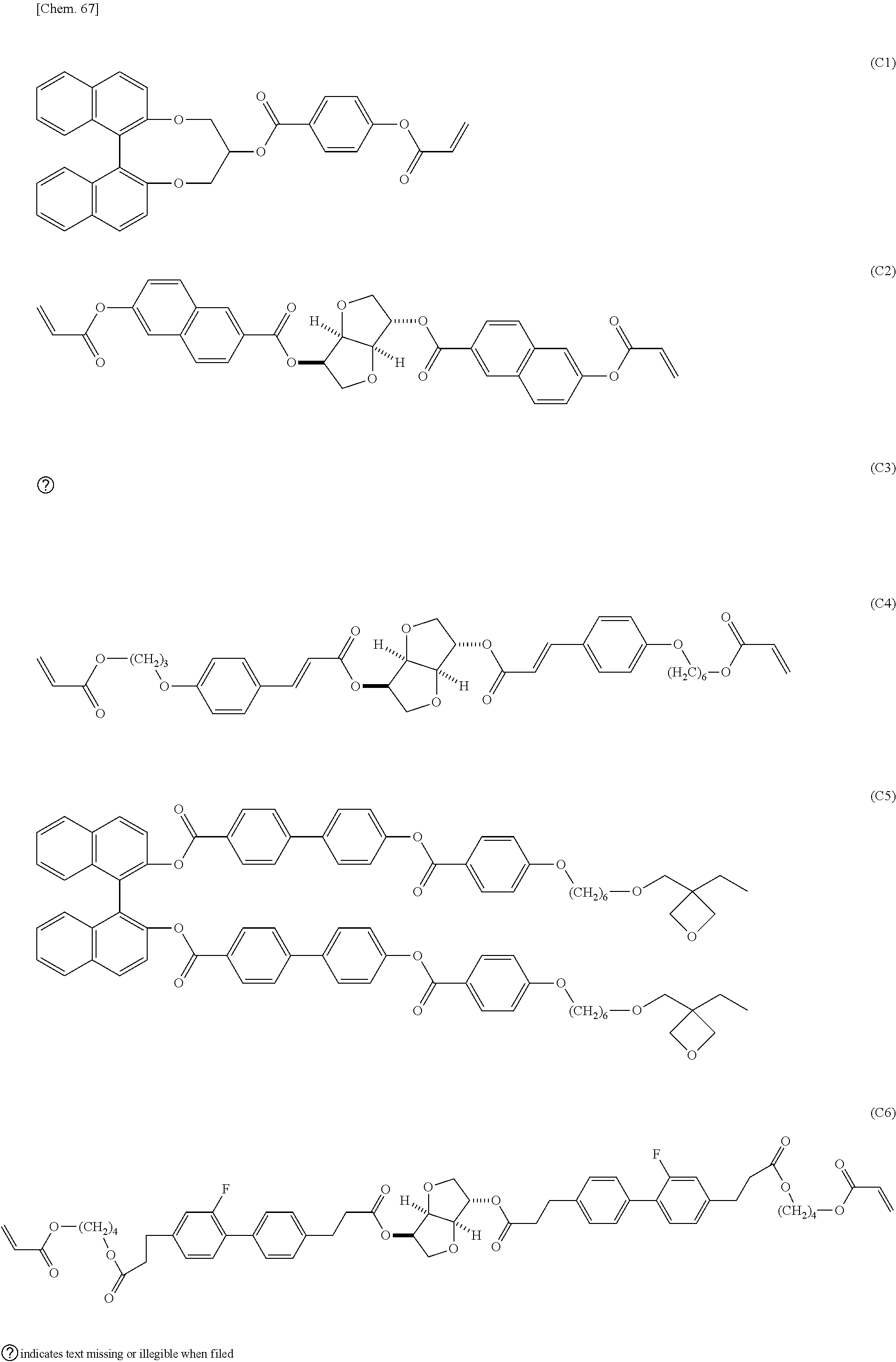

Propylene Glycol Monomethylether Acetate (D1)

p-methoxyphenol (E1)

Irgacure 907 (G1)

Irgacure 651 (G2)

Irgacure 127 (G3)

DTS-102 (G4)

Irgacure 251 (G5)

ANTHRACURE UVS-1331(G6)

Polypropylene (Weight average molecular weight (MW): 1275) (I1)

Fiuidized paraffin (I2)

Megafac F-554 (I3)

FTX-218 (I4)

TABLE 1

| | Polymerizable liquid crystal composition | | | | | | | | | | | | | |
|---|---|---|---|---|---|---|---|---|---|---|---|---|---|---|
| Compound | (1) | (2) | (3) | (4) | (5) | (6) | (7) | (8) | (9) | (10) | (11) | (12) | (13) | (14) |
| (A1) | 34 | | 40 | 11 | 49 | 35 | 20 | 20 | 50 | 39 | 52 | | | |
| (A2) | 10 | 20 | 10 | 19 | 11 | | 30 | | | | | | | |
| (A3) | | | | | | 35 | | 50 | | 30 | 11 | | 60 | |
| (A4) | | | | | | | | 10 | 20 | | | | | |
| (A5) | | | | | | | | 10 | 20 | | | | | |
| (A6) | | | | | | | | 10 | | | | | | |
| (A7) | | | | | | | | | | | | 40 | | |
| (A8) | | | | | | | | | | | | | | 30 |
| (A12) | | | | | | 30 | | | | | | | | |
| (A13) | | | | | | | | | | | | | 20 | |
| (A16) | | | | | | | | | | | | 4 | | |
| (A17) | | | | | | | 20 | | | | | | | |
| (A18) | | 40 | | | | | | | | | | | | |
| (A19) | | 40 | | | | | | | | | | | | |
| (B1) | 28 | | 25 | 26 | 7 | | | | | | 8 | 30 | 20 | |
| (B2) | 28 | | 25 | 27 | 12 | | | | | | 22 | | | |
| (B3) | | | | | 10 | | | | | | | | | |
| (B4) | | | | 8.5 | | | | | | | | | | 35 |
| (B5) | | | | 8.5 | | | | | | | | | | 35 |
| (B6) | | | | | | | | | | | | 18 | | |
| (B7) | | | | | | | | | | 23 | | | | |
| (B10) | | | | | | | 30 | | | | | | | |
| (C1) | | | | | 11 | | | | | | | | | |
| (C2) | | | | | | | | | | 8 | | | | |
| (C3) | | | | | | | | | | | | 8 | | |
| (C4) | | | | | | | | | | | 7 | | | |
| (C6) | | | | | | | | | 10 | | | | | |
| (D1) | 300 | 300 | 300 | 300 | 300 | 300 | | 300 | 300 | 300 | 300 | 300 | 300 | 300 |
| (E1) | 0.1 | 0.1 | 0.1 | 0.1 | 0.1 | 0.1 | 300 | 0.1 | 0.1 | 0.1 | 0.1 | 0.1 | 0.1 | 0.1 |
| (G1) | 5 | 5 | | | 5 | 5 | 0.1 | 5 | 5 | 5 | 5 | 5 | 5 | 5 |
| (G2) | | | 5 | 5 | | | 5 | | | | | | | |
| (I1) | 0.2 | 0.2 | 0.2 | 0.2 | 0.2 | 0.2 | | 0.2 | 0.2 | 0.2 | 0.2 | 0.2 | 0.2 | 0.2 |
| (I2) | | | | | | | | | | | | | | |
| (I3) | | | | | | | 0.2 | | | | | | | |
| (I4) | | | | | | | | | | | | | | |

TABLE 2

| | Polymerizable liquid crystal composition | | | | | | | | | |
|---|---|---|---|---|---|---|---|---|---|---|
| Compound | (15) | (16) | (17) | (18) | (19) | (20) | (21) | (22) | (23) | (24) |
| (A1) | 34 | 52 | | | | 20 | | | | 50 |
| (A2) | 10 | | 30 | | | | | 43 | | 30 |
| (A3) | | 11 | | | | | 30 | | | |
| (A4) | | | 39 | | | | | | | |
| (A6) | | | | 30 | | | | | | |
| (A9) | | | | | | | 50 | | 45 | |
| (A10) | | | | | | | | 34 | | |
| (A11) | | | | | | | | | 45 | |
| (A14) | | | | | 40 | | | | | |
| (A15) | | | | | 40 | 60 | | | | |
| (B1) | 28 | 8 | | 39 | 10 | 10 | 10 | | | 5 |
| (B2) | 10 | 22 | | | | | | | | 15 |
| (B3) | 18 | | | | | | | | | |
| (B8) | | | | | | | | 23 | | |
| (B9) | | | 23 | | | | | | | |
| (B10) | | | | 23 | | | | | | |
| (C1) | | 7 | | | | | | | | |
| (C2) | | | 8 | 5 | | | | | | |
| (C3) | | | | 3 | | | | | | |
| (C5) | | | | | 10 | 10 | 10 | | 10 | |
| (D1) | 300 | 300 | 300 | 300 | 300 | 300 | 300 | 300 | 300 | 300 |
| (E1) | 0.1 | 0.1 | 0.1 | 0.1 | 0.1 | 0.1 | 0.1 | 0.1 | 0.1 | 0.1 |
| (G1) | 5 | 5 | 5 | 5 | 5 | 5 | 5 | 5 | 3 | 5 |
| (G4) | | | | | | | | | 5 | |
| (G5) | | | | | 2 | | 2 | | | |
| (H1) | | | | | 1 | | 1 | | | |
| (I1) | 0.2 | 0.2 | | | | | | | | 0.2 |
| (I2) | | | 0.2 | 0.2 | | | | | | |
| (I3) | | | | | 0.2 | 0.2 | | | | |
| (I4) | | | | | | | 0.2 | 0.2 | | |

TABLE 3

| | Comparative polymerizable liquid crystal composition | | | | | | | | | | | | |
|---|---|---|---|---|---|---|---|---|---|---|---|---|---|
| Compound | (1) | (2) | (3) | (4) | (5) | (6) | (7) | (8) | (9) | (10) | (11) | (12) | (13) |
| (A1) | 10 | | 5 | 4 | 4 | 3 | | | | 3 | 3 | | |
| (A2) | 10 | 6 | 5 | 4 | 4 | | | | | | | | 5 |
| (A3) | | | | | | 3 | 5 | | | | 11 | | |
| (A7) | | | | | | | | | | | | 10 | |
| (A8) | | | | | | | | 4 | | | | | |
| (A9) | | | | | | | | | 3 | | | | |
| (A13) | | | | | | | 5 | | | | | | |
| (A14) | | | | | | | | | 2 | | | | |
| (A15) | | | | | | | | | 1 | 3 | | | |
| (B1) | 40 | | 45 | 30 | 10 | 47 | 90 | | 84 | 84 | | 41 | 40 |
| (B2) | 40 | | 45 | 30 | 40 | 47 | | | | | 40 | 41 | 20. |
| (B3) | | | | | 31 | | | | | | 39 | | 35 |
| (B4) | | 50 | | 16 | | | | 48 | | | | | |
| (B5) | | | | 17 | | | | 48 | | | | | |
| (B6) | | 44 | | | | | | | | | | | |
| (C1) | | | | | 11 | | | | | | | | |
| (C2) | | | | | | | | | | | | 8 | |
| (C4) | | | | | | | | | | | 7 | | |
| (C5) | | | | | | | | | 10 | 10 | | | |
| (D1) | 300 | 300 | 300 | 300 | 300 | 300 | 300 | 300 | 300 | 300 | 300 | 300 | 300 |
| (E1) | 0.1 | 0.1 | 0.1 | 0.1 | 0.1 | 0.1 | 0.1 | 0.1 | 0.1 | 0.1 | 0.1 | 0.1 | 0.1 |
| (G1) | 5 | 5 | | | 5 | 5 | 5 | 5 | 5 | 5 | 5 | 5 | 5 |
| (G2) | | | 5 | 5 | | | | | | | | | |
| (G5) | | | | | | | | | 2 | | | | |
| (H1) | | | | | | | | | 1 | | | | |
| (I1) | 0.1 | 0.1 | 0.1 | 0.1 | 0.1 | 0.1 | 0.2 | 0.2 | | | 0.1 | 0.2 | 0.1 |
| (I3) | | | | | | | | | 0.2 | 0.2 | | | |

TABLE 4

| | Comparative polymerizable liquid crystal composition | | | | | |
|---|---|---|---|---|---|---|
| Compound | (15) | (16) | (17) | (18) | (19) | (20) |
| (A1) | 4 | 3 | 4 | | | |
| (A2) | 4 | | | | | |
| (A3) | | 3 | | | 10 | |
| (A6) | | | | 3 | | |
| (A10) | | | | | 5 | |
| (A11) | | | | | | 5 |
| (B1) | 60 | | | | 62 | |
| (B2) | 14 | 87 | | | | |
| (B3) | 18 | | | | | |
| (B5) | | | | | | 50 |
| (B6) | | | | | | 40 |
| (B7) | | | 88 | 89 | | |
| (B8) | | | | | 23 | |
| (C1) | | 7 | | | | |
| (C2) | | | 8 | 5 | | |
| (C3) | | | | 3 | | |
| (C5) | | | | | | 5 |
| (D1) | 300 | 300 | 300 | 300 | 300 | 300 |
| (E1) | 0.1 | 0.1 | 0.1 | 0.1 | 0.1 | 0.1 |
| (G1) | 5 | 5 | 5 | 5 | 5 | 3 |
| (G4) | | | | | | 5 |
| (I1) | 0.2 | 0.2 | | | | |
| (I3) | | | 0.2 | 0.2 | | |
| (I4) | | | | | 0.2 | |

(Preparation of Photo-Alignment Agent Composition 1 for Retardation Film)

A compound (monomer) represented by the following Formula (J) was synthesized in the same manner as the method disclosed in Example 1 and Example 2 of JP-A-2013-33248.

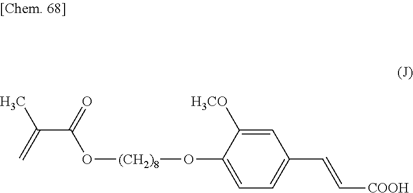

2.0 g of a monomer (J), 16.8 mg of azobisisobutyronitrile, and 20.2 mL of tetrahydrofuran were mixed in a flask and stirred for 8 hours at a temperature of 60° C. under nitrogen atmosphere. Then, hexane in the amount of 5 times the amount of the used monomer (5 mL per 1 g of a monomer) was added thereto to precipitate the reacted mixture, and a supernatant liquid was removed by decantation. The reacted mixture was dissolved again in tetrahydrofuran in the amount of 3 times the amount of the used monomer (3 mL per 1 g of a monomer), hexane in the amount of 5 times the amount of the used monomer (5 mL per 1g of a monomer) was added thereto to precipitate the reacted mixture, and a supernatant liquid was removed by decantation. After the operation of redissolving in tetrahydrofuran, precipitating by hexane, and decantation in this order was further performed 3 times, the obtained, reacted mixture was depressurized and dried at a tempera tare of 20° C. under the light being shielded to obtain 1.71 a of a polymer represented by the following Formula (K).

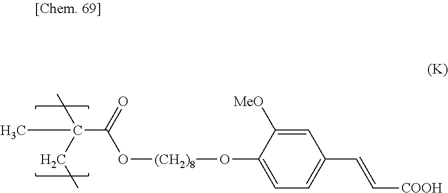

The weight average molecular weight Mw of the polymer, of Formula (K) was 50,352. A mixture of 2 parts by mass of the photo-alignment agent. (K) and 98 parts by mass of PGME was stirred for 10 minutes at room temperature. Each polymer solution obtained by uniformly dissolving the polymer in the respective solvents was filtrated using a 1 μm membrane filter to obtain a photo-alignment agent composition for a retardation film 1.

(Preparation of Photo-Alignment Agent Composition for a Retardation Film 2)

A photo-alignment agent, composition for a retardation film 2 was prepared according to the method disclosed in Synthesis Examples 1 to 5 of WO 2012/053290. That is, 100.0 g of 2-(3,4-epoxycyclohexyl)ethyl trimethoxysilane (ECETS), 500 g of methyl isobutyl ketone, and 10.0 g of triethylamine were put into a reactor vessel equipped with a stirrer, a thermometer, a dropping funnel, and a reflux condenser and mixed to each other at room temperature. Subsequently, 100 g of deionized water was added dropwise thereto for 30 minutes by a dropping funnel and then the resultant was reacted to each other for 6 hours at a temperature of 80° C. while being mixed to each other under reflux. After the reaction was completed, an organic layer was taken out, the resultant was washed until water after being washed with 0.2% by mass of an ammonium nitrate aqueous solution becomes neutralized, and then the solvent and water were removed by distillation under reduced pressure to obtain polyorganosiloxane having an epoxy group as a viscous transparent liquid. The weight average molecular weight Mw of the obtained polyorganosiloxane having an epoxy group was 2,200 and an epoxy equivalent was 186 g/mol.

Subsequently, the entire synthesis reactions of the specific cinnamic acid derivatives were performed under inert atmosphere 20 g of 4-bromodiphenyl ether, 0.18 g of palladium acetate, 0.98 g of tris(2-tolyl)phosphine, 32.4 g of triethylamine, and 135 mL of dimethylacetamide were mixed in a 500 mL three-necked flask equipped with a cooling tube. Next, acrylic acid was added to 7 g of a mixed solution by a syringe and stirred. This mixed solution was further heated for 3 hours at a temperature of 120° C. and stirred. After the completion of the reaction was confirmed by TLC (Thin Layer Chromatography), the reacted solution was cooled down to room temperature. After the precipitate was filtrated, the filtrate was poured into 300 mL of 1N hydrochloric acid aqueous solution to collect the precipitate. This precipitate was crystallized again in a solution of ethyl acetate and hexane (1:1 by mass ratio) to obtain 8.4 g of a compound represented by the following Formula (L) (specific cinnamic acid derivatives).

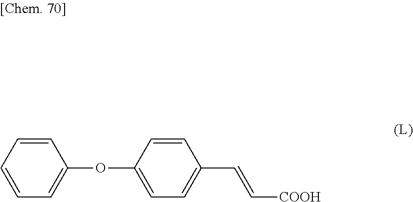 [SMILES: O=C(O)/C=C/c1ccc(Oc2ccccc2)cc1]

Further, 9.3 g of polyorganosiloxane having an epoxy group, 26 g of methyl isobutyl ketone, 3 g of specific cinnamic acid derivatives (L), and 0.10 g of quaternary amine salts (San-Apro Ltd., UCAT 18X) were put into a 100 mL three-necked flask, and stirred for 12 hours at a temperature of 80° C. After the reaction was completed, the resultant was precipitated again by methanol, and the precipitate was dissolved in ethyl acetate to obtain a solution. After this solution was washed 3 times, the solvent was removed by distillation to obtain 6.3 g of photo-aligning polyorganosiloxane (M) as a white powder.

The weight average molecular weight Mw of the photo-aligning polyorganosiloxane (M) was 3,500.

In addition, 19.61 g of cyclobutane tetracarboxylic acid dianhydride (0.1 mol) and 21.23 g of

4,4′-diamino-2,2′-dimethyl biphenyl (0.1 mol) were dissolved in 367.6 g of NMP and reacted to each other for 6 hours at room temperature. Subsequently, the reacted mixture was poured into a largely excessive methanol to cause a reacted product, to be precipitated. The precipitate was washed with methanol and dried for 15 hours at a temperature of 40° C. under reduced pressure to obtain 35 g of polyamic acid.

A solution containing polyamic acid was taken in the amount, corresponding to 1,000 parts by mass in terms of polyamic acid contained in this solution, 100 parts by mass of photo-aligning polyorganosiloxane (M) was added thereto, and further NMP and ethylene glycol monobutyl ether (EGMB) were mixed therein to obtain a solution of which a solvent composition is NMP:EGMB=50:50 (mass ratio), and a solid content is 4.0% by mass. This solution was filtrated by a membrane filter having a pore diameter of 1 μm to obtain a photo-alignment agent composition for a retardation film 2.

(Preparation of Photo-Alignment Agent Composition for a Retardation Film 3)

A photo-alignment agent composition for a retardation film 3 was prepared according to the other method disclosed in Synthesis Example 1 of WO 2011/126021. That is, 17.5 g of cyclohexanone was added to 0.46 g of 4-(6-hydroxyhexyloxy)cinnamic acid methyl ester, 1.37 g of a methoxylated methylolmelamine formaldehyde resin (Mn:511), 0.55 g of hexamethoxymethyl melamine, and 0.02 g of p-toluenesulfonic acid monohydrate to prepare a solution. This solution was filtrated by a membrane filter having a pore diameter of 1 μm to obtain a photo-alignment agent composition for a retardation film 3.

### Examples 1 to 4

After a color filter layer (4) was attached to a first optically transparent substrate (3), a horizontal alignment film (6) was formed and a rubbing treatment was weakly performed. The polymerizable liquid crystal composition I was applied on the horizontal alignment film (6) which has been rubbed by a spin coater, dried for 2 minutes at a temperature of 80° C., and cooled at room temperature, and then the composition was irradiated with an ultraviolet ray of 500 mJ/cm² using a high pressure mercury lamp to fabricate a first retardation film (7) of a positive A plate. The polymerizable liquid crystal composition 2 was applied to this retardation film by a spin coater, dried for 2 minutes at a temperature of 80° C., and cooled at room temperature, and then the composition was irradiated with, an ultraviolet ray of 500 mJ/cm² using a high pressure mercury lamp to fabricate a second retardation film (8) of a negative C plate. A transparent electrode layer (9) was vapor-deposited on the first retardation film (7) and the second retardation film (8) to form an alignment film (10). After a pixel electrode layer (13) was attached to a second optically transparent substrate (14) to form an alignment film (12) and then a rubbing treatment was weakly performed. The following liquid crystal composition 1 was injected to a liquid crystal layer (11) between the alignment film layers (10) and (12) to fabricate a liquid crystal display device of a VA mode of Example 1. FIG. 11 illustrates a liquid crystal display device of Example 1.

In addition, liquid crystal display devices of Examples 2 to 4 were fabricated in the same manner as in Example 1 except that the polymerizable liquid crystal composition shown below was used.

The VHR and ID of the obtained liquid crystal display device were measured. Also, the burn-in of the obtained liquid crystal display devices was evaluated. The results are shown in the following tables.

TABLE 5
Liquid crystal composition 1

| | |
|---|---|
| T_{NI}/° C. | 81.0 |
| Δn | 0.103 |
| Δε | −2.9 |
| η/mPa · s | 20.3 |
| γ₁/mPa · s | 112 |
| γ₁/Δn² × 10⁻² | 105 |
| 3-Cy-Cy-2 | 24% |
| 3-Cy-Cy-4 | 10% |
| 3-Cy-Cy-5 | 5% |
| 3-Cy-Ph—O1 | 2% |
| 3-Cy-Ph5—O2 | 13% |
| 2-Cy-Ph—Ph5—O2 | 9% |
| 3-Cy-Ph—Ph5—O2 | 9% |
| 3-Cy-Cy-Ph5—O3 | 5% |
| 4-Cy-Cy-Ph5—O2 | 6% |
| 5-Cy-Cy-Ph5—O2 | 5% |
| 3-Ph—Ph5—Ph-2 | 6% |
| 4-Ph—Ph5—Ph-2 | 6% |

TABLE 6

| | Example 1 | Example 2 | Example 3 | Example 4 |
|---|---|---|---|---|
| Liquid crystal | Liquid crystal | Liquid crystal | Liquid crystal | Liquid crystal |
| composition | composition 1 | composition 1 | composition 1 | composition 1 |
| Polymerizable | Polymerizable | Polymerizable | Polymerizable | Polymerizable |
| liquid crystal | liquid crystal | liquid crystal | liquid crystal | liquid crystal |
| composition of | composition 1 | composition 2 | composition 3 | composition 4 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 5 | composition 9 | composition 5 | composition 5 |
| the second | | | | |
| retardation film | | | | |
| VHR | 99.3 | 99.5 | 99.2 | 99.0 |
| ID | 37 | 20 | 46 | 66 |
| Burn-in | A | A | A | A |

It is understood that the liquid crystal composition 1 has a liquid crystal layer temperature range of 81° C., which is practical as a liquid crystal composition for a TV, a large absolute value of dielectric anisotropy, and low viscosity and optimal Δn.

In the liquid crystal display devices of Examples 1 to 4, the high VHR and low ID were realized. Also, it is not recognized that a residual image was generated even in the evaluation of burn-in.

### Examples 5 to 12

Liquid crystal display devices of Examples 5 to 12 were fabricated in the same manner as in Example 1 except that the liquid crystal composition and the polymerizable liquid crystal composition shown below were used, and the VHR and ID were measured. Also, the burn-in of the obtained liquid crystal display devices was evaluated. The results are shown in the following tables.

TABLE 7
Liquid crystal composition 2

| | |
|---|---|
| T_{NI}/° C. | 76.0 |
| Δn | 0.103 |
| Δε | −2.9 |
| η/mPa · s | 19.8 |
| γ₁/mPa · s | 110 |
| γ₁/Δn² × 10⁻² | 103 |
| 3-Cy-Cy-2 | 24% |
| 3-Cy-Cy-4 | 10% |
| 3-Cy-Ph—O1 | 7% |
| 3-Cy-Ph5—O2 | 14% |
| 2-Cy-Ph—Ph5—O2 | 7% |
| 3-Cy-Ph—Ph5—O2 | 9% |
| 3-Cy-Cy-Ph5—O3 | 5% |
| 4-Cy-Cy-Ph5—O2 | 7% |
| 5-Cy-Cy-Ph5—O2 | 5% |
| 3-Ph—Ph5—Ph-2 | 6% |
| 4-Ph—Ph5—Ph-2 | 6% |

Liquid crystal composition 3

| | |
|---|---|
| T_{NI}/° C. | 84.8 |
| Δn | 0.103 |
| Δε | −2.9 |
| η/mPa · s | 21.4 |
| γ₁/mPa · s | 119 |
| γ₁/Δn² × 10⁻² | 112 |
| 3-Cy-Cy-2 | 24% |
| 3-Cy-Cy-4 | 11% |
| 3-Cy-Ph5—O2 | 12% |
| 2-Cy-Ph—Ph5—O2 | 5% |
| 3-Cy-Ph—Ph5—O2 | 6% |
| 3-Cy-Cy-Ph5—O3 | 8% |
| 4-Cy-Cy-Ph5—O2 | 8% |
| 5-Cy-Cy-Ph5—O2 | 8% |
| 3-Ph—Ph5—Ph-2 | 6% |
| 4-Ph—Ph5—Ph-2 | 6% |
| 5-Ph—Ph-1 | 3% |
| 3-Cy-Cy-Ph-1 | 3% |

TABLE 8

| | Example 5 | Example 6 | Example 7 | Example 8 |
|---|---|---|---|---|
| Liquid crystal | Liquid crystal | Liquid crystal | Liquid crystal | Liquid crystal |
| composition | composition 2 | composition 2 | composition 2 | composition 2 |
| Polymerizable | Polymerizable | Polymerizable | Polymerizable | Polymerizable |
| liquid crystal | liquid crystal | liquid crystal | liquid crystal | liquid crystal |
| composition of | composition 1 | composition 2 | composition 3 | composition 4 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 5 | composition 9 | composition 5 | composition 5 |
| the second | | | | |
| retardation film | | | | |
| VHR | 99.5 | 99.6 | 99.3 | 99.1 |
| ID | 25 | 19 | 42 | 66 |
| Burn-in | A | A | A | B |

TABLE 9

| | Example 9 | Example 10 | Example 11 | Example 12 |
|---|---|---|---|---|
| Liquid crystal | Liquid crystal | Liquid crystal | Liquid crystal | Liquid crystal |
| composition | composition 3 | composition 3 | composition 3 | composition 3 |
| Polymerizable | Polymerizable | Polymerizable | Polymerizable | Polymerizable |
| liquid crystal | liquid crystal | liquid crystal | liquid crystal | liquid crystal |
| composition of | composition 1 | composition 2 | composition 3 | composition 4 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 5 | composition 9 | composition 5 | composition 5 |
| the second | | | | |
| retardation film | | | | |
| VHR | 99.4 | 99.6 | 99.2 | 99.0 |
| ID | 33 | 24 | 45 | 68 |
| Burn-in | A | A | A | B |

In the liquid crystal display devices of Examples 5 to 12, the high VHR and low IB were realized. Also, the residual image was not generated even in the evaluation of burn-in or, the residual image was generated extremely less, which was an acceptable level, even if the residual image was generated.

### Examples 13 to 24

Liquid crystal display devices of Examples 13 to 24 were fabricated in the same manner as in Example 1 except that the liquid crystal composition and the polymerizable liquid crystal composition shown below were used, and the VHR and ID were measured. Also, the burn-in of the obtained liquid crystal display devices was evaluated. The results are shown in the following tables.

TABLE 10
Liquid crystal composition 4

| | |
|---|---|
| T_{NI}/° C. | 74.9 |
| Δn | 0.102 |
| Δε | −2.9 |
| η/mPa · s | 21.1 |
| γ₁/mPa · s | 116 |
| γ₁/Δn² × 10⁻² | 111 |
| 3-Cy-Cy-2 | 22% |
| 3-Cy-Cy-4 | 11% |
| 3-Cy-Ph5—O2 | 7% |
| 3-Cy-Ph5—O4 | 8% |
| 2-Cy-Ph—Ph5—O2 | 6% |
| 3-Cy-Ph—Ph5—O2 | 7% |
| 3-Cy-Cy-Ph5—O3 | 7% |
| 4-Cy-Cy-Ph5—O2 | 7% |
| 5-Cy-Cy-Ph5—O2 | 7% |
| 3-Ph—Ph5—Ph-2 | 4% |
| 4-Ph—Ph5—Ph-2 | 4% |
| 5-Ph—Ph-1 | 8% |
| 3-Cy-Cy-Ph-1 | 2% |

Liquid crystal composition 5

| | |
|---|---|
| T_{NI}/° C. | 80.2 |
| Δn | 0.105 |
| Δε | −2.9 |
| η/mPa · s | 22.7 |
| γ₁/mPa · s | 124 |
| γ₁/Δn² × 10⁻² | 112 |
| 3-Cy-Cy-2 | 20% |
| 3-Cy-Cy-4 | 10% |
| 3-Cy-Ph5—O2 | 7% |
| 3-Cy-Ph5—O4 | 7% |
| 2-Cy-Ph—Ph5—O2 | 6% |
| 3-Cy-Ph—Ph5—O2 | 7% |
| 3-Cy-Cy-Ph5—O3 | 7% |
| 4-Cy-Cy-Ph5—O2 | 8% |
| 5-Cy-Cy-Ph5—O2 | 7% |
| 3-Ph—Ph5—Ph-2 | 4% |
| 4-Ph—Ph5—Ph-2 | 4% |
| 5-Ph—Ph-1 | 8% |
| 3-Cy-Cy-Ph-1 | 5% |

Liquid crystal composition 6

| | |
|---|---|
| T_{NI}/° C. | 85.7 |
| Δn | 0.104 |
| Δε | −3.0 |
| η/mPa · s | 22.9 |
| γ₁/mPa · s | 126 |
| γ₁/Δn² × 10⁻² | 116 |
| 3-Cy-Cy-2 | 20% |
| 3-Cy-Cy-4 | 10% |
| 3-Cy-Ph5—O2 | 7% |
| 3-Cy-Ph5—O4 | 7% |
| 2-Cy-Ph—Ph5—O2 | 6% |
| 3-Cy-Ph—Ph5—O2 | 7% |
| 3-Cy-Cy-Ph5—O3 | 7% |
| 4-Cy-Cy-Ph5—O2 | 8% |
| 5-Cy-Cy-Ph5—O2 | 7% |
| 3-Ph—Ph5—Ph-2 | 4% |
| 4-Ph—Ph5—Ph-2 | 4% |
| 5-Ph—Ph-1 | 5% |
| 3-Cy-Cy-Ph-1 | 8% |

TABLE 11

| | Example 13 | Example 14 | Example 15 | Example 16 |
|---|---|---|---|---|
| Liquid crystal | Liquid crystal | Liquid crystal | Liquid crystal | Liquid crystal |
| composition | composition 4 | composition 4 | composition 4 | composition 4 |
| Polymerizable | Polymerizable | Polymerizable | Polymerizable | Polymerizable |
| liquid crystal | liquid crystal | liquid crystal | liquid crystal | liquid crystal |
| composition of | composition 1 | composition 2 | composition 3 | composition 4 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 5 | composition 9 | composition 5 | composition 5 |
| the second | | | | |
| retardation film | | | | |
| VHR | 99.4 | 99.5 | 99.3 | 99.1 |
| ID | 34 | 26 | 39 | 57 |
| Burn-in | A | A | A | A |

TABLE 12

| | Example 17 | Example 18 | Example 19 | Example 20 |
|---|---|---|---|---|
| Liquid crystal | Liquid crystal | Liquid crystal | Liquid crystal | Liquid crystal |
| composition | composition 5 | composition 5 | composition 5 | composition 5 |
| Polymerizable | Polymerizable | Polymerizable | Polymerizable | Polymerizable |
| liquid crystal | liquid crystal | liquid crystal | liquid crystal | liquid crystal |
| composition of | composition 1 | composition 2 | composition 3 | composition 4 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 5 | composition 9 | composition 5 | composition 5 |
| the second | | | | |
| retardation film | | | | |
| VHR | 99.3 | 99.4 | 99.1 | 89.9 |
| ID | 35 | 28 | 50 | 72 |
| Burn-in | A | A | A | B |

TABLE 13

| | Example 21 | Example 22 | Example 23 | Example 24 |
|---|---|---|---|---|
| Liquid crystal | Liquid crystal | Liquid crystal | Liquid crystal | Liquid crystal |
| composition | composition 6 | composition 6 | composition 6 | composition 6 |
| Polymerizable | Polymerizable | Polymerizable | Polymerizable | Polymerizable |
| liquid crystal | liquid crystal | liquid crystal | liquid crystal | liquid crystal |
| composition of | composition 6 | composition 7 | composition 8 | composition 1 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 9 | composition 9 | composition 10 | composition 11 |
| the second | | | | |
| retardation film | | | | |
| VHR | 99.6 | 99.2 | 99.4 | 99.0 |
| ID | 18 | 48 | 26 | 65 |
| Burn-in | A | A | A | B |

In the liquid crystal display devices of Examples 13 to 24, the high VHR and low ID were realized. Also, the residual image was not generated even in the evaluation of burn-in or the residual image was generated extremely less, which was an acceptable level, even if the residual image was generated.

### Examples 25 to 36

Liquid crystal display devices or Examples 25 to 36 were fabricated in the same manner as in Example 1 except that the liquid crystal composition and the polymerizable liquid crystal composition shown below were used, and the VHR and ID were measured. Also, the burn-in of the obtained liquid crystal display devices was evaluated. The results are shown in the following tables.

TABLE 14
Liquid crystal composition 7

| | |
|---|---|
| T_{NI}/° C. | 75.1 |
| Δn | 0.103 |
| Δε | −2.6 |
| η/mPa · s | 20.5 |
| γ₁/mPa · s | 117 |
| γ₁/Δn² × 10⁻² | 110 |
| 3-Cy-Cy-2 | 15% |
| 3-Cy-Cy-4 | 12% |
| 3-Cy-Cy-5 | 7% |
| 3-Cy-Ph—O1 | 12% |
| 3-Cy-Ph5—O2 | 6% |
| 3-Cy-Ph5—O4 | 7% |
| 2-Cy-Ph—Ph5—O2 | 11% |
| 3-Cy-Ph—Ph5—O2 | 12% |
| 3-Cy-Cy-Ph5—O3 | 3% |
| 4-Cy-Cy-Ph5—O2 | 4% |
| 5-Cy-Cy-Ph5—O2 | 3% |
| 3-Ph—Ph5—Ph-2 | 4% |
| 4-Ph—Ph5—Ph-2 | 4% |

Liquid crystal composition 8

| | |
|---|---|
| T_{NI}/° C. | 80.4 |
| Δn | 0.103 |
| Δε | −2.6 |
| η/mPa · s | 21.6 |
| γ₁/mPa · s | 125 |
| γ₁/Δn² × 10⁻² | 117 |
| 3-Cy-Cy-2 | 15% |
| 3-Cy-Cy-4 | 12% |
| 3-Cy-Cy-5 | 7% |
| 3-Cy-Ph—O1 | 12% |
| 3-Cy-Ph5—O2 | 5% |
| 3-Cy-Ph5—O4 | 5% |
| 2-Cy-Ph—Ph5—O2 | 11% |
| 3-Cy-Ph—Ph5—O2 | 11% |
| 3-Cy-Cy-Ph5—O3 | 4% |
| 4-Cy-Cy-Ph5—O2 | 6% |
| 5-Cy-Cy-Ph5—O2 | 4% |
| 3-Ph—Ph5—Ph-2 | 4% |
| 4-Ph—Ph5—Ph-2 | 4% |

Liquid crystal composition 9

| | |
|---|---|
| T_{NI}/° C. | 85.1 |
| Δn | 0.103 |
| Δε | −2.6 |
| η/mPa · s | 22.7 |
| γ₁/mPa · s | 130 |
| γ₁/Δn² × 10⁻² | 122 |
| 3-Cy-Cy-2 | 10% |
| 3-Cy-Cy-4 | 15% |
| 3-Cy-Cy-5 | 12% |
| 3-Cy-Ph—O1 | 9% |
| 3-Cy-Ph5—O2 | 5% |
| 3-Cy-Ph5—O4 | 5% |
| 2-Cy-Ph—Ph5—O2 | 11% |
| 3-Cy-Ph—Ph5—O2 | 11% |
| 3-Cy-Cy-Ph5—O3 | 4% |
| 4-Cy-Cy-Ph5—O2 | 6% |
| 5-Cy-Cy-Ph5—O2 | 4% |
| 3-Ph—Ph5—Ph-2 | 4% |
| 4-Ph—Ph5—Ph-2 | 4% |

TABLE 15

| | Example 25 | Example 26 | Example 27 | Example 28 |
|---|---|---|---|---|
| Liquid crystal | Liquid crystal | Liquid crystal | Liquid crystal | Liquid crystal |
| composition | composition 7 | composition 7 | composition 7 | composition 7 |
| Polymerizable | Polymerizable | Polymerizable | Polymerizable | Polymerizable |
| liquid crystal | liquid crystal | liquid crystal | liquid crystal | liquid crystal |
| composition of | composition 6 | composition 7 | composition 8 | composition 1 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 9 | composition 9 | composition 10 | composition 11 |
| the second | | | | |
| retardation film | | | | |
| VHR | 99.7 | 99.4 | 99.5 | 99.2 |
| ID | 19 | 39 | 27 | 58 |
| Burn-in | A | A | A | A |

TABLE 16

| | Example 29 | Example 30 | Example 31 | Example 32 |
|---|---|---|---|---|
| Liquid crystal | Liquid crystal | Liquid crystal | Liquid crystal | Liquid crystal |
| composition | composition 8 | composition 8 | composition 8 | composition 8 |
| Polymerizable | Polymerizable | Polymerizable | Polymerizable | Polymerizable |
| liquid crystal | liquid crystal | liquid crystal | liquid crystal | liquid crystal |
| composition of | composition 6 | composition 7 | composition 8 | composition 1 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 9 | composition 9 | composition 10 | composition 11 |
| the second | | | | |
| retardation film | | | | |
| VHR | 99.6 | 99.3 | 99.5 | 99.1 |
| ID | 17 | 43 | 24 | 61 |
| Burn-in | A | A | A | A |

TABLE 17

| | Example 33 | Example 34 | Example 35 | Example 36 |
|---|---|---|---|---|
| Liquid crystal | Liquid crystal | Liquid crystal | Liquid crystal | Liquid crystal |
| composition | composition 9 | composition 9 | composition 9 | composition 9 |
| Polymerizable | Polymerizable | Polymerizable | Polymerizable | Polymerizable |
| liquid crystal | liquid crystal | liquid crystal | liquid crystal | liquid crystal |
| composition of | composition 6 | composition 7 | composition 8 | composition 1 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 9 | composition 9 | composition 10 | composition 11 |
| the second | | | | |
| retardation film | | | | |
| VHR | 99.5 | 99.3 | 99.5 | 99.1 |
| ID | 22 | 48 | 28 | 67 |
| Burn-in | A | A | A | B |

In the liquid crystal display devices of Examples 25 to 36, the high VHR and low IB were realized. Also, the residual image was not generated even in the evaluation of burn-in or the residual image was generated extremely less, which was; an acceptable level, even if the residual image was generated.

### Examples 37 to 48

Liquid crystal display devices of Examples 37 to 48 were fabricated in the same manner as in Example 1 except that the liquid crystal composition and the polymerizable liquid crystal composition shown below were used, and the VHR and ID were measured. Also, the burn-in of the obtained liquid crystal display devices was evaluated. The results are shown in the following tables.

TABLE 18
Liquid crystal composition 10

| | |
|---|---|
| T_{NI}/° C. | 76.7 |
| Δn | 0.109 |
| Δε | −3.0 |
| η/mPa · s | 22.4 |
| γ₁/mPa · s | 131 |
| γ₁/Δn² × 10⁻² | 110 |
| 3-Cy-Cy-2 | 24% |
| 3-Cy-Cy-4 | 6% |
| 3-Cy-Ph—O1 | 5% |
| 3-Cy-Ph5—O4 | 6% |
| 3-Ph—Ph5—O2 | 6% |
| 2-Cy-Ph—Ph5—O2 | 8% |
| 3-Cy-Ph—Ph5—O2 | 8% |
| 3-Cy-Cy-Ph5—O3 | 7% |
| 4-Cy-Cy-Ph5—O2 | 9% |
| 5-Cy-Cy-Ph5—O2 | 7% |
| 3-Ph—Ph5—Ph-2 | 4% |
| 4-Ph—Ph5—Ph-2 | 4% |
| 5-Ph—Ph-1 | 6% |

Liquid crystal composition 11

| | |
|---|---|
| T_{NI}/° C. | 80.3 |
| Δn | 0.105 |
| Δε | −3.1 |
| η/mPa · s | 21.8 |
| γ₁/mPa · s | 126 |
| γ₁/Δn² × 10⁻² | 114 |
| 3-Cy-Cy-2 | 24% |
| 3-Cy-Cy-4 | 10% |
| 3-Cy-Ph—O1 | 4% |
| 3-Cy-Ph5—O4 | 6% |
| 3-Ph—Ph5—O2 | 6% |
| 2-Cy-Ph—Ph5—O2 | 8% |
| 3-Cy-Ph—Ph5—O2 | 8% |
| 3-Cy-Cy-Ph5—O3 | 7% |
| 4-Cy-Cy-Ph5—O2 | 9% |
| 5-Cy-Cy-Ph5—O2 | 7% |
| 3-Ph—Ph5—Ph-2 | 4% |
| 4-Ph—Ph5—Ph-2 | 4% |
| 5-Ph—Ph-1 | 3% |

Liquid crystal composition 12

| | |
|---|---|
| T_{NI}/° C. | 85.8 |
| Δn | 0.104 |
| Δε | −3.2 |
| η/mPa · s | 22.0 |
| γ₁/mPa · s | 128 |
| γ₁/Δn² × 10⁻² | 119 |
| 3-Cy-Cy-2 | 24% |
| 3-Cy-Cy-4 | 10% |
| 3-Cy-Ph—O1 | 4% |
| 3-Cy-Ph5—O4 | 6% |
| 3-Ph—Ph5—O2 | 6% |
| 2-Cy-Ph—Ph5—O2 | 8% |
| 3-Cy-Ph—Ph5—O2 | 8% |
| 3-Cy-Cy-Ph5—O3 | 7% |
| 4-Cy-Cy-Ph5—O2 | 9% |
| 5-Cy-Cy-Ph5—O2 | 7% |
| 3-Ph—Ph5—Ph-2 | 4% |
| 4-Ph—Ph5—Ph-2 | 4% |
| 3-Cy-Cy-Ph-1 | 3% |

TABLE 19

| | Example 37 | Example 38 | Example 39 | Example 40 |
|---|---|---|---|---|
| Liquid crystal | Liquid crystal | Liquid crystal | Liquid crystal | Liquid crystal |
| composition | composition 10 | composition 10 | composition 10 | composition 10 |
| Polymerizable | Polymerizable | Polymerizable | Polymerizable | Polymerizable |
| liquid crystal | liquid crystal | liquid crystal | liquid crystal | liquid crystal |
| composition of | composition 6 | composition 7 | composition 8 | composition 1 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 9 | composition 9 | composition 10 | composition 11 |
| the second | | | | |
| retardation film | | | | |
| VHR | 99.5 | 99.2 | 99.3 | 99.2 |
| ID | 21 | 52 | 34 | 70 |
| Burn-in | A | A | A | B |

TABLE 20

| | Example 41 | Example 42 | Example 43 | Example 44 |
|---|---|---|---|---|
| Liquid crystal | Liquid crystal | Liquid crystal | Liquid crystal | Liquid crystal |
| composition | composition 11 | composition 11 | composition 11 | composition 11 |
| Polymerizable | Polymerizable | Polymerizable | Polymerizable | Polymerizable |
| liquid crystal | liquid crystal | liquid crystal | liquid crystal | liquid crystal |
| composition of | composition 14 | composition 15 | composition 8 | composition 8 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 16 | composition 17 | composition 18 |
| the second | | | | |
| retardation film | | | | |
| VHR | 99.5 | 99.2 | 99.6 | 99.4 |
| ID | 33 | 63 | 24 | 47 |
| Burn-in | A | B | A | A |

TABLE 21

| | Example 45 | Example 46 | Example 47 | Example 48 |
|---|---|---|---|---|
| Liquid crystal | Liquid crystal | Liquid crystal | Liquid crystal | Liquid crystal |
| composition | composition 12 | composition 12 | composition 12 | composition 12 |
| Polymerizable | Polymerizable | Polymerizable | Polymerizable | Polymerizable |
| liquid crystal | liquid crystal | liquid crystal | liquid crystal | liquid crystal |
| composition of | composition 14 | composition 15 | composition 8 | composition 8 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 16 | composition 17 | composition 18 |
| the second | | | | |
| retardation film | | | | |
| VHR | 99.5 | 99.3 | 99.7 | 99.4 |
| ID | 19 | 49 | 16 | 30 |
| Burn-in | A | A | A | A |

In the liquid crystal display devices of Examples 37 to 48, the high VHR and low ID were realized. Also, the residual image was not generated even in the evaluation of burn-in or the residual image was generated extremely less, which was an acceptable level, even if the residual image was generated.

### Examples 49 to 60

Liquid crystal display devices of Examples 2 to 4 were fabricated in the same manner as in Example 1 except that the liquid crystal composition and the polymerizable liquid crystal composition shown below were used, and the VHR and ID were measured. Also, the burn-in of the obtained liquid crystal display devices was evaluated. The results are shown in the following tables.

TABLE 22
Liquid crystal composition 13

| | |
|---|---|
| T_{NI}/° C. | 71.9 |
| Δn | 0.116 |
| Δε | −3.6 |
| η/mPa · s | 21.2 |
| γ₁/mPa · s | 123 |
| γ₁/Δn² × 10⁻² | 92 |
| 3-Cy-Cy-2 | 24% |
| 3-Cy-Ph—O1 | 7% |
| 2-Cy-Ph5—O2 | 6% |
| 3-Cy-Ph5—O4 | 6% |
| 3-Ph—Ph5—O2 | 5% |
| 5-Ph—Ph5—O2 | 5% |
| 2-Cy-Ph—Ph5—O2 | 7% |
| 3-Cy-Ph—Ph5—O2 | 9% |
| 3-Cy-Cy-Ph5—O3 | 5% |
| 4-Cy-Cy-Ph5—O2 | 5% |
| 5-Cy-Cy-Ph5—O2 | 4% |
| 3-Ph—Ph5—Ph-2 | 5% |
| 4-Ph—Ph5—Ph-2 | 6% |
| 3-Cy-Cy-Ph-1 | 6% |

Liquid crystal composition 14

| | |
|---|---|
| T_{NI}/° C. | 78.8 |
| Δn | 0.113 |
| Δε | −3.5 |
| η/mPa · s | 21.1 |
| γ₁/mPa · s | 122 |
| γ₁/Δn² × 10⁻² | 95 |
| 3-Cy-Cy-2 | 23% |
| 3-Cy-Cy-4 | 5% |
| 3-Cy-Ph—O1 | 3% |
| 2-Cy-Ph5—O2 | 5% |
| 3-Cy-Ph5—O4 | 5% |
| 3-Ph—Ph5—O2 | 5% |
| 5-Ph—Ph5—O2 | 5% |
| 2-Cy-Ph—Ph5—O2 | 7% |
| 3-Cy-Ph—Ph5—O2 | 7% |
| 3-Cy-Cy-Ph5—O3 | 5% |
| 4-Cy-Cy-Ph5—O2 | 6% |
| 5-Cy-Cy-Ph5—O2 | 5% |
| 3-Ph—Ph5—Ph-2 | 5% |
| 4-Ph—Ph5—Ph-2 | 6% |
| 3-Cy-Cy-Ph-1 | 8% |

Liquid crystal composition 15

| | |
|---|---|
| T_{NI}/° C. | 73.8 |
| Δn | 0.113 |
| Δε | −3.9 |
| η/mPa · s | 21.8 |
| γ₁/mPa · s | 123 |
| γ₁/Δn² × 10⁻² | 97 |
| 3-Cy-Cy-2 | 16% |
| 3-Cy-Cy-4 | 9% |
| 3-Cy-Ph—O1 | 6% |
| 2-Cy-Ph5—O2 | 6% |
| 3-Cy-Ph5—O4 | 6% |
| 3-Ph—Ph5—O2 | 6% |
| 5-Ph—Ph5—O2 | 6% |
| 2-Cy-Ph—Ph5—O2 | 5% |
| 3-Cy-Ph—Ph5—O2 | 7% |
| 3-Cy-Cy-Ph5—O3 | 5% |
| 4-Cy-Cy-Ph5—O2 | 6% |
| 5-Cy-Cy-Ph5—O2 | 6% |
| 3-Ph—Ph5—Ph-2 | 5% |
| 4-Ph—Ph5—Ph-2 | 5% |
| 3-Cy-Cy-Ph-1 | 6% |

TABLE 23

| | Example 49 | Example 50 | Example 51 | Example 52 |
|---|---|---|---|---|
| Liquid crystal | Liquid crystal | Liquid crystal | Liquid crystal | Liquid crystal |
| composition | composition 13 | composition 13 | composition 13 | composition 13 |
| Polymerizable | Polymerizable | Polymerizable | Polymerizable | Polymerizable |
| liquid crystal | liquid crystal | liquid crystal | liquid crystal | liquid crystal |
| composition of | composition 14 | composition 15 | composition 8 | composition 8 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 16 | composition 17 | composition 18 |
| the second | | | | |
| retardation film | | | | |
| VHR | 99.4 | 99.1 | 99.6 | 99.3 |
| ID | 38 | 64 | 21 | 45 |
| Burn-in | A | A | A | A |

TABLE 24

| | Example 53 | Example 54 | Example 55 | Example 56 |
|---|---|---|---|---|
| Liquid crystal | Liquid crystal | Liquid crystal | Liquid crystal | Liquid crystal |
| composition | composition 14 | composition 14 | composition 14 | composition 14 |
| Polymerizable | Polymerizable | Polymerizable | Polymerizable | Polymerizable |
| liquid crystal | liquid crystal | liquid crystal | liquid crystal | liquid crystal |
| composition of | composition 14 | composition 15 | composition 8 | composition 8 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 16 | composition 17 | composition 18 |
| the second | | | | |
| retardation film | | | | |
| VHR | 99.4 | 99.0 | 99.5 | 99.2 |
| ID | 35 | 66 | 23 | 48 |
| Burn-in | A | B | A | A |

TABLE 25

| | Example 57 | Example 58 | Example 59 | Example 60 |
|---|---|---|---|---|
| Liquid crystal | Liquid crystal | Liquid crystal | Liquid crystal | Liquid crystal |
| composition | composition 15 | composition 15 | composition 15 | composition 15 |
| Polymerizable | Polymerizable | Polymerizable | Polymerizable | Polymerizable |
| liquid crystal | liquid crystal | liquid crystal | liquid crystal | liquid crystal |
| composition of | composition 14 | composition 15 | composition 8 | composition 8 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 16 | composition 17 | composition 18 |
| the second | | | | |
| retardation film | | | | |
| VHR | 99.3 | 99.0 | 99.5 | 99.1 |
| ID | 41 | 72 | 29 | 58 |
| Burn-in | A | A | A | A |

In the liquid crystal display devices of Examples 49 to 60, the high VHR and low IB were realized. Also, the residual image was not generated even in the evaluation of burn-in or the residual image was generated extremely less, which was an acceptable level, even if the residual image was generated.

### Examples 61 to 72

Liquid crystal display devices of Examples 61 to 72 were fabricated in the same manner as in Example 1 except that the liquid crystal composition and the polymerizable liquid crystal composition shown in the following tables were used, and the VHR and ID were measured. Also, the burn-in of the obtained liquid crystal display devices was evaluated. The results are shown in the following tables.

TABLE 26
Liquid crystal composition 16

| | |
|---|---|
| T_{NI}/° C. | 75.9 |
| Δn | 0.112 |
| Δε | −2.8 |
| η/mPa · s | 19.8 |
| γ₁/mPa · s | 121 |
| γ₁/Δn² × 10⁻² | 96 |
| 3-Cy-Cy-2 | 19% |
| 3-Cy-Cy-4 | 12% |
| 3-Cy-Cy-5 | 5% |
| 3-Cy-Ph—O1 | 5% |
| 2-Cy-Ph5—O2 | 4% |
| 3-Cy-Ph5—O4 | 4% |
| 3-Ph—Ph5—O2 | 3% |
| 5-Ph—Ph5—O2 | 4% |
| 2-Cy-Ph—Ph5—O2 | 6% |
| 3-Cy-Ph—Ph5—O2 | 6% |
| 3-Cy-Cy-Ph5—O3 | 5% |
| 4-Cy-Cy-Ph5—O2 | 5% |
| 5-Cy-Cy-Ph5—O2 | 5% |
| 3-Ph—Ph5—Ph-2 | 8% |
| 4-Ph—Ph5—Ph-2 | 9% |

Liquid crystal composition 17

| | |
|---|---|
| T_{NI}/° C. | 82.3 |
| Δn | 0.111 |
| Δε | −2.7 |
| η/mPa · s | 19.2 |
| γ₁/mPa · s | 114 |
| γ₁/Δn² × 10⁻² | 94 |
| 3-Cy-Cy-2 | 21% |
| 3-Cy-Cy-4 | 12% |
| 3-Cy-Cy-5 | 5% |
| 2-Cy-Ph5—O2 | 4% |
| 3-Cy-Ph5—O4 | 4% |
| 3-Ph—Ph5—O2 | 3% |
| 5-Ph—Ph5—O2 | 4% |
| 2-Cy-Ph—Ph5—O2 | 6% |
| 3-Cy-Ph—Ph5—O2 | 6% |
| 3-Cy-Cy-Ph5—O3 | 5% |
| 4-Cy-Cy-Ph5—O2 | 5% |
| 5-Cy-Cy-Ph5—O2 | 4% |
| 3-Ph—Ph5—Ph-2 | 7% |
| 4-Ph—Ph5—Ph-2 | 8% |
| 3-Cy-Cy-Ph-1 | 6% |

Liquid crystal composition 18

| | |
|---|---|
| T_{NI}/° C. | 85.7 |
| Δn | 0.112 |
| Δε | −2.8 |
| η/mPa · s | 20.1 |
| γ₁/mPa · s | 119 |
| γ₁/Δn² × 10⁻² | 95 |
| 3-Cy-Cy-2 | 19% |
| 3-Cy-Cy-4 | 12% |
| 3-Cy-Cy-5 | 4% |
| 2-Cy-Ph5—O2 | 4% |
| 3-Cy-Ph5—O4 | 4% |
| 3-Ph—Ph5—O2 | 3% |
| 5-Ph—Ph5—O2 | 4% |
| 2-Cy-Ph—Ph5—O2 | 6% |
| 3-Cy-Ph—Ph5—O2 | 6% |
| 3-Cy-Cy-Ph5—O3 | 5% |
| 4-Cy-Cy-Ph5—O2 | 5% |
| 5-Cy-Cy-Ph5—O2 | 4% |
| 3-Ph—Ph5—Ph-2 | 7% |
| 4-Ph—Ph5—Ph-2 | 8% |
| 3-Cy-Cy-Ph-1 | 9% |

TABLE 27

| | Example 61 | Example 62 | Example 63 | Example 64 |
|---|---|---|---|---|
| Liquid crystal | Liquid crystal | Liquid crystal | Liquid crystal | Liquid crystal |
| composition | composition 16 | composition 16 | composition 16 | composition 16 |
| Polymerizable | Polymerizable | Polymerizable | Polymerizable | Polymerizable |
| liquid crystal | liquid crystal | liquid crystal | liquid crystal | liquid crystal |
| composition of | composition 3 | composition 4 | composition 13 | composition 13 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 16 | composition 16 | composition 13 | composition 20 |
| the second | | | | |
| retardation film | | | | |
| VHR | 99.3 | 99.1 | 99.5 | 99.4 |
| ID | 59 | 77 | 28 | 47 |
| Burn-in | A | B | A | A |

TABLE 28

| | Example 65 | Example 66 | Example 67 | Example 68 |
|---|---|---|---|---|
| Liquid crystal | Liquid crystal | Liquid crystal | Liquid crystal | Liquid crystal |
| composition | composition 17 | composition 17 | composition 17 | composition 17 |
| Polymerizable | Polymerizable | Polymerizable | Polymerizable | Polymerizable |
| liquid crystal | liquid crystal | liquid crystal | liquid crystal | liquid crystal |
| composition of | composition 3 | composition 4 | composition 13 | composition 13 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 16 | composition 16 | composition 19 | composition 20 |
| the second | | | | |
| retardation film | | | | |
| VHR | 99.3 | 99.0 | 99.4 | 99.3 |
| ID | 52 | 78 | 34 | 46 |
| Burn-in | B | B | A | A |

TABLE 29

| | Example 69 | Example 70 | Example 71 | Example 72 |
|---|---|---|---|---|
| Liquid crystal | Liquid crystal | Liquid crystal | Liquid crystal | Liquid crystal |
| composition | composition 18 | composition 18 | composition 18 | composition 18 |
| Polymerizable | Polymerizable | Polymerizable | Polymerizable | Polymerizable |
| liquid crystal | liquid crystal | liquid crystal | liquid crystal | liquid crystal |
| composition of | composition 3 | composition 4 | composition 13 | composition 13 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 16 | composition 16 | composition 19 | composition 20 |
| the second | | | | |
| retardation film | | | | |
| VHR | 99.2 | 99.1 | 99.5 | 99.3 |
| ID | 49 | 65 | 28 | 40 |
| Burn-in | A | A | A | A |

In the liquid crystal display devices of Examples 61 to 72, the high VHR and low ID were realized. Also, the residual image was not generated even in the evaluation of burn-in or the residual image was generated extremely less, which was an acceptable level, even if the residual image was generated.

### Examples 73 to 84

Liquid crystal display devices of Examples 73 to 34 were fabricated in the same manner as in Example 1 except that the liquid crystal composition and the polymerizable liquid crystal composition shown in the following tables were used, and the VHR and ID were measured. Also, the burn-in of the obtained liquid crystal display devices was evaluated. The results are shown in the following tables.

TABLE 30
Liquid crystal composition 19

| | |
|---|---|
| T_{NI}/° C. | 77.1 |
| Δn | 0.104 |
| Δε | −3.5 |
| η/mPa · s | 25.1 |
| γ₁/mPa · s | 141 |
| γ₁/Δn² × 10⁻² | 131 |
| 3-Cy-Cy-2 | 22% |
| 3-Cy-Ph—O1 | 14% |
| 2-Cy-Ph5—O2 | 7% |
| 3-Cy-Ph5—O4 | 8% |
| 2-Cy-Ph—Ph5—O2 | 7% |
| 3-Cy-Ph—Ph5—O2 | 9% |
| 3-Cy-Cy-Ph5—O3 | 8% |
| 4-Cy-Cy-Ph5—O2 | 8% |
| 5-Cy-Cy-Ph5—O2 | 8% |
| 3-Ph—Ph5—Ph-2 | 5% |
| 4-Ph—Ph5—Ph-2 | 4% |

Liquid crystal composition 20

| | |
|---|---|
| T_{NI}/° C. | 82.7 |
| Δn | 0.107 |
| Δε | −3.0 |
| η/mPa · s | 24.2 |
| γ₁/mPa · s | 141 |
| γ₁/Δn² × 10⁻² | 123 |
| 3-Cy-Cy-2 | 24% |
| 3-Cy-Cy-4 | 5% |
| 3-Cy-Ph—O1 | 6% |
| 2-Cy-Ph5—O2 | 5% |
| 3-Cy-Ph5—O4 | 5% |
| 2-Cy-Ph—Ph5—O2 | 7% |
| 3-Cy-Ph—Ph5—O2 | 9% |
| 3-Cy-Cy-Ph5—O3 | 8% |
| 4-Cy-Cy-Ph5—O2 | 8% |
| 5-Cy-Cy-Ph5—O2 | 8% |
| 3-Ph—Ph5—Ph-2 | 5% |
| 4-Ph—Ph5—Ph-2 | 5% |
| 5-Ph—Ph-1 | 5% |

Liquid crystal composition 21

| | |
|---|---|
| T_{NI}/° C. | 86.4 |
| Δn | 0.106 |
| Δε | −3.0 |
| η/mPa · s | 24.4 |
| γ₁/mPa · s | 142 |
| γ₁/Δn² × 10⁻² | 126 |
| 3-Cy-Cy-2 | 24% |
| 3-Cy-Cy-4 | 5% |
| 3-Cy-Ph—O1 | 6% |
| 2-Cy-Ph5—O2 | 5% |
| 3-Cy-Ph5—O4 | 5% |
| 2-Cy-Ph—Ph5—O2 | 7% |
| 3-Cy-Ph—Ph5—O2 | 9% |
| 3-Cy-Cy-Ph5—O3 | 8% |
| 4-Cy-Cy-Ph5—O2 | 8% |
| 5-Cy-Cy-Ph5—O2 | 8% |
| 3-Ph—Ph5—Ph-2 | 5% |
| 4-Ph—Ph5—Ph-2 | 5% |
| 5-Ph—Ph-1 | 3% |
| 3-Cy-Cy-Ph-1 | 2% |

TABLE 31

| | Example 73 | Example 74 | Example 75 | Example 76 |
|---|---|---|---|---|
| Liquid crystal | Liquid crystal | Liquid crystal | Liquid crystal | Liquid crystal |
| composition | composition 19 | composition 19 | composition 19 | composition 19 |
| Polymerizable | Polymerizable | Polymerizable | Polymerizable | Polymerizable |
| liquid crystal | liquid crystal | liquid crystal | liquid crystal | liquid crystal |
| composition of | composition 3 | composition 4 | composition 13 | composition 13 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 16 | composition 16 | composition 19 | composition 20 |
| the second | | | | |
| retardation film | | | | |
| VHR | 99.3 | 99.2 | 99.6 | 99.4 |
| ID | 47 | 60 | 19 | 33 |
| Burn-in | A | A | A | A |

TABLE 32

| | Example 77 | Example 78 | Example 79 | Example 80 |
|---|---|---|---|---|
| Liquid crystal | Liquid crystal | Liquid crystal | Liquid crystal | Liquid crystal |
| composition | composition 20 | composition 20 | composition 20 | composition 20 |
| Polymerizable | Polymerizable | Polymerizable | Polymerizable | Polymerizable |
| liquid crystal | liquid crystal | liquid crystal | liquid crystal | liquid crystal |
| composition of | composition 3 | composition 4 | composition 13 | composition 13 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 16 | composition 16 | composition 19 | composition 20 |
| the second | | | | |
| retardation film | | | | |
| VHR | 99.4 | 99.2 | 99.7 | 99.6 |
| ID | 39 | 57 | 16 | 21 |
| Burn-in | A | A | A | A |

TABLE 33

| | Example 81 | Example 82 | Example 83 | Example 84 |
|---|---|---|---|---|
| Liquid crystal | Liquid crystal | Liquid crystal | Liquid crystal | Liquid crystal |
| composition | composition 21 | composition 21 | composition 21 | composition 21 |
| Polymerizable | Polymerizable | Polymerizable | Polymerizable | Polymerizable |
| liquid crystal | liquid crystal | liquid crystal | liquid crystal | liquid crystal |
| composition of | composition 22 | composition 14 | composition 15 | composition 24 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 23 | composition 11 | composition 16 |
| the second | | | | |
| retardation film | | | | |
| VHR | 99.4 | 99.3 | 99.4 | 99.1 |
| ID | 31 | 57 | 38 | 66 |
| Burn-in | A | B | A | B |

In the liquid crystal display devices of Examples 73 to 84, the high VHR and low IB were realized. Also, the residual image was not generated even in the evaluation of burn-in or the residual image was generated extremely less, which was an acceptable level, even if the residual image was generated.

### Examples 85 to 96

Liquid crystal display devices of Examples 85 to 96 were fabricated in the same manner as in Example 1 except that the liquid crystal composition and the polymerizable liquid crystal composition shown in the following tables were used, and the VHR and ID were measured. Also, the burn-in of the obtained liquid crystal display devices was evaluated. The results are shown in the following tables.

TABLE 34
Liquid crystal composition 32

| | |
|---|---|
| T_{NI}/° C. | 75.5 |
| Δn | 0.102 |
| Δε | −2.8 |
| η/mPa · s | 22.2 |
| γ₁/mPa · s | 121 |
| γ₁/Δn² × 10⁻² | 117 |
| 3-Cy-Cy-2 | 14% |
| 3-Cy-Cy-4 | 12% |
| 3-Cy-Cy-5 | 5% |
| 3-Cy-Ph—O1 | 7% |
| 2-Cy-Ph5—O2 | 7% |
| 3-Cy-Ph5—O4 | 7% |
| 2-Cy-Ph—Ph5—O2 | 8% |
| 3-Cy-Ph—Ph5—O2 | 8% |
| 3-Cy-Cy-Ph5—O3 | 6% |
| 4-Cy-Cy-Ph5—O2 | 7% |
| 5-Cy-Cy-Ph5—O2 | 6% |
| 3-Ph—Ph5—Ph-2 | 3% |
| 4-Ph—Ph5—Ph-2 | 3% |
| 5-Ph—Ph-1 | 6% |
| 3-Cy-Cy-Ph-1 | 1% |

Liquid crystal composition 23

| | |
|---|---|
| T_{NI}/° C. | 80.3 |
| Δn | 0.101 |
| Δε | −2.9 |
| η/mPa · s | 22.0 |
| γ₁/mPa · s | 118 |
| γ₁/Δn² × 10⁻² | 117 |
| 3-Cy-Cy-2 | 17% |
| 3-Cy-Cy-4 | 12% |
| 3-Cy-Cy-5 | 5% |
| 3-Cy-Ph—O1 | 6% |
| 2-Cy-Ph5—O2 | 12% |
| 2-Cy-Ph—Ph5—O2 | 9% |
| 3-Cy-Ph—Ph5—O2 | 9% |
| 3-Cy-Cy-Ph5—O3 | 6% |
| 4-Cy-Cy-Ph5—O2 | 8% |
| 5-Cy-Cy-Ph5—O2 | 6% |
| 3-Ph—Ph5—Ph-2 | 3% |
| 4-Ph—Ph5—Ph-2 | 3% |
| 5-Ph—Ph-1 | 4% |

Liquid crystal composition 24

| | |
|---|---|
| T_{NI}/° C. | 85.0 |
| Δn | 0.102 |
| Δε | −3.0 |
| η/mPa · s | 22.7 |
| γ₁/mPa · s | 122 |
| γ₁/Δn² × 10⁻² | 118 |
| 3-Cy-Cy-2 | 16% |
| 3-Cy-Cy-4 | 12% |
| 3-Cy-Cy-5 | 5% |
| 3-Cy-Ph—O1 | 5% |
| 2-Cy-Ph5—O2 | 12% |
| 2-Cy-Ph—Ph5—O2 | 9% |
| 3-Cy-Ph—Ph5—O2 | 9% |
| 3-Cy-Cy-Ph5—O3 | 6% |
| 4-Cy-Cy-Ph5—O2 | 8% |
| 5-Cy-Cy-Ph5—O2 | 6% |
| 3-Ph—Ph5—Ph-2 | 3% |
| 4-Ph—Ph5—Ph-2 | 3% |
| 5-Ph—Ph-1 | 3% |
| 3-Cy-Cy-Ph-1 | 3% |

TABLE 35

| | Example 85 | Example 86 | Example 87 | Example 88 |
|---|---|---|---|---|
| Liquid crystal | Liquid crystal | Liquid crystal | Liquid crystal | Liquid crystal |
| composition | composition 22 | composition 22 | composition 22 | composition 22 |
| Polymerizable | Polymerizable | Polymerizable | Polymerizable | Polymerizable |
| liquid crystal | liquid crystal | liquid crystal | liquid crystal | liquid crystal |
| composition of | composition 22 | composition 14 | composition 15 | composition 24 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 23 | composition 11 | composition 16 |
| the second | | | | |
| retardation film | | | | |
| VHR | 99.5 | 99.2 | 99.4 | 99.0 |
| ID | 28 | 52 | 38 | 74 |
| Burn-in | A | A | A | B |

TABLE 36

| | Example 89 | Example 90 | Example 91 | Example 92 |
|---|---|---|---|---|
| Liquid crystal | Liquid crystal | Liquid crystal | Liquid crystal | Liquid crystal |
| composition | composition 23 | composition 23 | composition 23 | composition 23 |
| Polymerizable | Polymerizable | Polymerizable | Polymerizable | Polymerizable |
| liquid crystal | liquid crystal | liquid crystal | liquid crystal | liquid crystal |
| composition of | composition 22 | composition 14 | composition 15 | composition 24 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 23 | composition 11 | composition 16 |
| the second | | | | |
| retardation film | | | | |
| VHR | 99.5 | 99.2 | 99.3 | 99.1 |
| ID | 27 | 56 | 45 | 70 |
| Burn-in | A | A | A | B |

TABLE 37

| | Example 93 | Example 94 | Example 95 | Example 96 |
|---|---|---|---|---|
| Liquid crystal | Liquid crystal | Liquid crystal | Liquid crystal | Liquid crystal |
| composition | composition 24 | composition 24 | composition 24 | composition 24 |
| Polymerizable | Polymerizable | Polymerizable | Polymerizable | Polymerizable |
| liquid crystal | liquid crystal | liquid crystal | liquid crystal | liquid crystal |
| composition of | composition 22 | composition 14 | composition 15 | composition 24 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 23 | composition 11 | composition 16 |
| the second | | | | |
| retardation film | | | | |
| VHR | 99.7 | 99.4 | 99.5 | 99.3 |
| ID | 15 | 35 | 26 | 51 |
| Burn-in | A | A | A | A |

In the liquid crystal display devices of Examples 85 to 96, the high VHR and low ID were realized. Also, the residual image was not generated even in the evaluation of burn-in or the residual image was generated extremely less, which was an acceptable level, even if the residual image was generated.

### Examples 97 to 108

Liquid crystal display devices of: Examples 37 to 108 were fabricated in the same manner as in Example 1 except that the liquid crystal composition and the polymerizable liquid crystal composition shown in the following tables were used, and the VHR and ID were measured. Also, the burn-in of the obtained liquid crystal display devices was evaluated. The results are shown in the following tables.

TABLE 38
Liquid crystal composition 25

| | |
|---|---|
| T_{NI}/° C. | 75.6 |
| Δn | 0.104 |
| Δε | −2.8 |
| η/mPa · s | 20.2 |
| γ₁/mPa · s | 117 |
| γ₁/Δn² × 10⁻² | 107 |
| 3-Cy-Cy-2 | 25% |
| 3-Cy-Cy-4 | 10% |
| 3-Cy-Ph—O1 | 4% |
| 2-Cy-Ph5—O2 | 7% |
| 3-Cy-Ph5—O4 | 8% |
| 2-Cy-Ph—Ph5—O2 | 5% |
| 3-Cy-Ph—Ph5—O2 | 6% |
| 3-Cy-Cy-Ph5—O3 | 6% |
| 4-Cy-Cy-Ph5—O2 | 7% |
| 5-Cy-Cy-Ph5—O2 | 6% |
| 3-Ph—Ph5—Ph-2 | 8% |
| 4-Ph—Ph5—Ph-2 | 8% |

Liquid crystal composition 26

| | |
|---|---|
| T_{NI}/° C. | 81.1 |
| Δn | 0.105 |
| Δε | −2.8 |
| η/mPa · s | 20.8 |
| γ₁/mPa · s | 119 |
| γ₁/Δn² × 10⁻² | 107 |
| 3-Cy-Cy-2 | 25% |
| 3-Cy-Cy-4 | 10% |
| 3-Cy-Ph—O1 | 4% |
| 2-Cy-Ph5—O2 | 12% |
| 2-Cy-Ph—Ph5—O2 | 5% |
| 3-Cy-Ph—Ph5—O2 | 6% |
| 3-Cy-Cy-Ph5—O3 | 7% |
| 4-Cy-Cy-Ph5—O2 | 8% |
| 5-Cy-Cy-Ph5—O2 | 7% |
| 3-Ph—Ph5—Ph-2 | 8% |
| 4-Ph—Ph5—Ph-2 | 8% |

Liquid crystal composition 27

| | |
|---|---|
| T_{NI}/° C. | 85.7 |
| Δn | 0.105 |
| Δε | −2.9 |
| η/mPa · s | 21.0 |
| γ₁/mPa · s | 92 |
| γ₁/Δn² × 10⁻² | 82 |
| 3-Cy-Cy-2 | 25% |
| 3-Cy-Cy-4 | 12% |
| 2-Cy-Ph5—O2 | 12% |
| 2-Cy-Ph—Ph5—O2 | 5% |
| 3-Cy-Ph—Ph5—O2 | 6% |
| 3-Cy-Cy-Ph5—O3 | 7% |
| 4-Cy-Cy-Ph5—O2 | 8% |
| 5-Cy-Cy-Ph5—O2 | 7% |
| 3-Ph—Ph5—Ph-2 | 8% |
| 4-Ph—Ph5—Ph-2 | 8% |
| 3-Cy-Cy-Ph-1 | 2% |

TABLE 39

| | Example 97 | Example 98 | Example 99 | Example 100 |
|---|---|---|---|---|
| Liquid crystal | Liquid crystal | Liquid crystal | Liquid crystal | Liquid crystal |
| composition | composition 25 | composition 25 | composition 25 | composition 25 |
| Polymerizable | Polymerizable | Polymerizable | Polymerizable | Polymerizable |
| liquid crystal | liquid crystal | liquid crystal | liquid crystal | liquid crystal |
| composition of | composition 22 | composition 8 | composition 15 | composition 24 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 12 | composition 11 | composition 16 |
| the second | | | | |
| retardation film | | | | |
| VHR | 99.8 | 99.4 | 99.5 | 99.4 |
| ID | 14 | 23 | 33 | 46 |
| Burn-in | A | A | A | A |

TABLE 40

| | Example 101 | Example 102 | Example 103 | Example 104 |
|---|---|---|---|---|
| Liquid crystal | Liquid crystal | Liquid crystal | Liquid crystal | Liquid crystal |
| composition | composition 26 | composition 26 | composition 26 | composition 26 |
| Polymerizable | Polymerizable | Polymerizable | Polymerizable | Polymerizable |
| liquid crystal | liquid crystal | liquid crystal | liquid crystal | liquid crystal |
| composition of | composition 22 | composition 8 | composition 15 | composition 24 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 12 | composition 11 | composition 16 |
| the second | | | | |
| retardation film | | | | |
| VHR | 99.6 | 99.5 | 99.3 | 99.2 |
| ID | 25 | 32 | 50 | 62 |
| Burn-in | A | A | A | B |

TABLE 41

| | Example 105 | Example 106 | Example 107 | Example 108 |
|---|---|---|---|---|
| Liquid crystal | Liquid crystal | Liquid crystal | Liquid crystal | Liquid crystal |
| composition | composition 27 | composition 27 | composition 27 | composition 27 |
| Polymerizable | Polymerizable | Polymerizable | Polymerizable | Polymerizable |
| liquid crystal | liquid crystal | liquid crystal | liquid crystal | liquid crystal |
| composition of | composition 22 | composition 8 | composition 15 | composition 24 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 12 | composition 11 | composition 16 |
| the second | | | | |
| retardation film | | | | |
| VHR | 99.5 | 99.4 | 99.2 | 99.1 |
| ID | 24 | 39 | 53 | 66 |
| Burn-in | A | A | A | B |

In the liquid crystal display devices of Examples 97 to 108, the high VHR and low ID were realised. Also, the residual image was not generated even in the evaluation of burn-in or the residual image was generated extremely less, which was an acceptable level, even if the residual image was generated.

### Examples 109 to 112

0.3% by mass of 2-methyl-acrylic acid 4-(2-[4-(2-acryloyloxy-ethyl)-phenoxycarbonyl3-ethyl]-biphenyl-4′-yl ester was mixed in the liquid crystal composition 1 to obtain a liquid crystal composition 23. The liquid crystal composition 28 was injected in the same manner as in Example 1, the composition was irradiated with an ultraviolet ray for 600 seconds (3.0 J/cm²) and polymerized, while a driving voltage was applied between the electrodes, to fabricate liquid crystal display devices of Examples 103 to 112 and the VHR and ID were measured. Also, the burn-in of the obtained liquid crystal display devices was evaluated. The results are shown in the following tables.

TABLE 42

| | Example 109 | Example 110 | Example 111 | Example 112 |
|---|---|---|---|---|
| Liquid crystal | Liquid crystal | Liquid crystal | Liquid crystal | Liquid crystal |
| composition | composition 28 | composition 28 | composition 28 | composition 28 |
| Polymerizable | Polymerizable | Polymerizable | Polymerizable | Polymerizable |
| liquid crystal | liquid crystal | liquid crystal | liquid crystal | liquid crystal |
| composition of | composition 1 | composition 2 | composition 3 | composition 4 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 5 | composition 9 | composition 5 | composition 5 |
| the second | | | | |
| retardation film | | | | |
| VHR | 99.3 | 99.4 | 99.3 | 99.1 |
| ID | 42 | 30 | 48 | 62 |
| Burn-in | A | A | A | B |

In the liquid crystal display devices of Examples 109 to 112, the high VHR and low ID were realised. Also, the residual image was not generated even in the evaluation of burn-in or the residual image was generated extremely less, which was an acceptable level, even if the residual image was generated.

### Examples 113 to 116

0.3% by mass of bismethacrylic acid biphenyl-4,4′-diyl was mixed in the liquid crystal composition 13 to obtain a liquid crystal composition 29. The liquid crystal composition 29 was injected in the same manner as in Example 1, the composition was irradiated with an ultraviolet ray for 600 seconds (3.0 J/cm²) and polymerized, while a driving voltage was applied between the electrodes, to fabricate liquid crystal display devices of Examples 113 to 116 and the VHR and ID were measured. Also, the burn-in of the obtained liquid crystal display devices was evaluated. The results are shown in the following tables.

TABLE 43

| | Example 113 | Example 114 | Example 115 | Example 116 |
|---|---|---|---|---|
| Liquid crystal | Liquid crystal | Liquid crystal | Liquid crystal | Liquid crystal |
| composition | composition 29 | composition 29 | composition 29 | composition 29 |
| Polymerizable | Polymerizable | Polymerizable | Polymerizable | Polymerizable |
| liquid crystal | liquid crystal | liquid crystal | liquid crystal | liquid crystal |
| composition of | composition 6 | composition 7 | composition 8 | composition 1 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 9 | composition 9 | composition 10 | composition 11 |
| the second | | | | |
| retardation film | | | | |
| VHR | 99.5 | 99.2 | 99.4 | 99.1 |
| ID | 24 | 59 | 40 | 67 |
| Burn-in | A | A | A | B |

In the liquid crystal display devices of Examples 113 to 116, the high VHR and low ID were realized. Also, the residual image was not generated even in the evaluation of burn-in or the residual image was generated extremely less, which was an acceptable level, even it the residual image was generated.

### Examples 117 to 120

0.3% by mass of bismethacrylic acid 3-fluorobiphenyl-4,4′-diyl was mixed in the liquid crystal composition 19 to obtain a liquid crystal composition 30. The liquid crystal composition 30 was injected in the same manner as in Example 1, the composition was irradiated with an ultraviolet ray for 600 seconds (3.0 J/cm²) and polymerized, while a driving voltage was applied between the electrodes, to fabricate liquid crystal display devices of Examples 117 to 120 and the VHR and ID were measured. Also, the burn-in of the obtained liquid crystal display devices was evaluated. The results are shown in the following tables.

TABLE 44

| | Example 117 | Example 118 | Example 119 | Example 120 |
|---|---|---|---|---|
| Liquid crystal | Liquid crystal | Liquid crystal | Liquid crystal | Liquid crystal |
| composition | composition 30 | composition 30 | composition 30 | composition 30 |
| Polymerizable | Polymerizable | Polymerizable | Polymerizable | Polymerizable |
| liquid crystal | liquid crystal | liquid crystal | liquid crystal | liquid crystal |
| composition of | composition 22 | composition 14 | composition 15 | composition 24 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 23 | composition 11 | composition 16 |
| the second | | | | |
| retardation film | | | | |
| VHR | 99.5 | 99.3 | 99.3 | 99.1 |
| ID | 22 | 39 | 44 | 69 |
| Burn-in | A | A | A | B |

In the liquid crystal display devices of Examples 117 to 120, the high VHR and low ID were realized. Also, the residual image was not generated even in the evaluation of burn-in or the residual image was generated extremely less, which was an acceptable level, even if the residual image was generated.

### Examples 121 to 132

Liquid crystal display devices of Examples 121 to 132 were fabricated in the same manner as in Example 1 except that the liquid crystal composition and the polymerizable liquid crystal composition shown in the following tables were used, and the VHR and ID were measured. Also, the burn-in of the obtained liquid crystal display devices was evaluated. The results are shown in the following tables.

TABLE 45
Liquid crystal composition 31

| | |
|---|---|
| TNI/° C. | 75.5 |
| Δn | 0.103 |
| Δε | −3.1 |
| η/mPa · s | 15.8 |
| γ1/mPa · s | 113 |
| γ1/Δn2 × 10−2 | 113 |
| 3-Cy-Cy-2 | 13% |
| 3-Cy-Cy-V1 | 12% |
| 3-Cy-Cy-4 | 5% |
| 3-Ph—Ph-1 | 3% |
| 5-Ph—Ph-1 | 12% |
| 3-Cy-Cy-Ph-1 | 3% |
| V-Cy-Ph—Ph-3 | 6% |
| 3-Cy-1O—Ph5—O2 | 11% |
| 2-Cy-Cy-1O—Ph5—O2 | 12% |
| 3-Cy-Cy-1O—Ph5—O2 | 12% |
| 4-Cy-Cy-1O—Ph5—O2 | 2% |
| V-Cy-Cy-1O—Ph5—O2 | 3% |
| 1V-Cy-Cy-1O—Ph5—O2 | 6% |

Liquid crystal composition 32

| | |
|---|---|
| TNI/° C. | 75.4 |
| Δn | 0.109 |
| Δε | −3.1 |
| η/mPa · s | 14.9 |
| γ1/mPa · s | 110 |
| γ1/Δn2 × 10−2 | 92 |
| 2-Cy-Cy-V1 | 20% |
| 3-Cy-Cy-V1 | 13% |
| 3-Ph—Ph-1 | 10% |
| 5-Ph—Ph-1 | 5% |
| 3-Cy-Ph—Ph-2 | 6% |
| 1V-Cy-1O—Ph5—O2 | 8% |
| 2-Cy-Cy-1O—Ph5—O2 | 10% |
| 3-Cy-Cy-1O—Ph5—O2 | 10% |
| V-Cy-Cy-1O—Ph5—O2 | 10% |
| 1V-Cy-Cy-1O—Ph5—O2 | 4% |
| 3-Ph—Ph5—Ph-2 | 4% |

Liquid crystal composition 33

| | |
|---|---|
| TNI/° C. | 83.1 |
| Δn | 0.114 |
| Δε | −2.9 |
| η/mPa · s | 14.8 |
| γ1/mPa · s | 92 |
| γ1/Δn2 × 10−2 | 71 |
| V2—Ph—Ph-1 | 5% |
| 3-Cy-Cy-V | 39% |
| 3-Cy-1O—Ph5—O2 | 5% |
| 2-Cy-Cy-1O—Ph5—O2 | 11% |
| 3-Cy-Cy-1O—Ph5—O1 | 11% |
| 3-Cy-Cy-1O—Ph5—O2 | 6% |
| 2-Cy-Ph—Ph5—O2 | 6% |
| 3-Ph—Ph5—Ph-1 | 8% |
| 3-Ph—Ph5—Ph-2 | 9% |

TABLE 46

| | Example 121 | Example 122 | Example 123 | Example 124 |
|---|---|---|---|---|
| Liquid crystal | Liquid crystal | Liquid crystal | Liquid crystal | Liquid crystal |
| composition | composition 31 | composition 31 | composition 31 | composition 31 |
| Polymerizable | Polymerizable | Polymerizable | Polymerizable | Polymerizable |
| liquid crystal | liquid crystal | liquid crystal | liquid crystal | liquid crystal |
| composition of | composition 1 | composition 2 | composition 3 | composition 4 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 5 | composition 9 | composition 5 | composition 5 |
| the second | | | | |
| retardation film | | | | |
| VHR | 99.4 | 99.6 | 99.3 | 99.2 |
| ID | 29 | 18 | 43 | 59 |
| Burn-in | A | A | A | A |

TABLE 47

| | Example 125 | Example 126 | Example 127 | Example 128 |
|---|---|---|---|---|
| Liquid crystal | Liquid crystal | Liquid crystal | Liquid crystal | Liquid crystal |
| composition | composition 32 | composition 32 | composition 32 | composition 32 |
| Polymerizable | Polymerizable | Polymerizable | Polymerizable | Polymerizable |
| liquid crystal | liquid crystal | liquid crystal | liquid crystal | liquid crystal |
| composition of | composition 6 | composition 7 | composition 8 | composition 1 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 9 | composition 9 | composition 10 | composition 11 |
| the second | | | | |
| retardation film | | | | |
| VHR | 99.5 | 99.2 | 99.3 | 99.1 |
| ID | 30 | 61 | 47 | 68 |
| Burn-in | A | B | A | B |

TABLE 48

| | Example 129 | Example 130 | Example 131 | Example 132 |
|---|---|---|---|---|
| Liquid crystal | Liquid crystal | Liquid crystal | Liquid crystal | Liquid crystal |
| composition | composition 33 | composition 33 | composition 33 | composition 33 |
| Polymerizable | Polymerizable | Polymerizable | Polymerizable | Polymerizable |
| liquid crystal | liquid crystal | liquid crystal | liquid crystal | liquid crystal |
| composition of | composition 14 | composition 15 | composition 8 | composition 8 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 16 | composition 17 | composition 18 |
| the second | | | | |
| retardation film | | | | |
| VHR | 99.2 | 89.9 | 99.4 | 99.1 |
| ID | 48 | 74 | 36 | 65 |
| Burn-in | A | B | A | A |

In the liquid crystal display devices of Examples 121 to 132, the high VHR and low ID were realized. Also, the residual image was not generated even in the evaluation of burn-in or the residual image was generated extremely less, which was an acceptable level, even if the residual image was generated.

### Examples 133 to 140

liquid crystal display devices, of Examples 13.3 to 140 were fabricated in the same manner as in Example 1 except that the liquid crystal composition and the polymerizable liquid crystal composition shown in the following tables were used, and the VHR and ID were measured. Also, the burn-in of the obtained liquid crystal display devices was evaluated. The results are shown in the following tables.

TABLE 49
Liquid crystal composition 34

| | |
|---|---|
| TNI/° C. | 76.3 |
| Δn | 0.106 |
| Δε | −3.0 |
| η/mPa · s | 16.6 |
| γ1/mPa · s | 106 |
| γ1/Δn2 × 10−2 | 95 |
| 3-Cy-Cy-2 | 17% |
| 3-Cy-Ph—Ph-2 | 12% |
| 3-Cy-1O—Ph5—O1 | 11% |
| 3-Cy-1O—Ph5—O2 | 17% |
| 3-Nd—Ph5—Ph-2 | 4% |
| 3-Cy-Cy-V | 5% |
| 3-Cy-Cy-V1 | 10% |
| V-Cy-Ph—Ph-3 | 12% |
| V-Cy-Cy-1O—Ph5—O3 | 12% |

Liquid crystal composition 35

| | |
|---|---|
| TNI/° C. | 76.6 |
| Δn | 0.109 |
| Δε | −3.2 |
| η/mPa · s | 13.9 |
| γ1/mPa · s | 95 |
| γ1/Δn2 × 10−2 | 80 |
| 1V-Cy-1O—Ph5—O2 | 12% |
| 1V-Cy-Cy-1O—Ph5—O2 | 12% |
| 3-Cy-1O—Ph5—O2 | 2% |
| 2-Cy-Cy-1O—Ph5—O2 | 5% |
| 3-Cy-Cy-1O—Ph5—O2 | 4% |
| 3-Cy-Ph—Ph5—O2 | 4% |
| 3-Cy-Cy-V | 38% |
| 3-Cy-Cy-V1 | 3% |
| 3-Ph—Ph-1 | 3% |
| V2—Ph—Ph5—Ph—2V | 12% |
| 1V2—Ph—Ph5—Ph2—V1 | 5% |

TABLE 50

| | Example 133 | Example 134 | Example 135 | Example 136 |
|---|---|---|---|---|
| Liquid crystal | Liquid crystal | Liquid crystal | Liquid crystal | Liquid crystal |
| composition | composition 34 | composition 34 | composition 34 | composition 34 |
| Polymerizable | Polymerizable | Polymerizable | Polymerizable | Polymerizable |
| liquid crystal | liquid crystal | liquid crystal | liquid crystal | liquid crystal |
| composition of | composition 3 | composition 4 | composition 13 | composition 13 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 16 | composition 16 | composition 19 | composition 20 |
| the second | | | | |
| retardation film | | | | |
| VHR | 99.2 | 99.1 | 99.5 | 99.3 |
| ID | 49 | 66 | 29 | 40 |
| Burn-in | A | B | A | A |

TABLE 51

| | Example 137 | Example 138 | Example 139 | Example 140 |
|---|---|---|---|---|
| Liquid crystal | Liquid crystal | Liquid crystal | Liquid crystal | Liquid crystal |
| composition | composition 35 | composition 35 | composition 35 | composition 35 |
| Polymerizable | Polymerizable | Polymerizable | Polymerizable | Polymerizable |
| liquid crystal | liquid crystal | liquid crystal | liquid crystal | liquid crystal |
| composition of | composition 22 | composition 8 | composition 15 | composition 24 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 12 | composition 11 | composition 16 |
| the second | | | | |
| retardation film | | | | |
| VHR | 99.4 | 99.3 | 99.1 | 99.0 |
| ID | 34 | 42 | 60 | 71 |
| Burn-in | A | A | B | B |

In the liquid crystal display devices of Examples 133 to 140, the high VHR and low ID were realized. Also, the residual image was not generated even in the evaluation of burn-in or the residual image was generated extremely less, which was an acceptable level, even if the residual image was generated.

### Examples 141 to 149

Liquid crystal display devices of Examples 141 to 149 were fabricated in the same manner as in Example 1 except that the liquid crystal composition and the polymerizable liquid crystal composition shown in the following tables were used and an optical alignment film (6) using the optical alignment material was used instead of the alignment film for a retardation film (6) which has been rubbed, and the VHR and ID were measured. Also, the burn-in of the obtained liquid crystal display devices was evaluated. The results are shown in the following tables.

In addition, the optical alignment film was fabricated according to the following method. The photo-alignment agent composition for a retardation film was applied to the optically transparent substrate using a spin coater and then pre-baked on a hot plate for 120 seconds at a temperature of 80° C. to form a coating film having a film thickness of 0.1 μm. This film was post-baked in an oven for 1 hour at a temperature of 200° C. to for a cured film. In a case of the photo-alignment agent compositions for a retardation film 1 and 2, the cured film was irradiated with 300 J/m² of a linearly polarized light of 313 nm. In a case of the photo-alignment agent composition for a retardation film 3, the cured film was irradiated with 300 J/m² of a linearly polarized light of 300 nm.

TABLE 52

| | Example 141 | Example 142 | Example 143 |
|---|---|---|---|
| Liquid crystal | Liquid crystal | Liquid crystal | Liquid crystal |
| composition | composition 5 | composition 8 | composition 16 |
| Photo-alignment | Photo-alignment agent | Photo-alignment agent | Photo-alignment agent |
| agent composition | composition 1 | composition 1 | composition 1 |
| for retardation film | | | |
| Polymerizable | Polymerizable | Polymerizable | Polymerizable |
| liquid crystal | liquid crystal | liquid crystal | liquid crystal |
| composition of | composition 3 | composition 8 | composition 13 |
| the first | | | |
| retardation film | | | |
| Polymerizable | Polymerizable | Polymerizable | Polymerizable |
| liquid crystal | liquid crystal | liquid crystal | liquid crystal |
| composition of | composition 5 | composition 10 | composition 19 |
| the second | | | |
| retardation film | | | |
| VHR | 99.1 | 99.4 | 99.4 |
| ID | 49 | 24 | 28 |
| Burn-in | A | A | A |

TABLE 53

| | Example 144 | Example 145 | Example 146 |
|---|---|---|---|
| Liquid crystal | Liquid crystal | Liquid crystal | Liquid crystal |
| composition | composition 5 | composition 8 | composition 16 |
| Photo-alignment | Photo-alignment agent | Photo-alignment agent | Photo-alignment agent |
| agent composition | composition 2 | composition 2 | composition 2 |
| for retardation film | | | |
| Polymerizable | Polymerizable | Polymerizable | Polymerizable |
| liquid crystal | liquid crystal | liquid crystal | liquid crystal |
| composition of | composition 3 | composition 8 | composition 13 |
| the first | | | |
| retardation film | | | |
| Polymerizable | Polymerizable | Polymerizable | Polymerizable |
| liquid crystal | liquid crystal | liquid crystal | liquid crystal |
| composition of | composition 5 | composition 10 | composition 19 |
| the second | | | |
| retardation film | | | |
| VHR | 99.3 | 99.4 | 99.1 |
| ID | 49 | 25 | 27 |
| Burn-in | A | A | A |

TABLE 54

| | Example 147 | Example 148 | Example 149 |
|---|---|---|---|
| Liquid crystal | Liquid crystal | Liquid crystal | Liquid crystal |
| composition | composition 5 | composition 8 | composition 16 |
| Photo-alignment | Photo-alignment agent | Photo-alignment agent | Photo-alignment agent |
| agent composition | composition 3 | composition 3 | composition 3 |
| for retardation film | | | |
| Polymerizable | Polymerizable | Polymerizable | Polymerizable |
| liquid crystal | liquid crystal | liquid crystal | liquid crystal |
| composition of | composition 3 | composition 8 | composition 13 |
| the first | | | |
| retardation film | | | |
| Polymerizable | Polymerizable | Polymerizable | Polymerizable |
| liquid crystal | liquid crystal | liquid crystal | liquid crystal |
| composition of | composition 5 | composition 10 | composition 19 |
| the second | | | |
| retardation film | | | |
| VHR | 99.2 | 99.3 | 99.1 |
| ID | 48 | 26 | 29 |
| Burn-in | A | A | A |

In the liquid crystal display devices of Examples 141 to 149, the high VHR and low ID were realised. Also, the residual image was not generated even, in the evaluation of burn-in or the residual image was generated extremely less, which was an acceptable level, even if the residual image was generated.

### Comparative Examples 1 to 4

Liquid crystal display devices of Comparative Examples 1 to 4 were fabricated in the same manner as in Example 1 except that the liquid crystal composition and the polymerizable liquid crystal composition shown, in the following tables were used, and the VHR and ID were measured. Also, the burn-in of the obtained liquid crystal display devices was evaluated. The results are shown in the following tables.

[Chem. 71]
Comparative liquid
crystal composition 1

| | |
|---|---|
| 3-Cy-Cy-2 | 4% |
| 3-Cy-Cy-4 | 4% |
| 3-Cy-Ph5—O2 | 7% |
| 3-Cy-Ph5—O4 | 8% |
| 2-Cy-Ph—Ph5—O2 | 4% |
| 3-Cy-Ph—Ph5—O2 | 5% |
| 3-Cy-Cy-Ph5—O3 | 8% |
| 4-Cy-Cy-Ph5—O2 | 10% |
| 5-Cy-Cy-Ph5—O2 | 8% |
| 3-Ph—Ph5—Ph-2 | 4% |
| 4-Ph—Ph5—Ph-2 | 4% |
| 5-Ph—Ph-1 | 25% |
| 3-Cy-Cy-Ph-1 | 9% |

Comparative liquid
crystal composition 2

| | |
|---|---|
| 3-Cy-Cy-2 | 4% |
| 3-Cy-Cy-4 | 4% |
| 3-Cy-Ph5—O2 | 7% |
| 3-Cy-Ph5—O4 | 8% |
| 2-Cy-Ph—Ph5—O2 | 5% |
| 3-Cy-Ph—Ph5—O2 | 6% |
| 3-Cy-Cy-Ph5—O3 | 7% |
| 4-Cy-Cy-Ph5—O2 | 9% |
| 5-Cy-Cy-Ph5—O2 | 7% |
| 3-Ph—Ph5—Ph-2 | 4% |
| 4-Ph—Ph5—Ph-2 | 4% |
| 5-Ph—Ph-1 | 22% |
| 3-Cy-Cy-Ph-1 | 13% |

Comparative liquid
crystal composition 3

| | |
|---|---|
| 3-Cy-Cy-2 | 4% |
| 3-Cy-Cy-4 | 4% |
| 3-Cy-Ph5—O2 | 7% |
| 3-Cy-Ph5—O4 | 8% |
| 2-Cy-Ph—Ph5—O2 | 6% |
| 3-Cy-Ph—Ph5—O2 | 7% |
| 3-Cy-Cy-Ph5—O3 | 7% |
| 4-Cy-Cy-Ph5—O2 | 7% |
| 5-Cy-Cy-Ph5—O2 | 7% |
| 3-Ph—Ph5—Ph-2 | 4% |
| 4-Ph—Ph5—Ph-2 | 4% |
| 5-Ph—Ph-1 | 19% |
| 3-Cy-Cy-Ph-1 | 16% |

TABLE 55

| | Comparative | Comparative | Comparative | Comparative |
|---|---|---|---|---|
| | Example 1 | Example 2 | Example 3 | Example 4 |
| Liquid crystal | Comparative | Comparative | Comparative | Comparative |
| composition | liquid crystal | liquid crystal | liquid crystal | liquid crystal |
| | composition 1 | composition 1 | composition 1 | composition 1 |
| Polymerizable | Polymerizable | Polymerizable | Polymerizable | Polymerizable |
| liquid crystal | liquid crystal | liquid crystal | liquid crystal | liquid crystal |
| composition of | composition 1 | composition 2 | composition 3 | composition 4 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 5 | composition 9 | composition 5 | composition 5 |
| the second | | | | |
| retardation film | | | | |
| VHR | 98.4 | 98.5 | 98.2 | 98.2 |
| ID | 124 | 114 | 133 | 146 |
| Burn-in | C | C | D | D |

TABLE 56

| | Comparative | Comparative | Comparative | Comparative |
|---|---|---|---|---|
| | Example 5 | Example 6 | Example 7 | Example 8 |
| Liquid crystal | Comparative | Comparative | Comparative | Comparative |
| composition | liquid crystal | liquid crystal | liquid crystal | liquid crystal |
| | composition 2 | composition 2 | composition 2 | composition 2 |
| Polymerizable | Polymerizable | Polymerizable | Polymerizable | Polymerizable |
| liquid crystal | liquid crystal | liquid crystal | liquid crystal | liquid crystal |
| composition of | composition 1 | composition 2 | composition 3 | composition 4 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 5 | composition 9 | composition 5 | composition 5 |
| the second | | | | |
| retardation film | | | | |
| VHR | 98.3 | 98.4 | 98.3 | 98.2 |
| ID | 126 | 120 | 131 | 147 |
| Burn-in | C | C | D | D |

TABLE 57

| | Comparative | Comparative | Comparative | Comparative |
|---|---|---|---|---|
| | Example 9 | Example 10 | Example 11 | Example 12 |
| Liquid crystal | Comparative | Comparative | Comparative | Comparative |
| composition | liquid crystal | liquid crystal | liquid crystal | liquid crystal |
| | composition 3 | composition 3 | composition 3 | composition 3 |
| Polymerizable | Polymerizable | Polymerizable | Polymerizable | Polymerizable |
| liquid crystal | liquid crystal | liquid crystal | liquid crystal | liquid crystal |
| composition of | composition 1 | composition 2 | composition 3 | composition 4 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 5 | composition 9 | composition 5 | composition 5 |
| the second | | | | |
| retardation film | | | | |
| VHR | 98.4 | 98.5 | 98.2 | 98.2 |
| ID | 164 | 145 | 131 | 137 |
| Burn-in | C | C | C | D |

The liquid crystal display devices of Comparative Examples 5 to 12 had a lower VHR and a higher ID compared to those of the liquid crystal display device of the present invention. Also, it is recognized that a residual image was generated even in the evaluation of burn-in, which was not an acceptable level.

### Comparative Examples 13 to 24

Liquid crystal display devices of Comparative Examples 13 to 24 were fabricated in the same manner as in Example 1 except that the liquid crystal composition and the polymerizable liquid crystal composition shown in the following tables were used, and the VHR and ID were measured. Also, the burn-in of the obtained liquid crystal display devices was evaluated. The results are shown in the following tables.

TABLE 58
Comparative liquid
crystal composition 4

| | |
|---|---|
| T_{NI}/° C. | 73.6 |
| Δn | 0.099 |
| Δε | −2.15 |
| η/mPa · s | 17.7 |
| γ₁/mPa · s | 104 |
| γ₁/Δn² × 10⁻² | 106 |
| 3-Cy-Cy-2 | 20% |
| 3-Cy-Cy-4 | 12% |
| 3-Cy-Cy-5 | 7% |
| 3-Cy-Ph—O1 | 12% |
| 3-Cy-Ph5—O2 | 5% |
| 3-Cy-Ph5—O4 | 5% |
| 2-Cy-Ph—Ph5—O2 | 11% |
| 3-Cy-Ph—Ph5—O2 | 11% |
| 3-Cy-Cy-Ph5—O3 | 3% |
| 4-Cy-Cy-Ph5—O2 | 3% |
| 5-Cy-Cy-Ph5—O2 | 3% |
| 3-Ph—Ph5—Ph-2 | 4% |
| 4-Ph—Ph5—Ph-2 | 4% |

Comparative liquid
crystal composition 5

| | |
|---|---|
| T_{NI}/° C. | 80.9 |
| Δn | 0.094 |
| Δε | −2.16 |
| η/mPa · s | 17.0 |
| γ₁/mPa · s | 97 |
| γ₁/Δn² × 10⁻² | 109 |
| 3-Cy-Cy-2 | 24% |
| 3-Cy-Cy-4 | 12% |
| 3-Cy-Cy-5 | 15% |
| 3-Cy-Ph5—O2 | 5% |
| 3-Cy-Ph5—O4 | 5% |
| 2-Cy-Ph—Ph5—O2 | 11% |
| 3-Cy-Ph—Ph5—O2 | 11% |
| 3-Cy-Cy-Ph5—O3 | 3% |
| 4-Cy-Cy-Ph5—O2 | 3% |
| 5-Cy-Cy-Ph5—O2 | 3% |
| 3-Ph—Ph5—Ph-2 | 4% |
| 4-Ph—Ph5—Ph-2 | 4% |

Comparative liquid
crystal composition 6

| | |
|---|---|
| T_{NI}/° C. | 84.7 |
| Δn | 0.085 |
| Δε | −2.13 |
| η/mPa · s | 17.5 |
| γ₁/mPa · s | 98 |
| γ₁/Δn² × 10⁻² | 136 |
| 3-Cy-Cy-2 | 21% |
| 3-Cy-Cy-4 | 15% |
| 3-Cy-Cy-5 | 15% |
| 3-Cy-Ph5—O2 | 5% |
| 3-Cy-Ph5—O4 | 5% |
| 2-Cy-Ph—Ph5—O2 | 4% |
| 3-Cy-Ph—Ph5—O2 | 5% |
| 3-Cy-Cy-Ph5—O3 | 7% |
| 4-Cy-Cy-Ph5—O2 | 8% |
| 5-Cy-Cy-Ph5—O2 | 7% |
| 3-Ph—Ph5—Ph-2 | 4% |
| 4-Ph—Ph5—Ph-2 | 4% |

TABLE 59

| | Comparative | Comparative | Comparative | Comparative |
|---|---|---|---|---|
| | Example 13 | Example 14 | Example 15 | Example 16 |
| Liquid crystal | Comparative | Comparative | Comparative | Comparative |
| composition | liquid crystal | liquid crystal | liquid crystal | liquid crystal |
| | composition 4 | composition 4 | composition 4 | composition 4 |
| Polymerizable | Polymerizable | Polymerizable | Polymerizable | Polymerizable |
| liquid crystal | liquid crystal | liquid crystal | liquid crystal | liquid crystal |
| composition of | composition 6 | composition 7 | composition 8 | composition 1 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 9 | composition 9 | composition 10 | composition 11 |
| the second | | | | |
| retardation film | | | | |
| VHR | 98.3 | 98.2 | 98.3 | 98.1 |
| ID | 129 | 140 | 134 | 144 |
| Burn-in | C | D | C | D |

TABLE 60

| | Comparative | Comparative | Comparative | Comparative |
|---|---|---|---|---|
| | Example 17 | Example 18 | Example 19 | Example 20 |
| Liquid crystal | Comparative | Comparative | Comparative | Comparative |
| composition | liquid crystal | liquid crystal | liquid crystal | liquid crystal |
| | composition 5 | composition 5 | composition 5 | composition 5 |
| Polymerizable | Polymerizable | Polymerizable | Polymerizable | Polymerizable |
| liquid crystal | liquid crystal | liquid crystal | liquid crystal | liquid crystal |
| composition of | composition 6 | composition 7 | composition 8 | composition 1 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 9 | composition 9 | composition 10 | composition 11 |
| the second | | | | |
| retardation film | | | | |
| VHR | 98.5 | 98.2 | 98.4 | 98.1 |
| ID | 118 | 135 | 130 | 148 |
| Burn-in | C | C | C | D |

TABLE 61

| | Comparative | Comparative | Comparative | Comparative |
|---|---|---|---|---|
| | Example 21 | Example 22 | Example 23 | Example 24 |
| Liquid crystal | Comparative | Comparative | Comparative | Comparative |
| composition | liquid crystal | liquid crystal | liquid crystal | liquid crystal |
| | composition 6 | composition 6 | composition 6 | composition 6 |
| Polymerizable | Polymerizable | Polymerizable | Polymerizable | Polymerizable |
| liquid crystal | liquid crystal | liquid crystal | liquid crystal | liquid crystal |
| composition of | composition 6 | composition 7 | composition 8 | composition 1 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 9 | composition 9 | composition 10 | composition 11 |
| the second | | | | |
| retardation film | | | | |
| VHR | 98.4 | 98.3 | 98.3 | 98.2 |
| ID | 127 | 145 | 138 | 152 |
| Burn-in | C | D | C | D |

The liquid crystal display devices of Comparative Examples 13 to 24 had a lower VHR and a higher ID compared to those of the liquid crystal display device of the present invention. Also, it is recognized that a residual image was generated even in the evaluation of burn-in, which was not an acceptable level.

### Comparative Examples 25 to 36

Liquid crystal display devices of Comparative Examples 25 to 36 were fabricated in the same manner as in Example 1 except that the liquid crystal composition and the polymerizable liquid crystal composition shown in the following tables were used, and the VHR and ID were measured. Also, the burn-in of the obtained liquid crystal display devices was evaluated. The results are shown in the following tables.

TABLE 62
Comparative liquid
crystal composition 7

| | |
|---|---|
| 3-Cy-Cy-2 | 28% |
| 3-Cy-Cy-4 | 10% |
| 3-Cy-Ph—O1 | 7% |
| 2-Cy-Ph5—O2 | 2% |
| 3-Cy-Ph5—O4 | 2% |
| 2-Cy-Ph—Ph5—O2 | 5% |
| 3-Cy-Ph—Ph5—O2 | 5% |
| 3-Cy-Cy-Ph5—O3 | 5% |
| 4-Cy-Cy-Ph5—O2 | 5% |
| 5-Cy-Cy-Ph5—O2 | 5% |
| 3-Ph—Ph5—Ph-2 | 2% |
| 4-Ph—Ph5—Ph-2 | 2% |
| 5-Ph—Ph-1 | 22% |

Comparative liquid
crystal composition 8

| | |
|---|---|
| 3-Cy-Cy-2 | 25% |
| 3-Cy-Cy-4 | 9% |
| 3-Cy-Ph—O1 | 6% |
| 2-Cy-Ph5—O2 | 2% |
| 3-Cy-Ph5—O4 | 2% |
| 2-Cy-Ph—Ph5—O2 | 5% |
| 3-Cy-Ph—Ph5—O2 | 5% |
| 3-Cy-Cy-Ph5—O3 | 5% |
| 4-Cy-Cy-Ph5—O2 | 5% |
| 5-Cy-Cy-Ph5—O2 | 5% |
| 3-Ph—Ph5—Ph-2 | 2% |
| 4-Ph—Ph5—Ph-2 | 2% |
| 5-Ph—Ph-1 | 19% |
| 3-Cy-Cy-Ph-1 | 8% |

Comparative liquid
crystal composition 9

| | |
|---|---|
| 3-Cy-Cy-2 | 28% |
| 3-Cy-Cy-4 | 8% |
| 3-Cy-Ph—O1 | 7% |
| 2-Cy-Ph5—O2 | 2% |
| 3-Cy-Ph5—O4 | 2% |
| 2-Cy-Ph—Ph5—O2 | 5% |
| 3-Cy-Ph—Ph5—O2 | 5% |
| 3-Cy-Cy-Ph5—O3 | 5% |
| 4-Cy-Cy-Ph5—O2 | 5% |
| 5-Cy-Cy-Ph5—O2 | 5% |
| 3-Ph—Ph5—Ph-2 | 2% |
| 4-Ph—Ph5—Ph-2 | 2% |
| 5-Ph—Ph-1 | 15% |
| 3-Cy-Cy-Ph-1 | 9% |

TABLE 63

| | Comparative | Comparative | Comparative | Comparative |
|---|---|---|---|---|
| | Example 25 | Example 26 | Example 27 | Example 28 |
| Liquid crystal | Comparative | Comparative | Comparative | Comparative |
| composition | liquid crystal | liquid crystal | liquid crystal | liquid crystal |
| | composition 7 | composition 7 | composition 7 | composition 7 |
| Polymerizable | Polymerizable | Polymerizable | Polymerizable | Polymerizable |
| liquid crystal | liquid crystal | liquid crystal | liquid crystal | liquid crystal |
| composition of | composition 14 | composition 15 | composition 8 | composition 8 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 16 | composition 17 | composition 18 |
| the second | | | | |
| retardation film | | | | |
| VHR | 98.2 | 98.1 | 98.3 | 98.1 |
| ID | 136 | 146 | 129 | 144 |
| Burn-in | C | D | C | D |

TABLE 64

| | Comparative | Comparative | Comparative | Comparative |
|---|---|---|---|---|
| | Example 29 | Example 30 | Example 31 | Example 32 |
| Liquid crystal | Comparative | Comparative | Comparative | Comparative |
| composition | liquid crystal | liquid crystal | liquid crystal | liquid crystal |
| | composition 8 | composition 8 | composition 8 | composition 8 |
| Polymerizable | Polymerizable | Polymerizable | Polymerizable | Polymerizable |
| liquid crystal | liquid crystal | liquid crystal | liquid crystal | liquid crystal |
| composition of | composition 14 | composition 15 | composition 8 | composition 8 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 16 | composition 17 | composition 18 |
| the second | | | | |
| retardation film | | | | |
| VHR | 98.4 | 98.1 | 98.5 | 98.3 |
| ID | 114 | 149 | 109 | 127 |
| Burn-in | C | D | C | C |

TABLE 65

| | Comparative | Comparative | Comparative | Comparative |
|---|---|---|---|---|
| | Example 33 | Example 34 | Example 35 | Example 36 |
| Liquid crystal | Comparative | Comparative | Comparative | Comparative |
| composition | liquid crystal | liquid crystal | liquid crystal | liquid crystal |
| | composition 9 | composition 9 | composition 9 | composition 9 |
| Polymerizable | Polymerizable | Polymerizable | Polymerizable | Polymerizable |
| liquid crystal | liquid crystal | liquid crystal | liquid crystal | liquid crystal |
| composition of | composition 14 | composition 15 | composition 8 | composition 8 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 16 | composition 17 | composition 18 |
| the second | | | | |
| retardation film | | | | |
| VHR | 98.5 | 98.2 | 98.5 | 98.3 |
| ID | 111 | 134 | 106 | 125 |
| Burn-in | C | D | C | C |

The liquid crystal display devices of Comparative Examples 25 to 36 had a lower VHR and a higher ID compared to those of the liquid crystal display device of the present invention. Also, it is recognized that a residual image was generated even in the evaluation of burn-in, which was not an acceptable level.

### Comparative Examples 37 to 44

Liquid crystal display devices of Comparative Examples 37 to 54 were fabricated in the same manner as in Example 1 except that the liquid crystal composition and the polymerizable liquid crystal composition shown in the following tables were used, and the VHR and ID were measured. Also, the burn-in of the obtained liquid crystal display devices was evaluated. The results are shown in the following tables.

TABLE 66
Comparative liquid
crystal composition 10

| | |
|---|---|
| 3-Cy-Cy-2 | 10% |
| 3-Cy-Cy-4 | 3% |
| 3-Cy-Cy-5 | 2% |
| 3-Cy-Ph—O1 | 2% |
| 2-Cy-Ph5—O2 | 16% |
| 3-Cy-Ph5—O4 | 16% |
| 2-Cy-Ph—Ph5—O2 | 12% |
| 3-Cy-Ph—Ph5—O2 | 11% |
| 3-Cy-Cy-Ph5—O3 | 9% |
| 4-Cy-Cy-Ph5—O2 | 9% |
| 5-Cy-Cy-Ph5—O2 | 9% |
| 3-Cy-Cy-Ph-1 | 1% |

Comparative liquid
crystal composition 11

| | |
|---|---|
| 3-Cy-Cy-4 | 11% |
| 3-Cy-Cy-5 | 5% |
| 2-Cy-Ph5—O2 | 16% |
| 3-Cy-Ph5—O4 | 16% |
| 2-Cy-Ph—Ph5—O2 | 12% |
| 3-Cy-Ph—Ph5—O2 | 12% |
| 3-Cy-Cy-Ph5—O3 | 9% |
| 4-Cy-Cy-Ph5—O2 | 9% |
| 5-Cy-Cy-Ph5—O2 | 8% |
| 3-Cy-Cy-Ph-1 | 2% |

TABLE 67

| | Comparative | Comparative | Comparative | Comparative |
|---|---|---|---|---|
| | Example 37 | Example 38 | Example 39 | Example 40 |
| Liquid crystal | Comparative | Comparative | Comparative | Comparative |
| composition | liquid crystal | liquid crystal | liquid crystal | liquid crystal |
| | composition 10 | composition 10 | composition 10 | composition 10 |
| Polymerizable | Polymerizable | Polymerizable | Polymerizable | Polymerizable |
| liquid crystal | liquid crystal | liquid crystal | liquid crystal | liquid crystal |
| composition of | composition 3 | composition 4 | composition 13 | composition 13 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 16 | composition 16 | composition 19 | composition 20 |
| the second | | | | |
| retardation film | | | | |
| VHR | 98.3 | 98.3 | 98.5 | 98.4 |
| ID | 136 | 139 | 113 | 128 |
| Burn-in | D | D | C | C |

TABLE 68

| | Comparative | Comparative | Comparative | Comparative |
|---|---|---|---|---|
| | Example 41 | Example 42 | Example 43 | Example 44 |
| Liquid crystal | Comparative | Comparative | Comparative | Comparative |
| composition | liquid crystal | liquid crystal | liquid crystal | liquid crystal |
| | composition 11 | composition 11 | composition 11 | composition 11 |
| Polymerizable | Polymerizable | Polymerizable | Polymerizable | Polymerizable |
| liquid crystal | liquid crystal | liquid crystal | liquid crystal | liquid crystal |
| composition of | composition 3 | composition 4 | composition 13 | composition 13 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 16 | composition 16 | composition 19 | composition 20 |
| the second | | | | |
| retardation film | | | | |
| VHR | 98.4 | 98.2 | 98.6 | 98.5 |
| ID | 128 | 142 | 101 | 114 |
| Burn-in | C | D | C | C |

The liquid crystal display devices of Comparative Examples 37 to 44 had a lower VHR and a higher ID compared to those of the liquid crystal display device of the present invention. Also, it is recognized that a residual image was generated even in the evaluation of burn-in, which was not an acceptable level.

### Comparative Examples 45 to 56

Liquid crystal display devices of Comparative Examples 45 to 56 were fabricated in the same manner as in Example 1 except that the liquid crystal composition and the polymerizable liquid crystal composition shown in the following tables were used, and the VHR and ID were measured. Also, the burn-in of the obtained liquid crystal display devices was evaluated. The results are shown, in the following tables.

TABLE 69
Comparative liquid
crystal composition 12

| | |
|---|---|
| 3-Cy-Cy-2 | 25% |
| 3-Cy-Cy-4 | 12% |
| 3-Cy-Cy-5 | 7% |
| 3-Cy-Ph—O1 | 11% |
| 2-Cy-Ph5—O2 | 5% |
| 3-Cy-Ph5—O4 | 5% |
| 2-Cy-Ph—Ph5—O2 | 4% |
| 3-Cy-Ph—Ph5—O2 | 4% |
| 3-Cy-Cy-Ph5—O3 | 2% |
| 4-Cy-Cy-Ph5—O2 | 2% |
| 5-Cy-Cy-Ph5—O2 | 2% |
| 3-Ph—Ph5—Ph-2 | 5% |
| 4-Ph—Ph5—Ph-2 | 5% |
| 3-Cy-Cy-Ph-1 | 11% |

Comparative liquid
crystal composition 13

| | |
|---|---|
| 3-Cy-Cy-2 | 27% |
| 3-Cy-Cy-4 | 12% |
| 3-Cy-Cy-5 | 6% |
| 3-Cy-Ph—O1 | 9% |
| 2-Cy-Ph5—O2 | 5% |
| 3-Cy-Ph5—O4 | 5% |
| 2-Cy-Ph—Ph5—O2 | 4% |
| 3-Cy-Ph—Ph5—O2 | 3% |
| 3-Cy-Cy-Ph5—O3 | 3% |
| 4-Cy-Cy-Ph5—O2 | 2% |
| 5-Cy-Cy-Ph5—O2 | 2% |
| 3-Ph—Ph5—Ph-2 | 6% |
| 4-Ph—Ph5—Ph-2 | 4% |
| 3-Cy-Cy-Ph-1 | 12% |

Comparative liquid
crystal composition 14

| | |
|---|---|
| 3-Cy-Cy-2 | 30% |
| 3-Cy-Cy-4 | 12% |
| 3-Cy-Cy-5 | 9% |
| 2-Cy-Ph5—O2 | 4% |
| 3-Cy-Ph5—O4 | 4% |
| 2-Cy-Ph—Ph5—O2 | 5% |
| 3-Cy-Ph—Ph5—O2 | 5% |
| 3-Cy-Cy-Ph5—O3 | 3% |
| 4-Cy-Cy-Ph5—O2 | 3% |
| 5-Cy-Cy-Ph5—O2 | 3% |
| 3-Ph—Ph5—Ph-2 | 3% |
| 4-Ph—Ph5—Ph-2 | 3% |
| 3-Cy-Cy-Ph-1 | 16% |

TABLE 70

| | Comparative | Comparative | Comparative | Comparative |
|---|---|---|---|---|
| | Example 45 | Example 46 | Example 47 | Example 48 |
| Liquid crystal | Comparative | Comparative | Comparative | Comparative |
| composition | liquid crystal | liquid crystal | liquid crystal | liquid crystal |
| | composition 12 | composition 12 | composition 12 | composition 12 |
| Polymerizable | Polymerizable | Polymerizable | Polymerizable | Polymerizable |
| liquid crystal | liquid crystal | liquid crystal | liquid crystal | liquid crystal |
| composition of | composition 22 | composition 14 | composition 15 | composition 24 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 23 | composition 11 | composition 16 |
| the second | | | | |
| retardation film | | | | |
| VHR | 98.4 | 98.2 | 98.3 | 98.1 |
| ID | 129 | 148 | 140 | 154 |
| Burn-in | C | D | D | D |

TABLE 71

| | Comparative | Comparative | Comparative | Comparative |
|---|---|---|---|---|
| | Example 49 | Example 50 | Example 51 | Example 52 |
| Liquid crystal | Comparative | Comparative | Comparative | Comparative |
| composition | liquid crystal | liquid crystal | liquid crystal | liquid crystal |
| | composition 13 | composition 13 | composition 13 | composition 13 |
| Polymerizable | Polymerizable | Polymerizable | Polymerizable | Polymerizable |
| liquid crystal | liquid crystal | liquid crystal | liquid crystal | liquid crystal |
| composition of | composition 22 | composition 14 | composition 15 | composition 24 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 23 | composition 11 | composition 16 |
| the second | | | | |
| retardation film | | | | |
| VHR | 98.5 | 98.2 | 98.4 | 98.1 |
| ID | 116 | 143 | 127 | 159 |
| Burn-in | C | D | C | D |

TABLE 72

| | Comparative | Comparative | Comparative | Comparative |
|---|---|---|---|---|
| | Example 53 | Example 54 | Example 55 | Example 56 |
| Liquid crystal | Comparative | Comparative | Comparative | Comparative |
| composition | liquid crystal | liquid crystal | liquid crystal | liquid crystal |
| | composition 14 | composition 14 | composition 14 | composition 14 |
| Polymerizable | Polymerizable | Polymerizable | Polymerizable | Polymerizable |
| liquid crystal | liquid crystal | liquid crystal | liquid crystal | liquid crystal |
| composition of | composition 22 | composition 8 | composition 15 | composition 24 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 12 | composition 11 | composition 16 |
| the second | | | | |
| retardation film | | | | |
| VHR | 98.5 | 98.3 | 98.5 | 98. 2 |
| ID | 98 | 125 | 108 | 138 |
| Burn-in | C | C | C | D |

The liquid crystal display devices of Comparative Examples 45 to 56 had a lower VHR and a higher ID compared to those of the liquid crystal display device of the present invention. Also, it is recognized that a residual image was generated even in the evaluation of burn-in, which was not an acceptable level.

### Comparative Examples 57 to 60

Liquid crystal display devices of Comparative Examples 57 to 60 were fabricated in the same manner as in Example 1 except that the liquid crystal composition and the polymerizable liquid crystal composition shown in the following tables were used, and the VHR and ID were measured. Also, the burn-in of the obtained liquid crystal display devices was evaluated. The results are shown in the following tables.

TABLE 73
Comparative liquid crystal composition 15

| | |
|---|---|
| 3-Cy-Cy-2 | 14% |
| 3-Cy-Ph—O1 | 4% |
| 2-Cy-Ph5—O2 | 3% |
| 2-Cy-Ph—Ph5—O2 | 13% |
| 3-Cy-Ph—Ph5—O2 | 13% |
| 3-Cy-Cy-Ph5—O3 | 12% |
| 4-Cy-Cy-Ph5—O2 | 12% |
| 5-Cy-Cy-Ph5—O2 | 12% |
| 3-Ph—Ph5—Ph-2 | 8% |
| 4-Ph—Ph5—Ph-2 | 8% |
| 5-Ph—Ph-1 | 1% |

TABLE 74

| | Comparative | Comparative | Comparative | Comparative |
|---|---|---|---|---|
| | Example 57 | Example 58 | Example 59 | Example 60 |
| Liquid crystal | Comparative | Comparative | Comparative | Comparative |
| composition | liquid crystal | liquid crystal | liquid crystal | liquid crystal |
| | composition 15 | composition 15 | composition 15 | composition 15 |
| Polymerizable | Polymerizable | Polymerizable | Polymerizable | Polymerizable |
| liquid crystal | liquid crystal | liquid crystal | liquid crystal | liquid crystal |
| composition of | composition 22 | composition 8 | composition 15 | composition 24 |
| the first | | | | |
| retardation film | | | | |
| Polymerizable | Polymerizable | Polymerizable | Polymerizable | Polymerizable |
| liquid crystal | liquid crystal | liquid crystal | liquid crystal | liquid crystal |
| composition of | composition 21 | composition 12 | composition 11 | composition 16 |
| the second | | | | |
| retardation film | | | | |
| VHR | 98.4 | 98.3 | 98.3 | 98.1 |
| ID | 119 | 128 | 130 | 151 |
| Burn-in | C | C | D | D |

The liquid crystal display devices of Comparative Examples 57 to 60 had a lower VHR and a higher ID compared to those of the liquid crystal display device of the present invention. Also, it is recognized that a residual image was generated even in the evaluation of burn-in, which was not an acceptable level.

### Comparative Examples 61 to 92

Liquid crystal display devices of Comparative Examples 61 to 92 were fabricated in the same manner as in Example 1 except that the liquid crystal composition and the polymerizable liquid crystal composition shown in the following tables were used, and the VHR and ID were measured. Also, the burn-in of the obtained liquid crystal display devices was evaluated. The results are shown in the following tables.

TABLE 75

| | Comparative | Comparative | Comparative | Comparative |
|---|---|---|---|---|
| | Example 61 | Example 62 | Example 63 | Example 64 |
| Liquid crystal | Liquid crystal | Liquid crystal | Liquid crystal | Liquid crystal |
| composition | composition 1 | composition 1 | composition 1 | composition 1 |
| Polymerizable | Comparative | Comparative | Comparative | Comparative |
| liquid crystal | polymerizable | polymerizable | polymerizable | polymerizable |
| composition of | liquid crystal | liquid crystal | liquid crystal | liquid crystal |
| the first | composition 1 | composition 2 | composition 3 | composition 4 |
| retardation film | | | | |
| Polymerizable | Comparative | Comparative | Comparative | Comparative |
| liquid crystal | polymerizable | polymerizable | polymerizable | polymerizable |
| composition of | liquid crystal | liquid crystal | liquid crystal | liquid crystal |
| the second | composition 5 | composition 5 | composition 5 | composition 5 |
| retardation film | | | | |
| VHR | 98.3 | 97.8 | 98.1 | 98.0 |
| ID | 137 | 176 | 154 | 166 |
| Burn-in | C | D | D | D |

TABLE 76

| | Comparative | Comparative | Comparative | Comparative |
|---|---|---|---|---|
| | Example 65 | Example 66 | Example 67 | Example 68 |
| Liquid crystal | Liquid crystal | Liquid crystal | Liquid crystal | Liquid crystal |
| composition | composition 2 | composition 2 | composition 2 | composition 2 |
| Polymerizable | Comparative | Comparative | Comparative | Comparative |
| liquid crystal | polymerizable | polymerizable | polymerizable | polymerizable |
| composition of | liquid crystal | liquid crystal | liquid crystal | liquid crystal |
| the first | composition 1 | composition 2 | composition 3 | composition 4 |
| retardation film | | | | |
| Polymerizable | Comparative | Comparative | Comparative | Comparative |
| liquid crystal | polymerizable | polymerizable | polymerizable | polymerizable |
| composition of | liquid crystal | liquid crystal | liquid crystal | liquid crystal |
| the second | composition 5 | composition 5 | composition 5 | composition 5 |
| retardation film | | | | |
| VHR | 98.3 | 98.0 | 98.3 | 98.1 |
| ID | 128 | 158 | 132 | 147 |
| Burn-in | C | D | C | D |

TABLE 77

| | Comparative | Comparative | Comparative | Comparative |
|---|---|---|---|---|
| | Example 69 | Example 70 | Example 71 | Example 72 |
| Liquid crystal | Liquid crystal | Liquid crystal | Liquid crystal | Liquid crystal |
| composition | composition 3 | composition 3 | composition 3 | composition 3 |
| Polymerizable | Comparative | Comparative | Comparative | Comparative |
| liquid crystal | polymerizable | polymerizable | polymerizable | polymerizable |
| composition of | liquid crystal | liquid crystal | liquid crystal | liquid crystal |
| the first | composition 6 | composition 7 | composition 8 | composition 1 |
| retardation film | | | | |
| Polymerizable | Comparative | Comparative | Comparative | Comparative |
| liquid crystal | polymerizable | polymerizable | polymerizable | polymerizable |
| composition of | liquid crystal | liquid crystal | liquid crystal | liquid crystal |
| the second | composition 9 | composition 9 | composition 10 | composition 11 |
| retardation film | | | | |
| VHR | 97.9 | 98.1 | 98.0 | 98.2 |
| ID | 157 | 144 | 150 | 138 |
| Burn-in | D | D | D | C |

TABLE 78

| | Comparative | Comparative | Comparative | Comparative |
|---|---|---|---|---|
| | Example 73 | Example 74 | Example 75 | Example 76 |
| Liquid crystal | Liquid crystal | Liquid crystal | Liquid crystal | Liquid crystal |
| composition | composition 8 | composition 8 | composition 8 | composition 8 |
| Polymerizable | Comparative | Comparative | Comparative | Comparative |
| liquid crystal | polymerizable | polymerizable | polymerizable | polymerizable |
| composition of | liquid crystal | liquid crystal | liquid crystal | liquid crystal |
| the first | composition 6 | composition 7 | composition 8 | composition 1 |
| retardation film | | | | |
| Polymerizable | Comparative | Comparative | Comparative | Comparative |
| liquid crystal | polymerizable | polymerizable | polymerizable | polymerizable |
| composition of | liquid crystal | liquid crystal | liquid crystal | liquid crystal |
| the second | composition 9 | composition 9 | composition 10 | composition 11 |
| retardation film | | | | |
| VHR | 98.1 | 98.3 | 98.3 | 98.4 |
| ID | 148 | 123 | 125 | 119 |
| Burn-in | D | D | D | C |

TABLE 79

| | Comparative | Comparative | Comparative | Comparative |
|---|---|---|---|---|
| | Example 77 | Example 78 | Example 79 | Example 80 |
| Liquid crystal | Liquid crystal | Liquid crystal | Liquid crystal | Liquid crystal |
| composition | composition 13 | composition 13 | composition 13 | composition 13 |
| Polymerizable | Comparative | Comparative | Comparative | Comparative |
| liquid crystal | polymerizable | polymerizable | polymerizable | polymerizable |
| composition of | liquid crystal | liquid crystal | liquid crystal | liquid crystal |
| the first | composition 8 | composition 3 | composition 4 | composition 13 |
| retardation film | | | | |
| Polymerizable | Comparative | Comparative | Comparative | Comparative |
| liquid crystal | polymerizable | polymerizable | polymerizable | polymerizable |
| composition of | liquid crystal | liquid crystal | liquid crystal | liquid crystal |
| the second | composition 12 | composition 16 | composition 16 | composition 17 |
| retardation film | | | | |
| VHR | 98.4 | 98.2 | 98.2 | 98.3 |
| ID | 131 | 144 | 149 | 139 |
| Burn-in | D | D | D | D |

TABLE 80

| | Comparative | Comparative | Comparative | Comparative |
|---|---|---|---|---|
| | Example 81 | Example 82 | Example 83 | Example 84 |
| Liquid crystal | Liquid crystal | Liquid crystal | Liquid crystal | Liquid crystal |
| composition | composition 14 | composition 14 | composition 14 | composition 14 |
| Polymerizable | Comparative | Comparative | Comparative | Comparative |
| liquid crystal | polymerizable | polymerizable | polymerizable | polymerizable |
| composition of | liquid crystal | liquid crystal | liquid crystal | liquid crystal |
| the first | composition 8 | composition 3 | composition 4 | composition 13 |
| retardation film | | | | |
| Polymerizable | Comparative | Comparative | Comparative | Comparative |
| liquid crystal | polymerizable | polymerizable | polymerizable | polymerizable |
| composition of | liquid crystal | liquid crystal | liquid crystal | liquid crystal |
| the second | composition 12 | composition 16 | composition 16 | composition 17 |
| retardation film | | | | |
| VHR | 98.3 | 98.1 | 98.1 | 98.2 |
| ID | 122 | 136 | 142 | 130 |
| Burn-in | C | D | D | D |

TABLE 81

| | Comparative | Comparative | Comparative | Comparative |
|---|---|---|---|---|
| | Example 85 | Example 86 | Example 87 | Example 88 |
| Liquid crystal | Liquid crystal | Liquid crystal | Liquid crystal | Liquid crystal |
| composition | composition 19 | composition 19 | composition 19 | composition 19 |
| Polymerizable | Comparative | Comparative | Comparative | Comparative |
| liquid crystal | polymerizable | polymerizable | polymerizable | polymerizable |
| composition of | liquid crystal | liquid crystal | liquid crystal | liquid crystal |
| the first | composition 13 | composition 14 | composition 14 | composition 15 |
| retardation film | | | | |
| Polymerizable | Comparative | Comparative | Comparative | Comparative |
| liquid crystal | polymerizable | polymerizable | polymerizable | polymerizable |
| composition of | liquid crystal | liquid crystal | liquid crystal | liquid crystal |
| the second | composition 18 | composition 19 | composition 20 | composition 11 |
| retardation film | | | | |
| VHR | 98.0 | 98.3 | 98.3 | 98.1 |
| ID | 156 | 137 | 139 | 148 |
| Burn-in | D | D | D | D |

TABLE 82

| | Comparative | Comparative | Comparative | Comparative |
|---|---|---|---|---|
| | Example 89 | Example 90 | Example 91 | Example 92 |
| Liquid crystal | Liquid crystal | Liquid crystal | Liquid crystal | Liquid crystal |
| composition | composition 20 | composition 20 | composition 20 | composition 20 |
| Polymerizable | Comparative | Comparative | Comparative | Comparative |
| liquid crystal | polymerizable | polymerizable | polymerizable | polymerizable |
| composition of | liquid crystal | liquid crystal | liquid crystal | liquid crystal |
| the first | composition 13 | composition 14 | composition 14 | composition 15 |
| retardation film | | | | |
| Polymerizable | Comparative | Comparative | Comparative | Comparative |
| liquid crystal | polymerizable | polymerizable | polymerizable | polymerizable |
| composition of | liquid crystal | liquid crystal | liquid crystal | liquid crystal |
| the second | composition 13 | composition 19 | composition 20 | composition 11 |
| retardation film | | | | |
| VHR | 98.1 | 98.4 | 98.3 | 98.2 |
| ID | 155 | 125 | 134 | 141 |
| Burn-in | D | C | D | D |

The liquid crystal display devices of Comparative Examples 61 to 92 had a lower VHR and a higher ID compared to those of the liquid crystal display device of the present invention. Also, it is recognized that a residual image was generated even in the evaluation of burn-in, which was not an acceptable level.

1. A liquid crystal display device comprising;
a first substrate;
a second substrate;
a liquid crystal layer interposed between the first substrate and the second substrate;
a retardation film between a pair of the substrates; and
at least a pair of electrodes,
wherein the liquid crystal layer is composed of a liquid crystal composition which contains a compound represented by General Formula (I) in an amount of 10% to 50% by weight and a compound represented by General Formula (II) in an amount of 35% to 80% by weight; 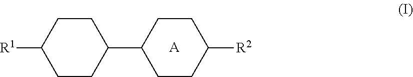
wherein R¹ and R² each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, and A represents a 1,4-phenylene group or a trans-1,4-cyclohexylene group, and 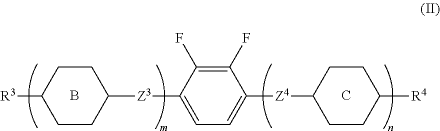
wherein R³ and R⁴ each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, Z³ and Z⁴ each independently represent a single bond, —CH═CH—, —C≡C—, —CH₂CH₂—, —(CH₂)₄—; —COO—, —OCO—, —OCH₂—, —CH₂O—, —OCF₂—, or —CF₂O—, B and C each independently represent a 1,4-phenylene group or a trans-1,4-cyclohexylene group, which may be fluorinated, and m and n each independently represent an integer of 0 to 4, and m+n=1 to 4; and
the retardation film layer is an optically anisotropic body obtained by polymerizing a polymerizable liquid crystal composition containing a liquid crystal compound having two or more polymerizable functional groups in an amount of 25% by weight or more.

2. The liquid crystal display device according to claim 1, containing a compound represented by General Formula (I), as the liquid crystal compound having two or more polymerizable functional groups:
P¹-(Sp¹)ₘ₁-MG-R¹ (1)
wherein P⁵ represents a polymerizable functional group, Sp¹ represents an alkylene group having 0 to 18 carbon atoms, the alkylene group may be substituted with one or more of a halogen atom, —CN, and an alkyl group having 1 to 8 carbon atoms having a polymerizable functional group, and one CH₂ group or two or more CH₂ groups non-adjacent to each other present in the alkylene group each independently may be substituted with —O—, —S—, —NH—, —N(CH₃)—, —CO—, —COO—, —OCO—, —OCOO—, —SCO—, —COS—, or —C≡C— as long as an oxygen atom is not directly bonded to another oxygen atom,
m1 represents 0 or 1.
MG represents a mesogenic group or a mesogenic supporting group,
R¹ represents a hydrogen atom, a halogen atom, a cyano group, or an alkyl group having 1 to 18 carbon atoms, the alkyl group may be substituted with one or more of a halogen atom or CN, and one CH₂ group present in the alkyl group or two or more CH₂ groups non-adjacent to each other each independently may be substituted with —O—, —S—, —NH—, —N(CH₃)—, —CO—, —COO—, —OCO—, —OCOO—, —SCO—, —COS—, or —C≡C— as long as an oxygen atom is not directly bonded to another oxygen atom, or R¹ represents a structure represented by General Formula (1-a):
-(Sp^{1a})ₘₐ-P^{1a} (1-a)
wherein P^{1a} represents a polymerizable functional group, Sp^{1a} represents the same meaning as the Sp¹ defined above and ma represents 0 or 1,
wherein the mesogenic group or the mesogenic supporting group represented by MG is represented by General Formula (1-b):
-Z0-(A1-Z1 )ₙ-(A2-Z2)ₗ-(A3-23)ₖ-A4-Z4-A5-Z5- (1-b)
wherein A1, A2, A3, A4, and A5 each independently represent a 1.4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decaliydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, and may have, as a substituent, one or more of F, Cl, CF₃, OCF₃, a CN group, an alkyl groups having 1 to 8 carbon atoms, an alkoxy group, an alkanoyl group, an alkanoyloxy group, an alkenyl group having 2 to 8 carbon atoms, an alkenyloxy group, an alkenoyl group, an alkenoyloxy group, and a substituent represented by General Formula (1-c):
-(A)ₙ₁-(Sp^{1c})-_{mc}P^{c} (1-c)
wherein P^{c} represents a polymerizable functional group, A represents —O—, —COO—, —OCO—, —OCH₂—, —CH₂O—, —CH₂CH₂OCO—, —COOCH₂CH₂—, —OCOCH₂CH₂—, or a single bond.
Sp^{1c} represents the same meaning as the Sp¹, n1 represents 0 or 1, and mc represents 0 or 1), Z0, Z1, Z2, Z3, Z4, and Z5 each independently represent —COO—, —OCO—, —CH₂CH₂—, —OCH₂—, —CH₂O—, —CH═CH—, —≡C—, —CH═CHCOO—, —OCOCH═CH—, —CH₂CH₂COO—, —CH₂CH₂OCO—, COOCH₂CH₂—, —OCOCH₂CH₂—, —CONH—, —NHCO—, an alkyl group having 2 to 10 carbon atoms which may have a halogen atom or a single bond, and
n, l, and k each independently represent 0 or 1 and satisfy 0≦n+l+k≦3,
with the proviso that in General Formula (1), two or more polymerizable functional groups are present.

3. The liquid crystal display device according to claim 1,
wherein the retardation film is an optically anisotropic body obtained by polymerizing a, polymerizable liquid crystal composition containing a liquid crystal compound having two polymerizable functional groups.

4. The liquid crystal display device according to claim 3, comprising a compound represented by the following General Formula (2), as the liquid crystal compound having two polymerizable functional groups,
P^{2a}-(Sp^{2a})ₘ₂-Z0-(A1-Z1)ₙ-(A2-Z2)ₗ-(A3-Z3)ₖ-A4-Z4-A5-Z5-(Sp^{2b})ₙ₂-P^{2b} (2)
wherein P^{2a} and P^{2b} represent a polymerizable functional group,
Sp^{2a} and Sp^{2b} each independently represent an alkylene group having 0 to 18 carbon atoms, the alkylene group be substituted with one or more of a halogen atom or CN, and one CH₂ group or two or more CH₂ groups non-adjacent to each other present in the alkylene group each independently may be substituted with —O—, —S—, —NH—, —N(CH₃)—, —CO—, —COO—, —OCO—, —OCOO—, —SCO—, —COS—, or —C═C— as long as an oxygen atom is not directly bonded to another oxygen atom,
m2 and n2 each independently represent 0 or 1.
n, l, and k each independently represent 0 or 1 and satisfy 0≦n+l+k≦3,
A1, A2, A3, A4, and A5 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]thiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group.
a substituent thereof represents one or more of F, Cl, CF₃, OCF₃, a CN group, an alkyl group having 1 to 8 carbon atoms, an alkoxy group, an alkanoyl group, an alkanoyloxy group, an alkenyl group having 2 to 8 carton atoms, an alkenyloxy group, an alkenoyl group, or an alkenoyloxy group,
Z0, Z1, Z2, Z3, Z4, and Z5 each independently represent —COO—, —OCO—, —CH₂CH₂—, ——OCH₂—, —CH₂O—, —CH═CH—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group having 2 so 10carbon atoms which may have a halogen atom or a single bond, and
n2b, k2b, and l2b each independently represent 0 or 1 and satisfy 0≦n+l+k≦3.

5. The liquid crystal display device according to claim 1,
wherein the polymerizable liquid crystal composition further contains a liquid crystal compound having one polymerizable functional group, and the retardation film is an optically anisotropic body obtained by polymerizing the polymerizable liquid crystal composition.

6. The liquid crystal display device according to claim 5,
wherein the liquid crystal compound having one polymerizable functional group is included in the polymerizable liquid crystal composition in the amount of 5% to 75% by weight.

7. The liquid crystal display device according to claim 5,
comprising a compound represented by the following General Formula (4), as the liquid crystal compound having one polymerizable functional group:
P⁴-(Sp⁴)ₘ₄-MG-R⁴ (4)
wherein P⁴ represents a polymerizable functional group, Sp⁴ represents an alkylene group having 0 to 18 carbon atoms, the alkylene group may be substituted with one or more of a halogen atom or CN, and one CH₂ group or two or more CH₂ groups non-adjacent to each other present in the alkylene group each independently may be substituted with —O—, —S—, —NH—, —N(CH₃)—, —CO—, —COO—, —OCO—, —OCOO—, —SCO—, —COS—, or —C≡C— as long as an oxygen atom is not directly bonded to another oxygen atom, m4 represents 0 or 1, MG represents a mesogenic group or a mesogenic supporting group.
R⁴ represents a hydrogen atom, a halogen atom, a cyano group, or an alkyl group having 1 to 18 carbon atoms, the alkyl group may be substituted with one or more of a halogen atom or CN, and one CH₂ group or two or more CH₂ groups non-adjacent to each other each present in the alkyl group independently may be substituted with —O—, —S—, —NH—, —N(CH₃)—, —CO—, —COO—, —OCO—, —OCOO—, —SCO—, —COS—, or —C≡C—, as long as an oxygen atom is not directly bonded to another oxygen atom.

8. The liquid crystal display device according to claim 1,
wherein the retardation film is configured by a positive A plate and/or a negative C plate.

9. A polymerizable liquid crystal composition according to claim 1, which is used for an in-cell type retardation film.

10. The liquid crystal display device according to claim 1,
wherein the liquid crystal composition layer further contains a compound represented by General Formula (III): 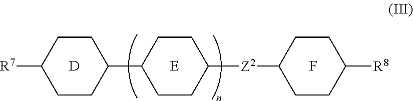
wherein R⁷ and R⁸ each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, D, E, and F each independently represent a 1,4-phenylene group or trans- 1,4-cyclohexylene which may be fluorinated, Z² represents a single bond, —OCH₂—, —OCO—, —CH₂O—, or —COO—, and n represents 0, 1, or 2, with the proviso that compounds represented by General Formula (I), General Formula (II-1) and General Formula (II-2) are excluded.

11. The liquid crystal display device according to claim 1, comprising at least one compound of General Formula (I) in which A represents
a trans-1,4-cyclohexylene group and at least one compound of General Formula (I) in which
A represents a 1,4-phenylene group.

12. The liquid crystal display device according to claim 1,
wherein the liquid crystal composition layer contains a compound represented by General Formula (II-1) and/or a compound represented by General Formula (II-2): 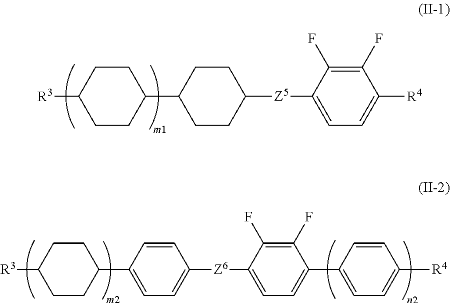
wherein R³ and R⁴ each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, Z⁵ and Z⁶ each independently represent a single bond, —CH═CH—, —C≡C—, —CH₂CH₂—, —(CH₂)₄—, —COO—, —OCO—, —OCH₂—, —CH₂O—, —OCF₂—, or —CF₂O—, and m1, m2, and n2 each independently represent 0 or 1.

13. The liquid crystal display device according to claim 1,
wherein of the liquid crystal composition constituting the liquid crystal composition layer exhibits a Z 13,000 or less, γ1 of 150 or less, and Δn of 0.08 to 0.13 with respect to the following equation:
Z=γ1/Δn² [Equation 1]
wherein γ1 represents a rotational viscosity and Δn represents a refractive index anisotropy.

14. The liquid crystal display device according to claim 1,
wherein the liquid crystal composition constituting the liquid crystal composition layer has a nematic liquid crystal phase upper limit temperature of 60° C. to 120° C., a nematic liquid crystal phase lower limit temperature of −20° C. or less, and a difference between the nematic liquid crystal phase upper limit temperature and the lower limit temperature is from 100 to 150.

15. The liquid crystal display device according to claim 1,
wherein the liquid crystal composition constituting the liquid crystal composition layer has a specific resistance of 10¹² (Ω·m) or more.
